(19) United States
(12) Patent Application Publication
(10) Pub. No.: US 2013/0316238 A1
(43) Pub. Date: Nov. 28, 2013

(54) NANOSIZED PARTICLES USED IN ANODE FOR LITHIUM ION SECONDARY BATTERIES, AND METHOD FOR PRODUCING THE SAME

(71) Applicants: FURUKAWA ELECTRIC CO., LTD., (US); THE FURUKAWA BATTERY CO., LTD, (US)

(72) Inventors: Takeshi NISHIMURA, Tokyo (JP); Toshio TANI, Tokyo (JP); Michihiro SHIMADA, Tokyo (JP); Masaaki KUBOTA, Iwaki-shi (JP); Hidetoshi ABE, Iwaki-shi (JP); Takashi EGURO, Iwaki-shi (JP)

(73) Assignees: THE FURUKAWA BATTERY CO., LTD, Yokohama-shi (JP); FURUKAWA ELECTRIC CO., LTD., Tokyo (JP)

(21) Appl. No.: 13/889,817

(22) Filed: May 8, 2013

Related U.S. Application Data
(63) Continuation of application No. PCT/JP2011/075556, filed on Nov. 7, 2011.

(30) Foreign Application Priority Data
Nov. 8, 2010 (JP) 2010-250220
Nov. 8, 2010 (JP) 2010-250221
Nov. 8, 2010 (JP) 2010-250222

(51) Int. Cl. H01M 4/36

(52) U.S. Cl. CPC H01M 4/36
USPC 429/219; 252/513; 252/512; 429/225; 429/229; 429/221; 429/223; 429/231.5; 429/224; 429/218.1; 429/220

(57) ABSTRACT

A nanosized particle has a first phase that is a simple substance or a solid solution of element A, which is Si, Sn, Al, Pb, Sb, Bi, Ge, In or Zn, and a second phase that is a compound of element D, which is Fe, Co, Ni, Ca, Sc, Ti, V, Cr, Mn, Sr, Y, Zr, Nb, Mo, Ru, Rh, Ba, lanthanoid elements (not including Ce and Pm), Hf, Ta, W or Ir, and element A, or a compound of element A and element M, which is Cu, Ag, or Au. The first phase and second phase are bound via an interface, and are exposed to the outer surface. The surface of the first phase other than the interface is approximately spherical. Furthermore, a lithium ion secondary battery includes the nanosized particle as an anode active material.

### RELATED APPLICATIONS

The present application is a continuation of International Application Number PCT/JP2011/075556, filed Nov. 7, 2011, and claims priority from, Japanese Application Number 2010-250220, filed Nov. 8, 2010, Japanese Application Number 2010-250221, filed Nov. 8, 2010 and Japanese Application Number 2010-250222, filed Nov. 8, 2010. The above listed applications are hereby incorporated by reference in their entirety.

### TECHNICAL FIELD

The present invention relates to an anode etc. for lithium ion secondary batteries, in particular, an anode for lithium ion secondary batteries that has high capacity and long service life.

### BACKGROUND ART

Conventionally, lithium ion secondary batteries using graphite as an anode active material have been put to practical use. Further, by kneading an anode active material with a conductive agent such as carbon black and a binder of resin to prepare a slurry, then applying and drying it on a copper foil, to thereby form an anode, is being performed.

On the other hand, in order to attain high capacity, lithium ion secondary batteries that use metals and alloys of high theoretical capacity, especially silicon and its alloy, as an anode active material, have been developed. However, since silicon occluding lithium ion expands in volume up to about four times that of silicon prior to occlusion, an anode that utilize silicon-type alloy as an anode active material is subjected to repeated expansion and contraction during cycles of charge-and-discharge. Thus, exfoliation etc. of the anode active material tends to occur, and there was a problem in that its service life was extremely short, compared to the conventional graphite electrode.

Thus, an anode for non-aqueous electrolyte secondary battery, wherein carbon nanofiber is grown on the surface of a silicon-type active material, to mitigate distortions caused by the expansion and contraction of the anode active material particles, and to thereby enhance its cycle characteristics, has been disclosed (for example, see Patent Document 1).

Further, an anode material for lithium secondary batteries, which comprises powders of component A and component B, and is obtained by mixing component A that is capable of storing Li, such as Si and Sn, and component B, such as Cu and Fe, by a mechanochemical method, has been disclosed (see Patent Document 2).

### PRIOR ART DOCUMENTS

### Patent Documents

[Patent Document 1] JP-A-2006-244984
[Patent Document 2] JP-A-2005-78999

### SUMMARY OF THE INVENTION

### Technical Problem

However, in conventional anodes formed by applying and drying a slurry of anode active material, conductive agent and binder, the anode active material and current collector are bound by a resin, which is low in conductivity. Thus, the amount of resin used must be minimized to avoid the internal resistance from becoming large, and the bonding strength becomes weak. Therefore, unless the volume expansion of silicon itself is suppressed, the capacity of the anode active material deteriorates, due to the pulverization of the anode active material, the exfoliation of the anode active material, the occurrence of cracks in the anode, or the decrease in conductivity between the anode active materials, during charge-and-discharge. Hence, there was a problem in that its cycle characteristic was inferior and that the service life of the secondary battery was short.

Furthermore, in the invention described in Patent Document 1, the suppression of the volume expansion of silicon itself was insufficient, and the anode active material and the current collector was bound by a resin that showed insufficient bonding strength, and thus could not adequately prevent the deterioration of the cycle characteristic. Further, since a process of forming carbon nanofiber was required, the productivity was low. Moreover, in the invention described in Patent Document 2, homogeneously dispersing each component in a nanosized level was difficult, and the deterioration of the cycle characteristic could not be sufficiently prevented.

In particular, there has been a problem in that silicon, for which its practical application as an anode material is highly expected, shows large volume change during charge-and-discharge and is prone to cracking, and has poor charge-and-discharge cycle characteristic.

The present invention was made in view of the aforementioned problems, and its object is to provide an anode material for lithium ion secondary batteries, which enable large capacity and superior cycle characteristic.

### Means for Solving the Problem

The present inventors, through earnest studies to attain the above object, discovered that by binding a phase that can hardly occlude lithium to a first phase that easily occludes lithium, the other phase suppresses the expansion of the first phase, which is attached to it, when the first phase occludes lithium, since this other phase is difficult to expand. Thus, it was discovered that the pulverization of the nanosized particle during charge-and-discharge can be prevented. The present invention has been made based on such findings.

Hence, the present invention provides the following nanosized particles and anode materials etc. for lithium ion secondary battery:

(1) A nanosized particle, which comprises element A and element D, wherein said element A is at least one element selected from the group consisting of Si, Sn, Al, Pb, Sb, Bi, Ge, In and Zn, and said element D is at least one element selected from the group consisting of Fe, Co, Ni, Ca, Sc, Ti, V, Cr, Mn, Sr, Y, Zr, Nb, Mo, Ru, Rh, Ba, lanthanoid elements (not including Ce and Pm), Hf, Ta, W and Ir; and comprises at least a first phase that is a simple substance or a solid solution of said element A, and a second phase that is a compound of said element A and said element D, wherein said first phase and said second phase are bound via an interface, said first phase and said second phase are exposed to the outer surface, and the surface of said first phase other than the interface is approximately spherical.
(2) The nanosized particle according to (1), wherein said element A is Si and said element D is at least one element selected from the group consisting of Fe, Co, Ni, Ca, Sc, Ti, V, Cr, Mn, Sr, Y, Zr, Nb, Mo, Ru, Rh, Ba, Hf, Ta, W and Ir.
(3) The nanosized particle according to (1), wherein the average particle diameter is 2 to 500 nm.
(4) The nanosized particle according to (1), wherein said second phase is a compound expressed as DA_{X} (1<x≦3).
(5) The nanosized particle according to (1), which further comprises a third phase that is a compound of said element A and said element D, wherein said third phase is dispersed in said first phase.
(6) The nanosized particle according to (1) or (5), wherein said first phase consists mainly of crystalline silicon and said second phase and/or said third phase are crystalline silicide.
(7) The nanosized particle according to (1), wherein said first phase is composed of silicon with phosphorus or boron added thereto.
(8) The nanosized particle according to (1), wherein oxygen is added to said first phase.
(9) The nanosized particle according to (1), wherein the atomic ratio of said element D in the total amount of said element A and said element D is 0.01 to 25%.
(10) The nanosized particle according to (1) or (5), wherein said element D is two or more elements selected from the group from which element D can be selected, and said second phase and/or third phase, which are compounds of one of said element D and said element A, contain another element D as a solid solution or a compound.
(11) The nanosized particle according to (1), which further comprises element D′, which is at least one element selected from the group consisting of Fe, Co, Ni, Ca, Sc, Ti, V, Cr, Mn, Sr, Y, Zr, Nb, Mo, Ru, Rh, Ba, lanthanoid elements (other than Ce and Pm), Hf, Ta, W and Ir, wherein said element D′ is an element that differs from said element D, which composes said second phase; and which further comprises a fourth phase, which is a compound of said element A and said element D′, wherein said first phase and said fourth phase are bound via an interface, and said fourth phase is exposed to the outer surface.
(12) The nanosized particle according to (1), wherein said first phase consist mainly of crystalline silicon, and the outer surface of said nanosized particle is covered with an amorphous layer.
(13) The nanosized particle according to (1), wherein said second phase consist mainly of crystalline silicide, and the outer surface of said nanosized particle is covered with an amorphous layer.
(14) The nanosized particle according to (12) or (13), wherein the thickness of said amorphous layer is 0.5 to 15 nm.
(15) The nanosized particle according to (1) or (11), wherein the surfaces of said second phase and/or said fourth phase other than their interface are approximately spherical or polyhedral
(16) A nanosized particle, which comprises element A and element M that differ, wherein said element A is at least one element selected from the group consisting of Si, Sn, Al, Pb, Sb, Bi, Ge, In and Zn, and said element M is at least one element selected from the group consisting of Cu, Ag and Au; and comprises at least a sixth phase that is a simple substance or a solid solution of said element A, and a seventh phase that is a compound of said element A and said element M, or a simple substance or solid solution of said element M, wherein said sixth phase and said seventh phase are bound via an interface, said sixth phase and said seventh phase are both exposed to the outer surface, and the surfaces of said sixth phase and seventh phase other than their interface are approximately spherical.
(17) The nanosized particle according to (16), wherein the average particle diameter is 2 to 500 nm.
(18) The nanosized particle according to (16), wherein said seventh phase is a compound expressed as MA_{X} (x≦1, 3<x).
(19) The nanosized particle according to (16), wherein said sixth phase consist mainly of crystalline silicon.
(20) The nanosized particle according to (16), wherein said element M is Cu.
(21) The nanosized particle according to (16), wherein said sixth phase is composed of silicon with phosphorus or boron added thereto.
(22) The nanosized particle according to (16), wherein said sixth phase comprises oxygen, and the atomic ratio of said oxygen in said sixth phase is AO_{z} (0<z<1).
(23) The nanosized particle according to (16), wherein the atomic ratio of said element M in the total amount of said element A and said element M is 0.01 to 60%.
(24) The nanosized particle according to (16), which further comprises element M′, which is at least one element selected from the group consisting of Cu, Ag and Au, wherein said element M′ is an element that differs from said element M, which composes said seventh phase; and which further comprises an eighth phase, which is a compound of said element A and said element M′, or a simple substance or solid solution of said element M′, wherein said sixth phase and said eighth phase are bound via an interface, said eighth phase is exposed to the outer surface, and the surface of said eighth phase other than the interface is spherical.
(25) The nanosized particle according to (16), which further comprises element D, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os or Ir; and which further comprises a ninth phase, which is a compound of said element A and said element D, wherein said sixth phase and said ninth phase are bound via an interface, and said ninth phase is exposed to the outer surface.
(26) The nanosized particle according to (25), wherein said element D is one element selected from the group consisting of Fe, Co, Ni, Ca, Sc, Ti, V, Cr, Mn, Sr, Y, Zr, Nb, Mo, Tc, Ru, Rh and Ba.
(27) The nanosized particle according to (25), which further comprises a tenth phase, which is a compound of said element A and said element D, wherein part or all of said tenth phase is covered with said sixth phase.
(28) The nanosized particle according to (25) or (27), wherein said ninth phase and/or said tenth phase is a compound expressed as DA_{y} (1<y≦3).
(29) The nanosized particle according to (25), wherein the atomic ratio of said element D in the total amount of said element A and said element D is 0.01 to 25%.
(30) The nanosized particle according to (25) or (27), wherein said element D is composed of two or more elements selected from the group from which element D can be selected; and said ninth phase and/or tenth phase, which are compounds of one of said element D and said element A, contain another element D as a solid solution or a compound.
(31) The nanosized particle according to (25), which further comprises element D′, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, wherein said element D′ is an element that differs from said element D, which composes said ninth phase; and which further comprises an eleventh phase, which is a compound of said element A and said element D′, wherein said sixth phase and said eleventh phase are bound via an interface, and said eleventh phase is exposed to the outer surface.
(32) The nanosized particle according to (31), which further comprises a twelfth phase that is a compound of said element A and said element D′, wherein part or all of said twelfth phase is covered with said sixth phase.
(33) The nanosized particle according to (25) or (31), wherein the surfaces of said ninth phase and/or said eleventh phase other than their interface are spherical or polyhedral.
(34) A nanosized particle, which comprises element A-1 and element A-2, which are two elements selected from the group consisting of Si, Sn, Al, Pb, Sb, Bi, Ge, In and Zn, and element D, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (not including Ce and Pm), Hf, Ta, W, Re, Os and Ir; and comprises a thirteenth phase, which is a simple substance or a solid solution of said element A-1, a fourteenth phase, which is a simple substance or a solid solution of said element A-2, and a fifteenth phase, which is a compound of said element A-1 and said element D, wherein said thirteenth phase and said fourteenth phase are bound via an interface, said thirteenth phase and said fifteenth phase are bound via an interface, the surfaces of said thirteenth phase and said fourteenth phase other than their interface are approximately spherical, and said thirteenth phase, said fourteenth phase, and said fifteenth phase are exposed to the outer surface.
(35) The nanosized particle according to (34), wherein said element A-1 and said element A-2 are two elements selected from the group consisting of Si, Sn and Al, and said element D is one element selected from the group consisting of Fe, Co, Ni, Ca, Sc, Ti, V, Cr, Mn, Sr, Y, Zr, Nb, Mo, Tc, Ru, Rh and Ba.
(36) The nanosized particle according to (34), which further comprises a sixteenth phase that is a compound of said element A and said element D, wherein part or all of said sixteenth phase is covered with said thirteenth phase.
(37) The nanosized particle according to (34), which further comprises a seventeenth phase that is a compound of said element A and said element D, wherein said seventeenth phase is bound to said fourteenth phase via an interface, and is exposed to the outer surface.
(38) The nanosized particle according to (34), wherein the average particle diameter is 2 to 500 nm.
(39) The nanosized particle according to any one of (34), (36), or (37), wherein at least one of said fifteenth phase, said sixteenth phase, and said seventeenth phase is a compound expressed as D(A-1)_{y} (1<y≦3).
(40) The nanosized particle according to (34), wherein the atomic ratio of said element D in the total amount of said element A-1, said element A-2, and said element D is 0.01 to 25%.
(41) The nanosized particle according to (34), wherein said thirteenth phase is silicon with phosphorus or boron added thereto.
(42) The nanosized particle according to (34), wherein said thirteenth phase contains oxygen, and the atomic ratio of the oxygen in said thirteenth phase is AO_{z} (0<z≦1).
(43) The nanosized particle according to (34), which further comprises element A-3, which is one element selected from the group consisting of Si, Sn, Al, Pb, Sb, Bi, Ge, In and Zn, wherein said element A-3 is an element that differs from said element A-1 and said element A-2; and further comprises an eighteenth phase that is a simple substance or a solid solution of said element A-3, said thirteenth phase and said eighteenth phase are bound via an interface, the surface of said eighteenth phase other than the interface is approximately spherical, and said eighteenth phase is exposed to the outer surface.
(44) The nanosized particle according to (34) or (36), wherein said element D is composed of two or more elements selected from the group from which element D can be selected, and said fifteenth phase and/or sixteenth phase, which are compounds of one of said element D and said element A, contain another element D as a solid solution or a compound.
(45) The nanosized particle according to (34), which further comprises element D′, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, wherein said element D′ is an element that differs from said element D, which composes said fifteenth phase; and which further comprises a nineteenth phase, which is a compound of said element A-1 and said element D′, wherein said thirteenth phase and said nineteenth phase are bound via an interface, and said nineteenth phase is exposed to the outer surface.
(46) The nanosized particle according to (45), which further comprises a twentieth phase that is a compound of said element A and said element D′, wherein part or all of said twentieth phase is covered with said thirteenth phase.
(47) The nanosized particle according to (34) or (45), wherein the surfaces of said fifteenth phase and/or said nineteenth phase other than their interface are spherical or polyhedral.
(48) The nanosized particle according to any one of (1), (16), or (34), wherein the powder conductivity under a condition of compressing powdered particles at 63.7 MPa, is 4×10⁻⁸ [S/cm] or more.
(49) An anode material for lithium ion secondary batteries, which comprises the nanosized particle according to any one of (1), (16), or (34) as an anode active material.
(50) The anode material for lithium ion secondary batteries according to (49), which further comprises a conductive agent, wherein said conductive agent is at least one powder selected from the group consisting of C, Cu, Ni and Ag.
(51) The anode material for lithium ion secondary batteries according to (50), wherein said conductive agent contains carbon nanohorn.
(52) An anode for lithium ion secondary batteries, which utilizes the anode material for lithium ion secondary batteries according to (49).
(53) A lithium ion secondary battery, which comprises a cathode that is able to occlude and discharge lithium ion, the anode according to (52), and a separator arranged between said cathode and said anode, wherein said cathode, said anode, and said separator are provided in an electrolyte that has lithium ion conductivity.
(54) A method for producing a nanosized particle, which comprises plasmatizing a raw material containing at least one element selected from the group consisting of Si, Sn, Al, Pb, Sb, Bi, Ge, In and Zn, and at least one element selected from the group consisting of Fe, Co, Ni, Ca, Sc, Ti, V, Cr, Mn, Sr, Y, Zr, Nb, Mo, Ru, Rh, Ba, lanthanoid elements (other than Ce and Pm), Hf, Ta, W and Ir, to obtain a nanosized particle via a nanosized droplet.
(55) A method for producing a nanosized particle, which comprises: a process of plasmatizing a raw material containing at least one element selected from the group consisting of Si, Sn, Al, Pb, Sb, Bi, Ge, In and Zn, and at least one element selected from the group consisting of Cu, Ag and Au, to obtain a nanosized particle via a nanosized droplet; and a process of oxidizing said nanosized particle.
(56) A method for producing a nanosized particle, which comprises a process of plasmatizing a raw material containing: at least one element selected from the group consisting of Si, Sn, Al, Pb, Sb, Bi, Ge, In and Zn; at least one element selected from the group consisting of Cu, Ag and Au; and at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir; to obtain a nanosized particle via a nanosized droplet.
(57) A method for producing a nanosized particle, which comprises plasmatizing a raw material containing at least two elements selected from the group consisting of Si, Sn, Al, Pb, Sb, Bi, Ge, In and Zn, and at least one element selected from the group consisting of Fe, Co, Ni, Ca, Sc, Ti, V, Cr, Mn, Sr, Y, Zr, Nb, Mo, Ru, Rh, Ba, lanthanoid elements (other than Ce and Pm), Hf, Ta, W and Ir, to obtain a nanosized particle via a nanosized droplet.
(58) A method for producing a nanosized particle, which comprises plasmatizing a raw material containing: At least two elements selected from the group consisting of Si, Sn, Al, Pb, Sb, Bi, Ge, In and Zn; and at least one element selected from the group consisting of Cu, Ag and Au; to obtain a nanosized particle via a nanosized droplet.
(59) A method for producing a nanosized particle, which comprises plasmatizing a raw material containing: at least two elements selected from the group consisting of Si, Sn, Al, Pb, Sb, Bi, Ge, In and Zn; at least one element selected from the group consisting of Cu, Ag and Au; and at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir; to obtain a nanosized particle via a nanosized droplet.

### Effect of the Invention

According to the present invention, an anode material for lithium ion secondary batteries that enables high capacity and superior cycle characteristic can be obtained.

### BRIEF DESCRIPTION OF THE DRAWINGS

FIG. 1: (a), (b), (c) schematic sectional views that show a first embodiment of the nanosized particle.

FIG. 2: (a), (b) schematic sectional views that show another example of the first embodiment of the nanosized particle.

FIG. 3: (a), (b) schematic sectional views that show another example of the first embodiment of the nanosized particle.

FIG. 4: a diagram that shows a production apparatus for the nanosized particle of the present invention.

FIG. 5: (a), (b) schematic sectional views that show a second embodiment of the nanosized particle.

FIG. 6: (a), (b), (c) schematic sectional views that show a third embodiment of the nanosized particle.

FIG. 7: (a), (b) schematic sectional views that show another example of the third embodiment of the nanosized particle.

FIG. 8: (a), (b) schematic sectional views that show another example of the third embodiment of the nanosized particle.

FIG. 9: a schematic sectional view that show another example of the first embodiment of the nanosized particle.

FIG. 10: (a), (b), (c) schematic sectional views that show a fourth embodiment of the nanosized particle.

FIG. 11: (a), (b) schematic sectional views that show another example of the fourth embodiment of the nanosized particle.

FIG. 12: (a), (b) schematic sectional views that show another example of the fourth embodiment of the nanosized particle.

FIG. 13: (a), (b) schematic sectional views that show another example of the fourth embodiment of the nanosized particle.

FIG. 14: a sectional view that shows an example of the lithium ion secondary battery of the present invention.

FIG. 15: an XRD analysis result for the nanosized particle of Example 1-1.

FIG. 16: (a) a BF-STEM image for the nanosized particle of Example 1-1; (b) a HAADF-STEM image for the nanosized particle of Example 1-1.

FIG. 17: (a) a HAADF-STEM image for the nanosized particle of Example 1-1 at a first observation part; (b)-(c) EDS maps for the same view point.

FIG. 18: (a) a HAADF-STEM image for the nanosized particle of Example 1-1 at a second observation part; (b)-(c) EDS maps for the same view point.

FIG. 19: a binary system phase diagram for Fe and Si.

FIG. 20: an XRD analysis result for the nanosized particle of Example 1-2.

FIG. 21: (a), (b) STEM images for the nanosized particle of Example 1-2.

FIG. 22: (a) a HAADF-STEM image for the nanosized particle of Example 1-2 at a first observation part; (b)-(d) EDS maps for the same view point.

FIG. 23: (a) a HAADF-STEM image for the nanosized particle of Example 1-2 at a second observation part; (b)-(d) EDS maps for the same view point.

FIG. 24: an XRD analysis result for the nanosized particle of Example 1-3.

FIG. 25: (a)-(c) TEM images for the nanosized particle of Example 1-3.

FIG. 26: (a), (b) TEM images for the nanosized particle of Example 1-3.

FIG. 27: (a) a HAADF-STEM image for the nanosized particle of Example 1-3; (b)-(d) EDS maps for the same view point.

FIG. 28: (a)-(d) EDS point analysis results for the nanosized particle of Example 1-3.

FIG. 29: a high resolution TEM image for the nanosized particle of Example 1-3.

FIG. 30: an XRD analysis result for the nanosized particle of Example 1-4.

FIG. 31: (a) a HAADF-STEM image for the nanosized particle of Example 1-4; (b)-(d) EDS maps for the same view point.

FIG. 32: (a) an EDS map of silicon atom for the nanosized particle of Example 1-4; (b) an EDS map of titanium atom for the same view point; (c) a superposition of (a) and (b).

FIG. 33: (a), (b) high resolution TEM images for the nanosized particle of Example 1-4.

FIG. 34: an XRD analysis result for the nanosized particle of Example 1-5.

FIG. 35: (a) a BF-STEM image for the nanosized particle of Example 1-5; (b) a HAADF-STEM image for the same view point.

FIG. 36: (a)-(c) high resolution TEM images for the nanosized particle of Example 1-5.

FIG. 37: (a) a HAADF-STEM image for the nanosized particle of Example 1-5; (b)-(c) EDS maps for the same view point.

FIG. 38: (a), (b) XRD analysis results for the nanosized particle of Example 1-6.

FIG. 39: (a) a BF-STEM image for the nanosized particle of Example 1-6; (b) a HAADF-STEM image for the same view point.

FIG. 40: (a)-(c) high resolution TEM images for the nanosized particle of Example 1-6.

FIG. 41: (a) a HAADF-STEM image for the nanosized particle of Example 1-6 at a first observation part; (b)-(d) EDS maps for the same view point.

FIG. 42: (a) a HAADF-STEM image for the nanosized particle of Example 1-6 at a second observation part; (b)-(d) EDS maps for the same view point.

FIG. 43: graphs of the number of cycles and discharge capacity for Examples 1-1 to 1-3, 1-7, and Comparative Examples 1-1, 1-2.

FIG. 44: graphs of the number of cycles and discharge capacity for Examples 1-4 to 1-6.

FIG. 45: a binary system phase diagram for Co and Si.

FIG. 46: a binary system phase diagram for Fe and Sn.

FIG. 47: a binary system phase diagram for Co and Fe.

FIG. 48: an XRD analysis result for the nanosized particle of Example 2-1, prior to oxidization.

FIG. 49: (a)-(c) TEM images for the nanosized particle of Example 2-1, prior to oxidization.

FIG. 50: (a)-(d) TEM images for the nanosized particle of Example 2-1, after oxidization.

FIG. 51: (a) an XRD analysis result for the nanosized particle of Example 2-1, prior to (As-syn) and after (Ox) oxidization; (b) an enlarged view for the range of 2θ=20°-43°.

FIG. 52: an XRD analysis result for the nanosized particle of Example 2-2.

FIG. 53: (a) a BF-STEM image for the nanosized particle of Example 2-2; (b) a HAADF-STEM image for the nanosized particle of Example 2-2.

FIG. 54: (a) a HAADF-STEM image for the nanosized particle of Example 2-2 at a first observation part; (b)-(e) EDS maps for the same view point.

FIG. 55: (a) a HAADF-STEM image for the nanosized particle of Example 2-2 at a second observation part; (b)-(e) EDS maps for the same view point.

FIG. 56: (a)-(b) TEM images for the nanosized particle of Example 2-2.

FIG. 57: an XRD analysis result for the nanosized particle of Example 2-3.

FIG. 58: (a) a BF-STEM image for the nanosized particle of Example 2-3; (b) a HAADF-STEM image for the nanosized particle of Example 2-3.

FIG. 59: (a) a BF-STEM image for the nanosized particle of Example 2-3; (b)-(c) HAADF-STEM images for the nanosized particle of Example 2-3.

FIG. 60: (a) a HAADF-STEM image for the nanosized particle of Example 2-3 at a first observation part; (b)-(e) EDS maps for the same view point.

FIG. 61: (a) a HAADF-STEM image for the nanosized particle of Example 2-3 at a second observation part; (b)-(e) EDS maps for the same view point.

FIG. 62: (a) a HAADF-STEM image for the nanosized particle of Example 2-3 at a third observation part; (b)-(e) EDS maps for the same view point.

FIG. 63: (a) an EDS map for the nanosized particle of Example 2-3; (b) a HAADF-STEM image for the same view point.

FIG. 64: (a) a HAADF-STEM image for the nanosized particle of Example 2-3; (b) an EDS analysis result for point 1 in (a); (c) an EDS analysis result for point 2 in (a); (d) an EDS analysis result for point 3 in (a).

FIG. 65: graphs of the number of cycles and discharge capacity for Examples 2-1 to 2-4 and Comparative Example 2-1, 2-2.

FIG. 66: a binary system phase diagram for Cu and Si.

FIG. 67: a binary system phase diagram for Cu and Sn.

FIG. 68: a binary system phase diagram for Ag and Si.

FIG. 69: a binary system phase diagram for Fe and Si.

FIG. 70: a binary system phase diagram for Cu and Fe.

FIG. 71: an XRD analysis result for the nanosized particle of Example 3-1.

FIG. 72: (a) a BF-STEM image for the nanosized particle of Example 3-1; (b) a HAADF-STEM image for the nanosized particle of Example 3-1.

FIG. 73: (a)-(b) HAADF-STEM images for the nanosized particle of Example 3-1.

FIG. 74: (a) a HAADF-STEM image for the nanosized particle of Example 3-1 at a first observation part; (b)-(e) EDS maps for the same view point.

FIG. 75: (a) a HAADF-STEM image for the nanosized particle of Example 3-1 at a second observation part; (b)-(e) EDS maps for the same view point.

FIG. 76: a high resolution TEM image for the nanosized particle of Example 3-1.

FIG. 77: (a)-(b) high resolution TEM images for the nanosized particle of Example 3-1.

FIG. 78: an XRD analysis result for the nanosized particle of Example 3-2.

FIG. 79: (a) a BF-STEM image for the nanosized particle of Example 3-2; (b) a HAADF-STEM image for the nanosized particle of Example 3-2.

FIG. 80: (a)-(b) HAADF-STEM images for the nanosized particle of Example 3-2.

FIG. 81: a HAADF-STEM image for the nanosized particle of Example 3-2.

FIG. 82: (a) a HAADF-STEM image for the nanosized particle of Example 3-2 at a first observation part; (b)-(e) EDS maps for the same view point.

FIG. 83: (a) a HAADF-STEM image for the nanosized particle of Example 3-2 at a second observation part; (b)-(e) EDS maps for the same view point.

FIG. 84: (a) a HAADF-STEM image for the nanosized particle of Example 3-2 at a third observation part; (b)-(e) EDS maps for the same view point.

FIG. 85: a high resolution TEM image for the nanosized particle of Example 3-2.

FIG. 86: a high resolution TEM image for the nanosized particle of Example 3-2.

FIG. 87: an XRD analysis result for the nanosized particle of Example 3-3.

FIG. 88: (a) a BF-STEM image for the nanosized particle of Example 3-3; (b) a HAADF-STEM image for the nanosized particle of Example 3-3.

FIG. 89: (a)-(b) HAADF-STEM images for the nanosized particle of Example 3-3.

FIG. 90: (a) a BF-STEM image for the nanosized particle of Example 3-3; (b) a HAADF-STEM image for the nanosized particle of Example 3-3.

FIG. 91: (a) a BF-STEM image for the nanosized particle of Example 3-3; (b) a HAADF-STEM image for the nanosized particle of Example 3-3.

FIG. 92: (a) a HAADF-STEM image for the nanosized particle of Example 3-3 at a first observation part; (b)-(e) EDS maps for the same view point.

FIG. 93: (a) an EDS map for the nanosized particle of Example 3-3 at a first observation part; (b) a HAADF-STEM image for the same view point.

FIG. 94: (a) a HAADF-STEM image for the nanosized particle of Example 3-3 at a second observation part; (b)-(e) EDS maps for the same view point.

FIG. 95: (a) a HAADF-STEM image for the nanosized particle of Example 3-3 at a third observation part; (b)-(e) EDS maps for the same view point.

FIG. 96: (a) a HAADF-STEM image for the nanosized particle of Example 3-3 at a fourth observation part; (b)-(e) EDS maps for the same view point.

FIG. 97: (a) an EDS map for the nanosized particle of Example 3-3 at a fourth observation part; (b) a HAADF-STEM image for the same view point.

FIG. 98: (a) a HAADF-STEM image for the nanosized particle of Example 3-3 at a fourth observation part; (b) an EDS analysis result for point 1 in (a); (c) an EDS analysis result for point 3 in (a).

FIG. 99: graphs of the number of cycles and discharge capacity for Examples 3-1 to 3-4 and Comparative Example 3-1, 3-2.

FIG. 100: a binary system phase diagram for Si and Sn.

FIG. 101: a binary system phase diagram for Al and Si.

FIG. 102: a binary system phase diagram for Al and Sn.

### BEST MODE FOR CARRYING OUT THE INVENTION

Hereinafter, embodiments of the present invention will be discussed in detail with reference to the accompanying Figures.

### (1. Nanosized Particle of the First Embodiment)

### (1-1. Composition of the Nanosized Particle)

Nanosized particle 1 of the first embodiment will be described.

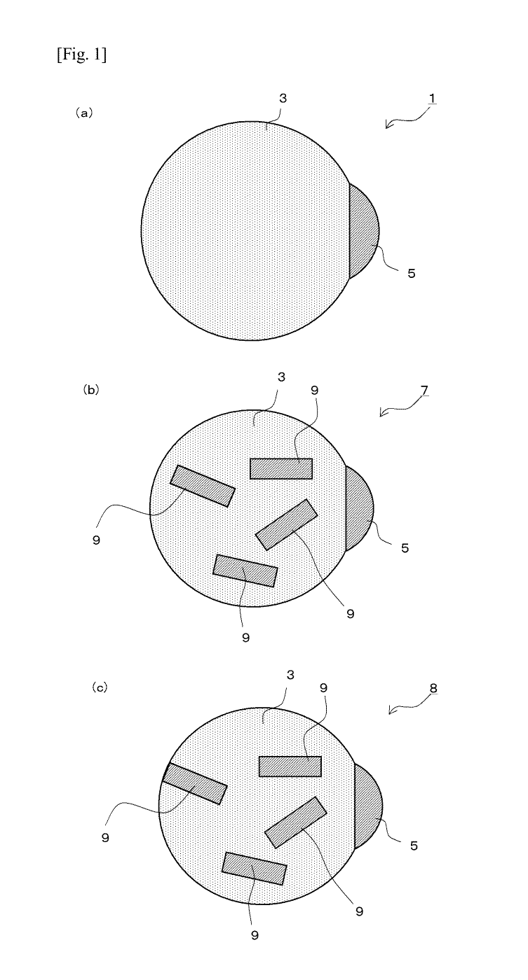

FIG. 1 is a schematic sectional view that shows nanosized particle 1. Nanosized particle 1 has a first phase 3 and a second phase 5, and the surface of first phase 3 other than the interface is approximately spherical. The second phase 5 is bound to the first phase 3 via an interface. The interface between the first phase 3 and the second phase 5 is flat or curved.

The first phase 3 is a simple substance of element A, and element A is at least one element selected from the group consisting of Si, Sn, Al, Pb, Sb, Bi, Ge, In and Zn. Element A is an element that easily occludes lithium. Note that the first phase 3 may also be a solid solution containing element A as its main component. The first phase 3 may be crystalline or amorphous. The element that forms a solid solution with element A may be an element selected from the group from which element A can be selected, or an element that has not been listed in the aforementioned group. The first phase 3 can occlude and discharge lithium. The first phase 3 forms an alloy once by occluding lithium, and becomes amorphous once it de-alloys by discharging lithium.

The surface other than the interface being approximately spherical does not imply that the configuration is limited to a sphere or an ellipsoid, but merely means that the surface is composed more or less of a smooth curved surface, and may, in part, contain a flat surface. However, it should be noted that the configuration differs from that with angles on the surface, as in solids formed by fracturing.

The second phase 5 is a compound of element A and element D, and is crystalline. Element D is at least one element selected from the group consisting of Fe, Co, Ni, Ca, Sc, Ti, V, Cr, Mn, Sr, Y, Zr, Nb, Mo, Ru, Rh, Ba, lanthanoid elements (not including Ce and Pm), Hf, Ta, W and Ir. Element D is an element that hardly occludes lithium, and forms compound DAₓ (1<x≦3) with element A. For most elements A, x=2, as in FeSi₂ and CoSi₂. However, it may also be x=1.33, as in the case of Rh₃Si₄ (RhSi_{1.33}), or x=1.5, as in the case of Ru₂Si₃ (RuSi_{1.5}), or x=1.67, as in Sr₃Si₅ (SrSi_{1.67}), x=1.75, as in Mn₄Si₇ (MnSi_{1.75}) and Tc₄Si₇ (TcSi_{1.75}), or even x=3 as in the case of IrSi₃. The second phase 5 hardly occludes lithium. Note that Tc, Re and Os may also be used as element D.

When applying the nanosized particle by preparing an aqueous slurry, lanthanoid elements are not suitable, since they easily form hydroxides in aqueous slurry, causing exfoliation between the phases. Further, nanosized particles containing lanthanoid elements are problematic in that they tend to be hydrogenated in the plasma at formation. Note that by preventing the entrance of water in the plasma during the formation of the nanosized particle, or preparing an organic solvent-type slurry, nanosized particles containing lanthanoid elements can be used without problem.

Further, as with nanosized particle 7 shown in FIG. 1(b), a third phase 9, which is a compound of element A and element D, may also be dispersed in the first phase 3. The third phase 9 is covered by the first phase 3. The third phase 9, like the second phase 5, hardly occludes lithium. Further, as shown in FIG. 1(c), part of the third phase 9 may be exposed to the surface. That is, the third phase 9 does not necessarily have to be completely covered by the first phase 3, but may only be partially covered by the first phase 3.

Note that although multiple numbers of the third phase 9 are dispersed in the first phase 3 in FIG. 1(b), only a single third phase 9 may be incorporated.

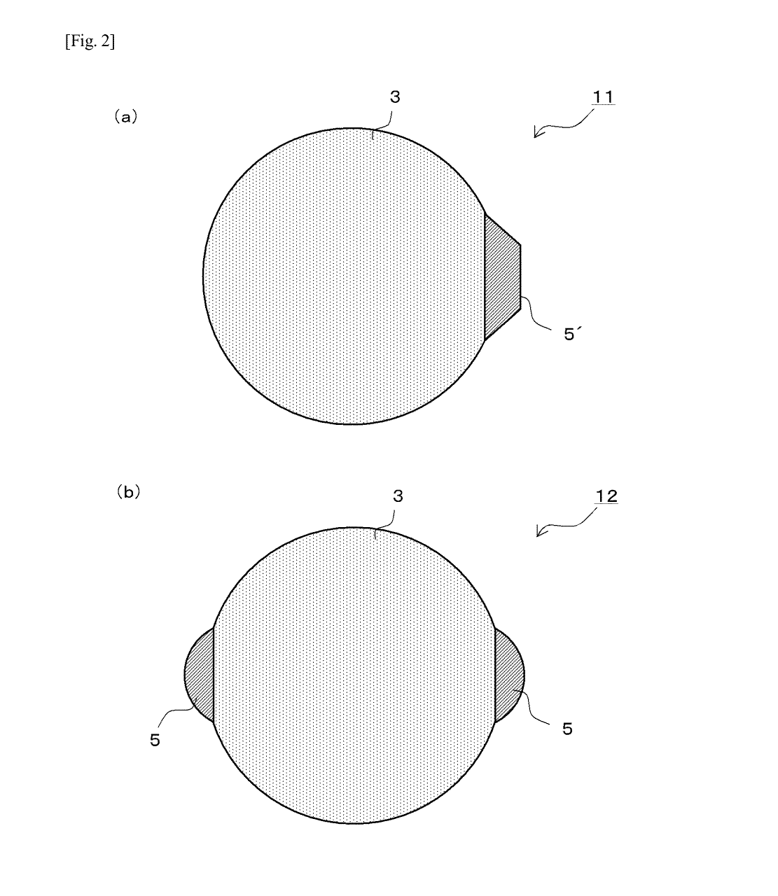

Furthermore, the configuration of the surface of the second phase 5 other than the interface may more or less be a smooth spherical surface, as shown in FIG. 1(a), or polyhedral as shown in the second phase 5′ in FIG. 2(a). The second phase 5′ takes a polyhedral configuration due to the effect of crystalline stability of the compound of element A and element D.

Further, as with nanosized particle 12 shown in FIG. 2(b), the second phase 5 may exist in plurality. For example, cases where the second phase 5 disperse and bind to the surface of the first phase 3, due to the content of element D being small and the collision frequency between each element D decreasing in the gaseous state or liquid state, due to the relationship between the melting points, the wettabilities, or the cooling rates of the first phase 3 and the second phase 5, can be listed.

When there are a plurality of the second phase 5 on the first phase 3, the area of the interface between the first phase 3 and the second phase 5 becomes large, and the expansion and contraction of the first phase 3 can further be suppressed. Moreover, when the first phase 3 is Si or Ge, electron transfer is accelerated, since the second phase 5 has a higher conductivity than the first phase 3. Thus the nanosized particle 12 would have multiple current collecting spots on the first phase 3 within each nanosized particle 12. Hence, the nanosized particle 12 becomes an anode material of high powder conductivity, and enables the decrease of the amount of conductive agent, thus allowing the formation of a high capacity anode. Further, an anode that is superior in high-rate characteristic can be obtained.

As for element D, when there are two or more elements selected from the group from which element D can be selected, the second phase 5 and/or the third phase 9, which is a compound of one particular element D and element A, may contain another one of element D as a solid solution or a compound. That is, even when the nanosized particle contains two or more elements selected from the group from which element D can be selected, a fourth phase 15 may not be formed, as in the later-described element D′. For example, when element A is Si, one of element D is Ni, and the other element D is Fe, Fe can exist as a solid solution in NiSi₂. Further, when observed by EDS, the distribution of Ni and Fe may be approximately the same, or different, and yet another element D may be uniformly contained in the second phase 5 and/or the third phase 9, or may be contained partially.

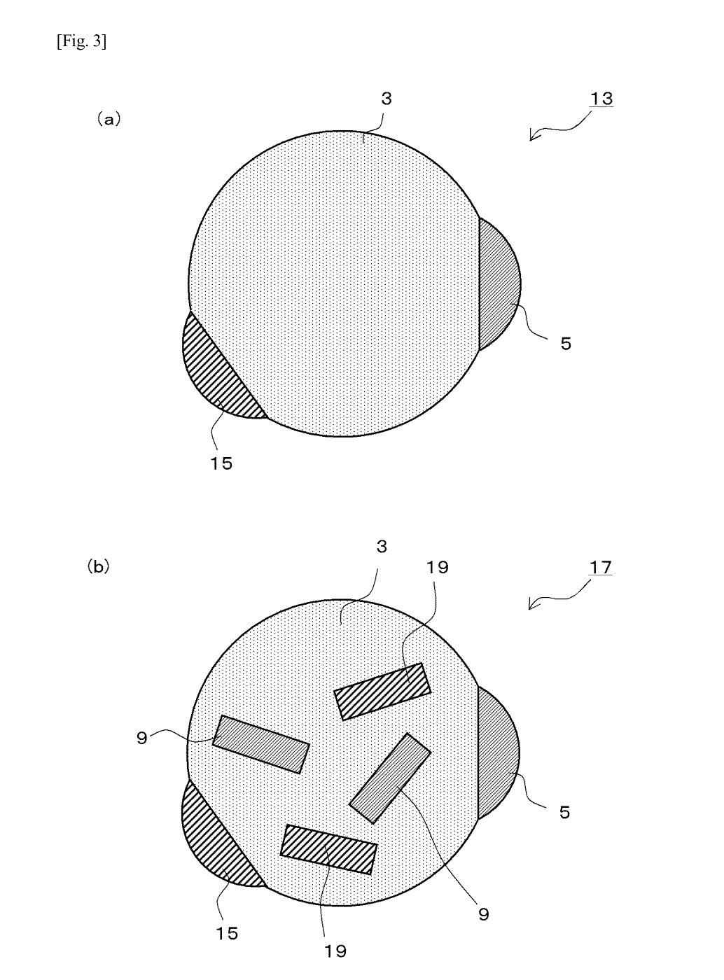

Furthermore, the nanosized particle may contain element D′, in addition to element D. Element D′ is an element selected from the group from which element D can be selected, and element A, element D and element D′ are different elements. Nanosized particle 13 of FIG. 3(a) contains element D and element D′, and comprises a fourth phase 15, in addition to the second phase 5, which is a compound of element A and element D. The fourth phase 15 is a compound of element A and element D′. Nanosized particle 13 may contain a solid solution consisting of element D and element D′ (not shown in the figure). For example, a case where the second phase 5 is a compound of Si and Fe, the fourth phase 15 is a compound of Si and Co, and the solid solution consisting of element D and element D′ is a solid solution of Fe and Co, may be listed.

Further, as shown in FIG. 3(b), a third phase 9 that is a compound of element A and element D, and a fifth phase 19 that is a compound of element A and element D′, may be dispersed in the first phase 3. Note that although in FIG. 3(a) and (b), an example where two elements were selected as element D is described, three or more elements may be selected.

The average particle diameter of such nanosized particles are preferably 2 to 500 nm, and more preferably 50 to 300 nm. According to the Hall-Petch law, the smaller the particle size, the larger the yield stress is. Thus, if the average particle diameter of the nanosized particle is 2 to 500 nm, the particle size is sufficiently small and the yield stress is sufficiently large. Hence, pulverization due to charge and discharge is less likely to occur. Note that when the average particle diameter is smaller than 2 nm, the handling of the nanosized particle after synthesis becomes difficult, and when the average particle size is larger than 500 nm, the particle size becomes too large, making its yield stress insufficient.

The atomic ratio of element D in the sum of element A and element D is preferably 0.01 to 25%. If this atomic ratio is 0.01 to 25%, cycle characteristic and high capacity can coexist when the nanosized particle 1 is used as an anode material in lithium ion secondary batteries. On the other hand, when it is lower than 0.01%, the volume expansion of the nanosized particle 1 during lithium occlusion cannot be suppressed, and when it is larger than 25%, the amount of element A bonding to element D becomes large, decreasing the number of element A-sites to which lithium can occlude, and thus, the advantage of being high capacity diminishes. Note that when the nanosized particle contains element D′, it is preferable that the atomic ratio of the sum of element D and element D′ to the sum of element A, element D and element D′ is 0.01 to 25%.

In particular, it is preferable that the first phase is mainly composed of crystalline silicon and the second phase is crystalline silicide. Further, it is preferable that the first phase is mainly composed of silicon with phosphorus or boron added thereto. By adding phosphorus or boron, the conductivity of silicon can be enhanced. Note that indium and gallium may be used in place of phosphorus, and arsenic may be used in place of boron. By enhancing the conductivity of silicon in the first phase, internal resistance of the anode that utilizes such nanosized particle becomes small, and large currents can be conducted, thus enabling superior high-rate characteristic.

Furthermore, by adding oxygen to the Si of the first phase, the Si sites that bond with Li are suppressed, thereby controlling volume expansion due to Li occlusion, and obtaining superior service life characteristic. Note that the amount y of oxygen added is preferably in the range of SiO_{y [}0≦y<0.9]. Under conditions where y is larger than 0.9, the number of Si sites to which Li can occlude decrease, leading to a diminished capacity.

Note that particles usually exist as an aggregate, and the average particle size of the nanosized particle in this case refers to the average particle size of the primary particle. For the measurement of particle, image information obtained by an electron microscope (SEM) and volume based median diameter obtained by dynamic light scattering photometer (DLS) are used in combination. The average particle size can be obtained by confirming the particle configuration by SEM image beforehand, and using an image analysis software (for example, “A-zo-kun” (registered trademark) by Asahi Engineering Corporation), or by subjecting to measurement by DLS (for example, DLS-8000 by Otsuka Electronics Co. Ltd.) after dispersing in a solvent. If the particles are sufficiently dispersed and are not aggregated, the measurement results of SEM and DLS should be about equal. Further, the average particle size can also be obtained by defining the average particle size by its primary particle, and performing image analysis of its SEM image, even when the configuration of the nanosized particle is a highly developed structured configuration as in acetylene black. Moreover, the average particle size can be obtained by measuring the specific surface area by the BET method etc., and assuming that it is a spherical particle. This method must be applied by confirming that the nanosized particle is solid rather than porous by SEM observation and TEM observation.

Note that when the first phase is mainly composed of crystalline silicon, oxygen may be bonded to the outer-most surface of the nanosized particle 1. This is because when the nanosized particle 1 is taken out into air, the oxygen in the air reacts with the elements on the surface of the nanosized particle 1. In other words, the outer-most surface of the nanosized particle 1 may comprise an amorphous layer with a thickness of 0.5 to 15 nm. In particular, when the first phase is mainly crystalline silicon, it may comprise an oxide film layer. By being covered by an amorphous layer, it becomes stable in air, and aqueous solvents may be used as the slurry solvent, and its industrial utility becomes high.

### (1-2. Effect of the Nanosized Particle)

When the first phase 3 occludes lithium, volume expansion occurs, but because the second phase 5 hardly occludes lithium, the expansion of the first phase 3, which is bound to the second phase 5, is suppressed. That is, even though the first phase 3 tries to expand by occluding lithium, the interface between the first phase 3 and the second phase 5 hardly slips, because the second phase 5 hardly expands, and the second phase 5 shows a wedge-like or pin-like effect, to alleviate the volume distortion and suppresses the expansion of the entire nanosized particle. Thus, compared to a particle that does not have a second phase 5, the nanosized particle 1, which has a second phase 5, hardly expands during lithium occlusion. During lithium discharge, a restoring force works to return to its original configuration. Therefore, according to the present invention, in the nanosized particle 1, the distortion accompanying volume expansion is alleviated even when lithium is occluded, and the deterioration of discharge capacity after repeated charge-and-discharge can be suppressed.

Furthermore, as described previously, since nanosized particle 1 hardly expands, even when nanosized particle 1 is taken out in the atmosphere, it hardly reacts with oxygen in the atmosphere. When nanoparticles that do not comprise the second phase 5 are left in the atmosphere without surface protection, reaction with oxygen begins at the surface, and oxidation advances into the particle from the surface, thus oxidizing the entire particle. However, when the nanosized particle of the present invention is left in the atmosphere, although the outer-most surface of the particle reacts with oxygen, because the overall nanosized particle hardly expands, it is difficult for oxygen to penetrate into the particle, and oxidation does not extend to the center of the nanosized particle 1. Thus, although regular metallic nanoparticles have large specific surface areas and tend to oxidize, leading to heat generation and volume expansion, the nanosized particle 1 of the present invention does not require a special surface coat of organic substances or metal oxides, can be handled on its own in the atmosphere as a powder, and is industrially useful.

Furthermore, according to the present invention, the second phase 5 has a high conductivity because it contains element D, and in particular, when the first phase 3 is Si or Ge, the conductivity of the overall nanosized particle is dramatically elevated. Hence, the nanosized particle 1 will have current collecting spots of nano-level within each nanosized particle, and becomes an anode material with conductivity even with little amounts of conductive agents, and an electrode of high capacity can be formed, and an anode of excellent high-rate characteristic can be obtained.

Furthermore, in nanosized particle 7, which contains a third phase 9 in the first phase 3, and nanosized particle 17, which contains a third phase 9 and a fifth phase 19 the majority of parts of the first phase 3 is in contact with a phase that does not occlude lithium, and thus, the expansion of the first phase 3 is suppressed more effectively. As a result, nanosized particles 7, 8, and 17 can exhibit the effect of suppressing volume expansion with less amount of element D, and are able to increase the amount of element A, which can occlude lithium. Thus, high capacity and enhanced cycle characteristics are obtained.

Nanosized particle 13 and 17, which comprise both the second phase 5 and the fourth phase 15, show effects similar to that of nanosized particle 1, as well as have increased numbers of current collecting spots, and thus, their current collectivity are effectively enhanced. By adding two or more element Ds, two or more compounds are produced, and since such compounds are likely to dissociate from each other, the number of current collector spots tend to increase, and are thus more preferable.

### (1-3. Method for Producing Nanosized Particle)

The method for producing these nanosized particles will be described. These nanosized particles are synthesized by the vapor phase synthesis method. In particular, by plasmatizing a raw material powder and heating up to about the equivalent of 10,000 K, then cooling, such nanosized particles can be produced. As for the method of plasma generation, (1) a method of utilizing high-frequency electromagnetic field to heat gas inductively; (2) a method of utilizing arc discharge between electrodes; (3) a method of heating gas by microwave, are known, and all are applicable.

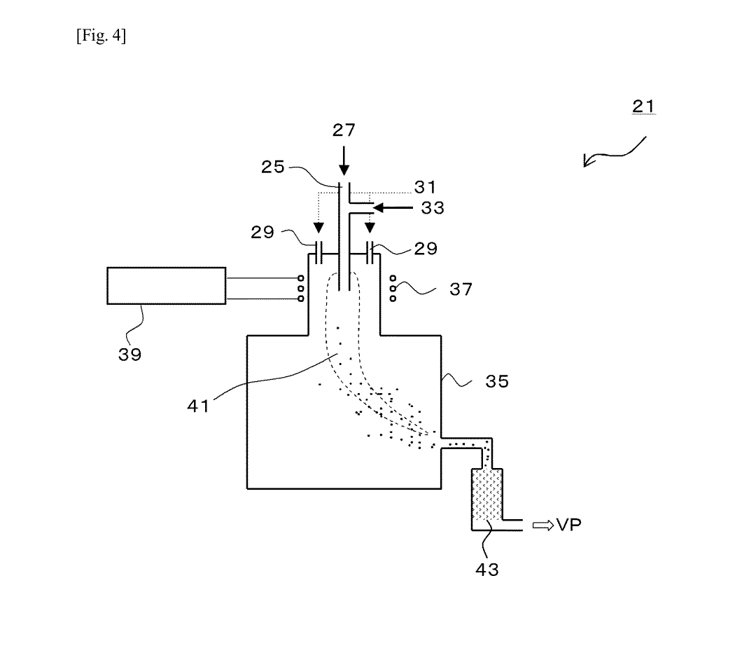

As a specific example of the production apparatus for the production of the nanosized particle, method (1) of utilizing high-frequency electromagnetic field to heat gas inductively will be described, with reference to FIG. 4. In the nanosized particle production apparatus 21 of FIG. 4, a high-frequency coil 37 is wound on the upper outer wall of the reaction chamber 35. An AC voltage of several MHz is applied to the high-frequency coil 37 from a high-frequency power supply 39. Note that the upper outer wall, to which the high-frequency coil 37 is wound, is a cylindrical duplex tube comprised of quartz glass etc., and cooling water flows in the gap to prevent the melting of quartz glass by plasma.

Further, on the top part of the reaction chamber 35 is provided a sheath gas supply port 29, along with a raw material powder supply port 25. The raw material powder 27 supplied from the raw material powder feeder is supplied to the plasma 41, along with a carrier gas 33 (noble gas such as helium and argon) via the raw material powder supply port 25. Furthermore, sheath gas 31 is supplied to the reaction chamber 35 through the sheath gas supply port 29. Sheath gas 31 is a gas such as a gas mixture of argon gas and oxygen gas. Note that the raw material powder supply port 25 does not necessarily have to be provided above the plasma 41 as shown in FIG. 4, but may also be provided with the nozzle at the side of the plasma 41. Moreover, the form of the raw material for the nanosized particle is not limited to a powder, and a slurry of the raw material powder or a gaseous raw material may be supplied, too.

The reaction chamber 35 serves to maintain the pressure of the plasma reaction part, and to suppress the dispersion of the fine powder produced. The reaction chamber 35 is also cooled by water to prevent damage by the plasma. Further, a suction pipe is attached to the side of the reaction chamber 35, and at the middle of the suction pipe is a filter 43 for collecting the synthesized fine powder. The suction pipe that connects the filter 43 to the reaction chamber 35 is also cooled by water. The pressure within the reaction chamber 35 is controlled by the suction force of the vacuum pump (VP) provided downstream of the filter 43.

Since the method of producing nanosized particle 1 is a bottom-up method, wherein nanosized particle 1 is deposited from plasma, via gas and liquid to solid, the nanosized particle 1 becomes spherical, because the droplet forms as a sphere. On the other hand, in a top down method such as the fracturing method or the mechanochemical method, the particle becomes distorted and rugged, differing greatly from the spherical configuration of the nanosized particle 1.

Note that by using a mixed powder of a powder of element A and a powder of element D as the raw material powder, nanosized particles 1, 7, 8, 11 and 12 are obtained. Further, by using a mixed powder of a powder of element A, element D, and element D′ as the raw material powder, nanosized particles 13 and 17 are obtained. Furthermore, when introducing oxygen into the first phase 3, the composition ratio can easily be controlled by introducing element A with its oxide AO₂, as in Si and SiO₂, as a powder.

### (2. The Nanosized Particle of the Second Embodiment)

### (2-1. Composition of Nanosized Particle 51)

Nanosized particle 51 of the second embodiment will be described.

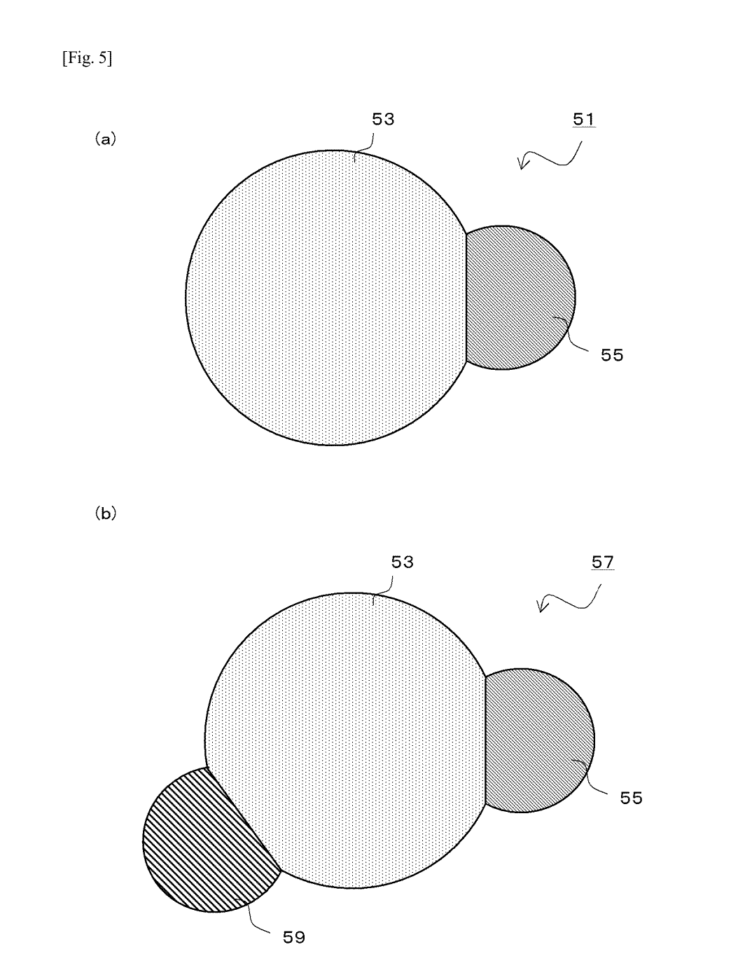

FIG. 5 is a schematic sectional view describing nanosized particle 51. Nanosized particle 51 comprises a sixth phase 53 and a seventh phase 55, and the sixth phase 53 and seventh phase 55 are both exposed to the outer surface of nanosized particle 51. The interface of the sixth phase 53 and seventh phase 55 are flat or curved, and the sixth phase and seventh phase are bound via an interface, and the surfaces other than their interface are approximately spherical.

The sixth phase 53 is composed of a simple substance or solid solution of element A, and element A is at least one element selected from the group consisting of Si, Sn, Al, Pb, Sb, Bi, Ge, In and Zn. Element A is an element that easily occludes lithium. The element that forms a solid solution with element A may be an element selected from the group from which element A can be selected, or an element that is not listed in the aforementioned group. The sixth phase 53 can occlude and discharge lithium.

The sixth phase 53 and the seventh phase 55 being approximately spherical except at their interface means that the sixth phase 53 and the seventh phase 55 are spherical or ellipsoidal other than at the interface of the sixth phase 53 and the seventh phase 55. In other words, the surfaces of the sixth phase 53 and the seventh phase 55 other than the area where the sixth phase and the seventh phase are bound, is formed mostly of a smooth curve. That is, the configuration of the sixth phase 53 and the seventh phase 55 differ from that of a solid obtained by a fracturing method, which contains angles. Further, the configuration of the interface of the sixth phase 53 and the seventh phase 55 is circular or elliptical.

The seventh phase 55 is a compound of element A and element M or a simple substance or solid solution of element M, and is crystalline. Element M is one or more element selected from the group consisting of Cu, Ag and Au. Element M is an element that hardly occludes lithium, and the seventh phase 55 hardly occludes lithium.

As long as the combination of element A and element M are capable of forming a compound, the seventh phase 55 is formed of MAₓ (x≦1, 3<x), which is a compound of element A and element M. On the other hand, if the combination of element A and element M is not capable of forming a compound, the seventh phase 55 becomes a simple substance or solid solution of element M.

For example, when element A is Si, and element M is Cu, the seventh phase 55 is formed of copper silicide, which is a compound of element M and element A.

For example, when element A is Si, and element M is Ag or Au, the seventh phase 55 is formed of a simple substance of element M or a solid solution composed mainly of element M.

In particular, it is preferable that the sixth phase 53 is crystalline silicon. Further, it is preferable that the sixth phase is silicon with phosphorus or boron added thereto. By adding phosphorus or boron, the conductivity of silicon is enhanced. Indium and gallium may be used in place of phosphorus and arsenic may be used in place of boron. By increasing the conductivity of silicon in the sixth phase, the anode that utilizes such nanosized particle will have a smaller internal resistance, and becomes possible to conduct large currents, and will show superior high-rate characteristics. Furthermore, when the sixth phase 53 contains oxygen, sites that react with lithium can be suppressed. By containing oxygen, the capacity decreases, but volume expansion due to lithium occlusion can be suppressed. The amount of oxygen added z, is preferably in the range of AO_{z} (0<z<1). When z is larger than 1, the lithium occlusion site of A is suppressed, and the capacity will deteriorate.

The average particle diameter of nanosized particle 51 is preferably 2 to 500 nm, and more preferably 50 to 200 nm. According to the Hall-Petch law, the smaller the particle size, the larger the yield stress is. Thus, if the average particle diameter of the nanosized particle 51 is 2 to 500 nm, the particle size is sufficiently small and the yield stress is sufficiently large. Hence, pulverization due to charge and discharge is less likely to occur. Note that when the average particle diameter is smaller than 2 nm, the handling of the nanosized particle after synthesis becomes difficult, and when the average particle size is larger than 500 nm, the particle size becomes too large, making its yield stress insufficient.

The atomic ratio of element M in the sum of element A and element M is preferably 0.01 to 60%. If this atomic ratio is 0.01 to 60%, cycle characteristic and high capacity can coexist when the nanosized particle 51 is used as an anode material in lithium ion secondary batteries. On the other hand, when it is lower than 0.01%, the volume expansion of the nanosized particle 51 during lithium occlusion cannot be suppressed, and when it is larger than 60%, the advantage of being high capacity diminishes.

Note that particles usually exist as an aggregate, and the average particle size of the nanosized particle refers to the average particle size of the primary particle. For the measurement of particle, image information obtained by an electron microscope (SEM) and volume based median diameter obtained by a dynamic light scattering photometer (DLS) are used in combination. The average particle size can be obtained by confirming the particle configuration by SEM image beforehand, and using image analysis (for example, “A-zo-kun” (registered trademark) by Asahi Engineering Corporation), or by subjecting to measurement by DLS (for example, DLS-8000 by Otsuka Electronics Co. Ltd.) after dispersing in a solvent. If the particles are sufficiently dispersed and are not aggregated, the measurement results of SEM and DLS should be about equal. Further, the average particle size can also be obtained by defining the average particle size by its primary particle and analyzing its SEM image, even when the configuration of the nanosized particle is a highly developed structured configuration as in acetylene black. Moreover, the average particle size can be obtained by measuring the specific surface area through the BET method etc., and assuming that it is a spherical particle. This method must be applied by confirming that the nanosized particle is solid rather than porous by SEM observation and TEM observation, beforehand.

Note that the nanosized particle 51 of the second embodiment may comprise an eighth phase 59, as the nanosized particle 57 shown in FIG. 5(b). Nanosized particle 57 further comprises element M′, which is selected from the group consisting of Cu, Ag and Au, wherein element M and element M′ differ. The eighth phase 59 is a compound of element A and element M′, or a simple substance or solid solution of M′. For example, nanosized particle 57, wherein element A is Si, element M is Cu, element M′ is Ag, and the sixth phase 53 is a simple substance or solid solution of silicon, the seventh phase 55 is copper silicide, and the eighth phase 59 is a simple substance or solid solution of silver, may be exemplified.

The sixth phase 53 and the seventh phase 55 and the eighth phase 59 are all exposed to the outer surface, and are approximately spherical except for the interface of the sixth phase 53, seventh phase 55 and eighth phase. For example, in nanosized particle 57 shows a configuration similar to water molecule, wherein the seventh phase 55 of small spherical configuration and the eighth phase 59 of small spherical configuration are bound on the surface of the large spherical configuration of the sixth phase 53. Further, the atomic ratio of the sum of element M and element M′ in the total amount of element A, element M and element M′, is preferably 0.01 to 60%.

Note that when the first phase is mainly composed of crystalline silicon, oxygen may be bonded to the outer-most surface of the nanosized particle 51. This is because when the nanosized particle 51 is taken out into air, the oxygen in the air reacts with the elements on the surface of the nanosized particle 51. In other words, the outer-most surface of the nanosized particle 51 may comprise an amorphous oxide film with a thickness of 0.5 to 15 nm. Further, by introducing oxygen to the sixth phase 53 in a range of AO_{z} (0<z<1), it becomes stable in air, and aqueous solvents may be used as the slurry solvent, making its industrial utility high.

### (2-2. Effect of the Second Embodiment)

According to the second embodiment, when the sixth phase 53 occludes lithium, volume expansion occurs, but because the seventh phase 55 does not occlude lithium, the expansion of the part of the sixth phase 53, which is bound to the seventh phase 55, is suppressed. That is, even though the sixth phase 53 tries to expand in volume by occluding lithium, the interface between the sixth phase 53 and the seventh phase 55 hardly slips, because the seventh phase 55 hardly expands, and the seventh phase 55 shows a wedge-like or pin-like effect to alleviate the volume distortion and suppresses the expansion of the entire nanosized particle. Thus, compared to a particle that does not have a seventh phase 55, the nanosized particle 51, which has a seventh phase 55, hardly expands during lithium occlusion. During lithium discharge, a restoring force works to return to its original configuration. Therefore, according to the second embodiment, in nanosized particle 51, volume expansion is suppressed even when lithium is occluded, and the deterioration of discharge capacity after repeated charge-and-discharge can be suppressed.

Further, according to the second embodiment, the seventh phase 55 has a higher conductivity than the sixth phase 53, because it contains element M. Thus, nanosized particle 51 contains current collecting spots of nano-level within each nanosized particle 51, making nanosized particle 51 an anode material with good conductivity, which provides an anode of superior current collectivity.

Nanosized particle 57, which comprises both the seventh phase 55 and the eighth phase 59, show similar effects to that of nanosized particle 51, and shows an effectively enhanced current collectivity, due to increased numbers of current collecting spots in the nano-level.

### (3. Third Embodiment)

### (3-1. Composition of Nanosized Particle 61)

Nanosized particle 61 of the third embodiment will be described. Hereinafter, components that have the same aspects as those of the second embodiment will be assigned the same numerical notations to avoid redundant descriptions.

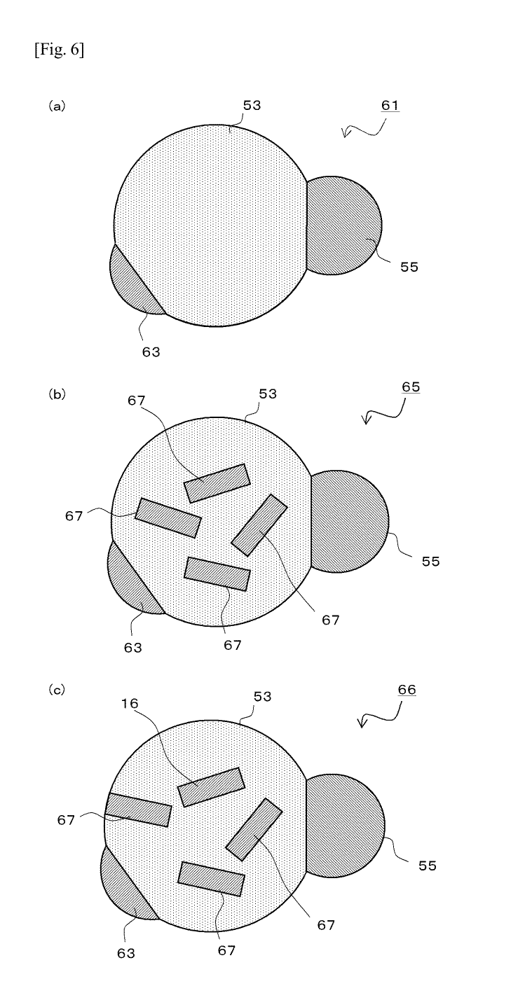

FIG. 6(a) is a schematic sectional view of nanosized particle 61. Nanosized particle 61 comprises a sixth phase 53, a seventh phase 55 and a ninth phase 63, and the sixth phase 53 and seventh phase 55 are bound via an interface, and the sixth phase and ninth phase 63 are bound via an interface. Further, the sixth phase 53, seventh phase 55, and ninth phase 63 are all exposed to the outer surface of the nanosized particle 51, and the surfaces of the sixth phase 53, seventh phase 55, and ninth phase 63, other than their interface, are approximately spherical.

The ninth phase 63 is a compound of element A and element D, is highly conductive, and crystalline. Element D is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir. Element D is an element that hardly occludes lithium, and can form a compound DA_{y} (1<y≦3) with element A. The ninth phase 63 hardly occludes lithium, or occludes lithium in a minimal amount.

The atomic ratio of element D in the sum of element A and element D is preferably 0.01 to 25%. If this atomic ratio is 0.01 to 25%, cycle characteristic and high capacity can coexist when the nanosized particle is used as an anode material in lithium ion secondary batteries. On the other hand, when it is lower than 0.01%, the volume expansion of the nanosized particle during lithium occlusion cannot be suppressed, and when it is larger than 25%, the amount of element A bonding to element D becomes large, decreasing the number of element A-sites to which lithium can occlude, and thus, the advantage of being high capacity diminishes. Note that when the nanosized particle contains element D′, as described later, it is preferable that the atomic ratio of the sum of element D and element D′ to the sum of element A, element D and element D′ is 0.01 to 25%.

Further, as with nanosized particle 65 shown in FIG. 6(b), nanosized particle 61 of the third embodiment may contain a tenth phase 67, which is a compound of element A and element D, dispersed in the sixth phase 53. The tenth phase 67 is covered by the sixth phase 53. As with the seventh phase 55, the tenth phase 67 hardly occludes lithium, or occludes with lithium in a minimal amount.

Note that although in FIG. 6(b) a plurality of the tenth phase 67 are dispersed in the sixth phase 53, a single tenth phase 67 may be incorporated.

Further, as with nanosized particle 66 shown in FIG. 6(c), part of the tenth phase 67 may be exposed to the surface. That is, all of the tenth phase 67 does not necessarily have to be covered with the sixth phase 53, and only part of the periphery of the tenth phase 67 may be covered by the sixth phase 53.

Furthermore, nanosized particles 61 and 65 of the third embodiment may comprise an eighth phase 59, as with nanosized particle 69 shown in FIG. 7(a), or nanosized particle 71 shown in FIG. 7(b). Nanosized particles 69 and 71 further comprise element M′, which is selected from the group consisting of Cu, Ag and Au, and element M′ differs from element M. The eighth phase 59 is a compound of element A and element M′ or a simple substance or solid solution of element M′.

When element D is two or more elements selected from the group from which element D can be selected, a ninth phase 63 and/or tenth phase 67, which are compounds of one particular element D and element A, may contain another one of element D as a solid solution or a compound. That is, even when the nanosized particle contains two or more elements selected from the group from which element D can be selected, as with the later-described element D′, an eleventh phase 75 may not be formed. For example, when element A is Si, one of element D is Ni, and the other element D is Fe, Fe may exist within NiSi₂ as a solid solution. Further, when observed by EDS, the distribution of Ni and the distribution of Fe may be approximately equal or different, and the other element D may be contained uniformly or partially in the ninth phase 63 and/or tenth phase 67.

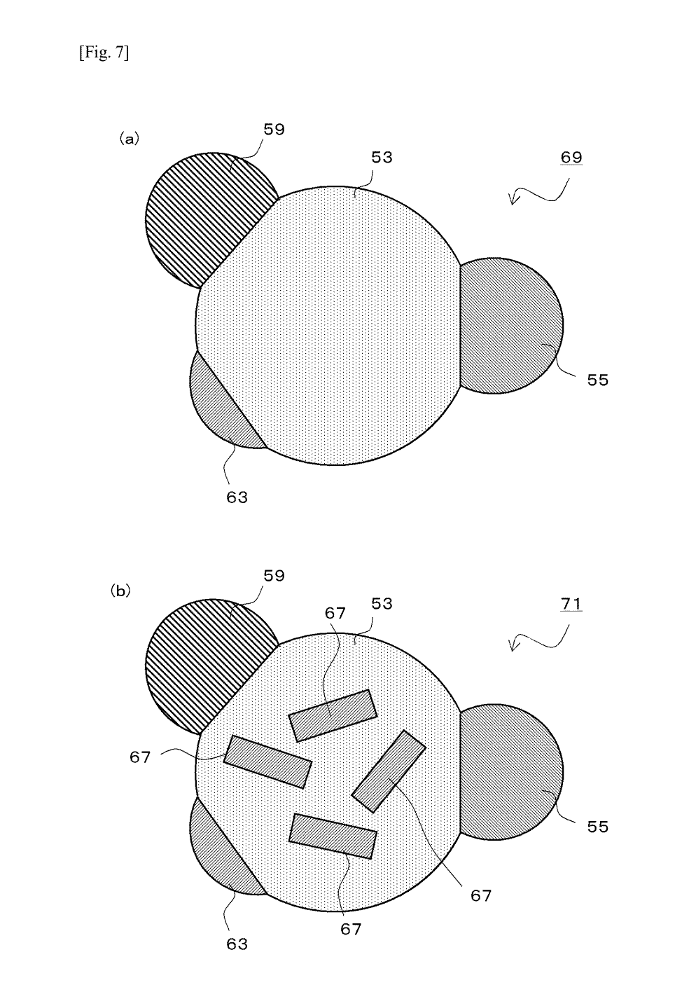

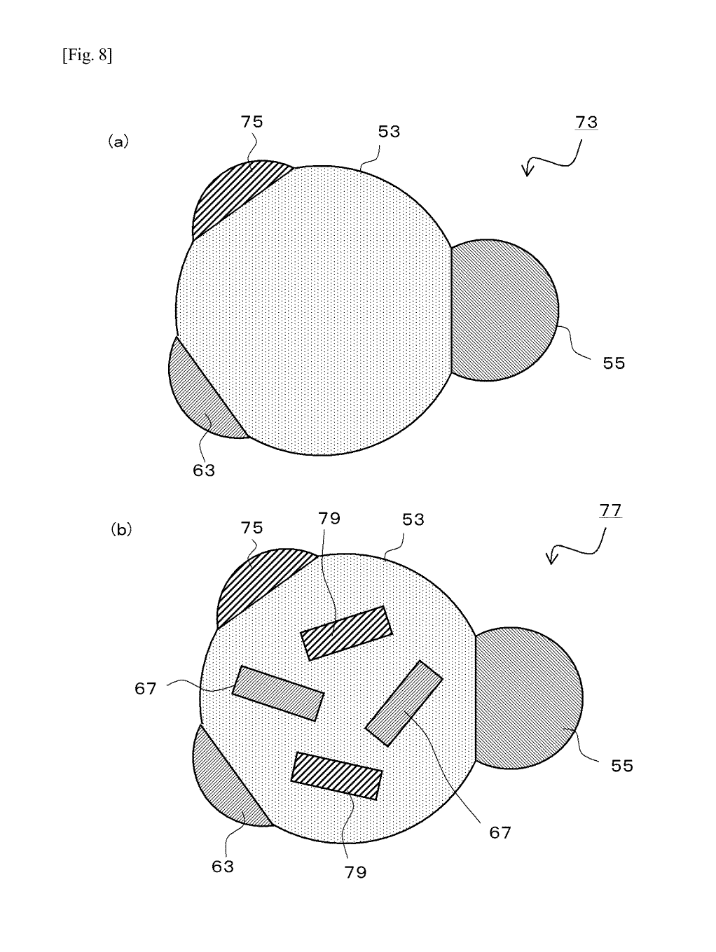

Further, nanosized particle 61 of the third embodiment may contain element D and element D′, as in nanosized particle 73 shown in FIG. 8 (a), and an eleventh phase 75 that is bound to the sixth phase 53 may be formed. The eleventh phase 75 is a compound of element A and element D′. The eleventh phase 75 is bound to the sixth phase 53 via an interface, and is exposed to the outer surface. For example, a case where element A is silicon, element D is iron, element D′ is cobalt, the sixth phase 53 is a simple substance or solid solution of silicon, the ninth phase 63 is iron silicide, and the eleventh phase 75 is cobalt silicide, is exemplified. In such a case, a solid solution of iron and cobalt may be formed within the sixth phase 53.

Element D′ is an element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, and differs from element D.

Further, nanosized particle 73 of the third embodiment may, as with nanosized particle 77 shown in FIG. 8(b), contain element D and element D′, and have a tenth phase 67, which is a compound of element A and element D, and a twelfth phase 79, which is a compound of element A and element D′, dispersed in the sixth phase 53. The twelfth phase 79 is covered by the sixth phase 53. The twelfth phase, as with the eleventh phase 75, hardly occludes lithium or occludes lithium in a minimal amount.

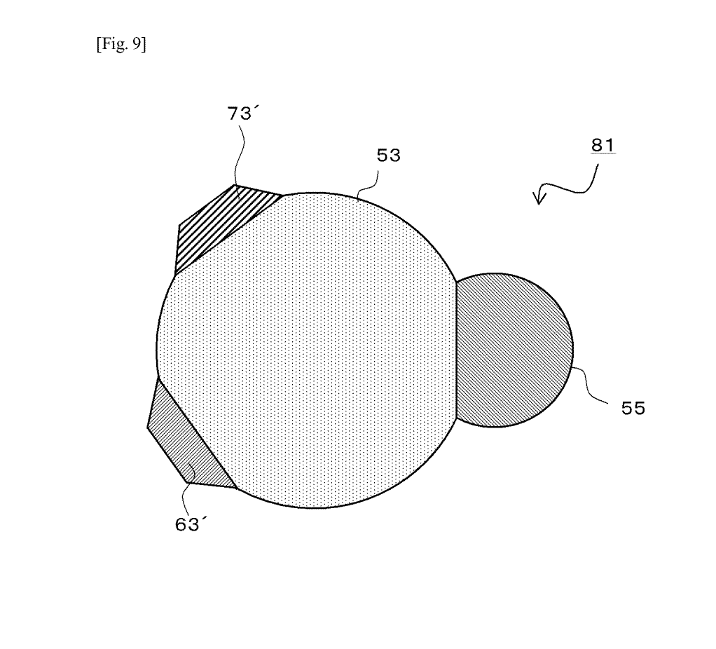

Further, the configuration of the surfaces of the ninth phase 63 and the eleventh phase 75 other than their interface may be spherical with a more or less smooth surface, as in the ninth phase 63 shown in FIG. 6(a) or the eleventh phase 75 shown in FIG. 8(a), or may be polyhedral, as in the ninth phase 63′ and eleventh phase 75′ of nanosized particle 81, shown in FIG. 9. The ninth phase 63′ and the eleventh phase 75′ are of a polyhedral configuration due to the effect of the crystal of the compound of element A and element D.

Multiple nanosized particles may bond with each other via the ninth phase 63 or the eleventh phase 75, to form a conjugate. Further, a nanosized particle may part from a composite of multiple nanosized particles bound together, to form a polyhedral configuration at the junction.

### (3-2. Effect of the Third Embodiment)

According to the third embodiment, added to the effects obtained by the second embodiment, there is an effect in that nanosized particle 61 is less likely to pulverize when lithium is occluded. In the third embodiment, when the sixth phase 53 occludes lithium, volume expansion occurs, but because the seventh phase 55 and the ninth phase 63 hardly occlude lithium, the expansion of the sixth phase 53, which is bound to the seventh phase 55 and the ninth phase 63, is suppressed. That is, even though the sixth phase 53 tries to expand in volume by occluding lithium, the interface between the sixth phase 53 and the seventh phase 55 or the ninth phase 63 hardly slip, because the seventh phase 55 and the ninth phase 63 hardly expand, and the seventh phase 55 and the ninth phase 63 show wedge-like or pin-like effects to alleviate the volumetric distortion and suppresses the expansion of the entire nanosized particle. Thus, compared to a particle that does not have a ninth phase 63, the nanosized particle 61, which has a ninth phase 63, hardly expands during lithium occlusion. During lithium discharge, a restoring force works to return to its original configuration. Therefore, in nanosized particle 61, the distortion accompanying volume expansion is suppressed, even when lithium is occluded and discharged, and the deterioration of discharge capacity after repeated charge-and-discharge can be suppressed.

Further, in nanosized particle 65 and nanosized particle 71, which contain a tenth phase 67 within the sixth phase 53, the expansion of the sixth phase 53 is more effectively suppressed with less amount of the tenth phase 67, since a large part of the sixth phase 53 is in contact with a phase that does not occlude lithium. As a result, in nanosized particles 65 and 71, volume expansion is suppressed even when lithium is occluded, and the deterioration of discharge capacity after repeated charge-and-discharge is further suppressed.

Nanosized particle 69 and nanosized particle 71, which comprise both the seventh phase 55 and the eighth phase 59 show effects similar to those of nanosized particle 51, and further, the current collectivity is effectively enhanced, since current collecting spots of nano-level are increased. Thus, the high-rate characteristic is enhanced.

Similarly, nanosized particle 73 and nanosized particle 77, which comprise both the ninth phase 63 and the eleventh phase 75, show effects similar to those of nanosized particle 51, and further, the current collectivity is effectively enhanced, since current collecting spots of nano-level are increased. Thus, the high-rate characteristic is enhanced.

Furthermore, in nanosized particle 77, which contain a tenth phase 67 and a twelfth phase 79 within the sixth phase 53, a large part of the sixth phase 53 is in contact with a phase that hardly occludes lithium, or occludes very little lithium, and thus, the expansion of the sixth phase 53 is further suppressed. As a result, in nanosized particle 77, the deterioration of discharge capacity after repeated charge-and-discharge is further suppressed, and the high-rate characteristic is enhanced.

### (4. Method of Producing Nanosized Particles of the Second Embodiment and Third Embodiment)

The method for producing the nanosized particle of the present invention will be described. The nanosized particles of the present invention are synthesized by the vapor phase synthesis method. In particular, by plasmatizing a raw material powder and heating up to about the equivalent of 10,000 K, then cooling, such nanosized particles can be produced. As for the method of plasma generation, (1) a method of utilizing high-frequency electromagnetic field to heat gas inductively; (2) a method of utilizing arc discharge between electrodes; (3) a method of heating gas by microwave, are known, and all are applicable.

A specific example of the production apparatus used for the production of the nanosized particle is the nanosized particle production apparatus 21 of FIG. 4.

Since the method of producing nanosized particle is a bottom-up method, wherein nanosized particle is deposited from plasma, via gas and liquid to solid, the sixth phase 53 and the seventh phase 55 become approximately spherical, since a sphere is formed at the droplet stage. On the other hand, since the fracturing method and the mechanochemical method are a top down method where large particles are made smaller, the configuration of the particles become rugged, differing greatly from the spherical configuration of nanosized particle 51.

Afterward, such nanosized particles are heated in the atmosphere, to thereby advance the oxidization of the nanosized particle. For example, by heating at 250° C. for one hour in the atmosphere, the nanosized particle can be oxidized and stabilized. Further, by purposefully introducing oxygen as AO_{z} (0<z<1), the initial capacity can be suppressed while enhancing the service-life characteristic. For example, by introducing Si as element A and its oxide SiO₂, the composition ratio can easily be controlled.

Note that by using a mixed powder of a powder of element A and a powder of element M as the raw material nanosized particle 51 of the second embodiment can be obtained. On the other hand, when a mixed powder of a powder of each of element A, element M, and element D is used as the raw material, nanosized particle 61 of the third embodiment can be obtained. Further, when a mixed powder of a powder of each of element A, element M, element M′, and element D is used as the raw material, nanosized particle 69 of the third embodiment can be obtained. Furthermore, when a mixed powder of a powder of each of element A, element M, element D, and element D′ is used as the raw material, nanosized particle 73 of the third embodiment can be obtained.

### (5. Nanosized Particle of the Fourth Embodiment)

### (5-1. Composition of the Nanosized Particle of the Fourth Embodiment)

Nanosized particle 101 of the fourth embodiment will be described.

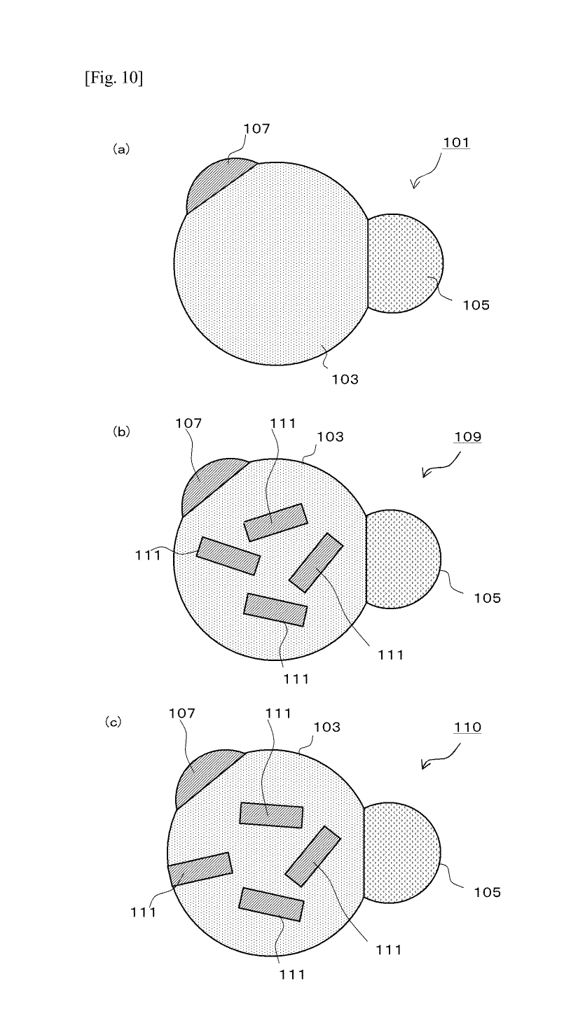

FIG. 10(a) is a schematic sectional view of nanosized particle 101. Nanosized particle 101 comprises a thirteenth phase 103, a fourteenth phase 105 and a fifteenth phase 107, wherein: the thirteenth phase 103, fourteenth phase 105, and fifteenth phase 107 are exposed to the outer surface of nanosized particle 101; the outer surface of the thirteenth phase 103, the fourteenth phase 105, and the fifteenth phase 107 other than their interface are approximately spherical; and the thirteenth phase 103 and the fourteenth phase 105 are bound via an interface, and the thirteenth phase 103 and the fifteenth phase 107 are bound via an interface.

The thirteenth phase 103 is a simple substance of element A-1, and A-1 is an element selected from the group consisting of Si, Sn, Al, Pb, Sb, Bi, Ge, In and Zn. Element A-1 is an element that easily occludes lithium. Note that the thirteenth phase 103 may be a solid solution composed mainly of element A-1. The element that forms a solid solution with element A-1 may be an element selected from the aforementioned group from which element A-1 can be selected, or an element that has not been listed in the aforementioned group. The thirteenth phase 103 can occlude and discharge lithium. The interface between the thirteenth phase 103 and the fourteenth phase 105 is flat or curved. The interface between the thirteenth phase 103 and the fifteenth phase 107 is flat or curved. Further, the fourteenth phase 105 and the fifteenth phase 107 may be bound via an interface.

The outer surface of the thirteenth phase 103 and the fourteenth phase 105 being approximately spherical except at their interface means that the thirteenth phase 103 and the fourteenth phase 105 are spherical or ellipsoid other than at the interface of the thirteenth phase 103 and the fourteenth phase 105. In other words, the surface of the thirteenth phase 103 and the fourteenth phase 105 other than the part where the thirteenth phase 103 and the fourteenth phase 105 are bound is composed mostly of a smooth curve. That is, the configuration of the thirteenth phase 103 and the fourteenth phase 105 differ from that of a solid obtained by a fracturing method, which contains angles. The same can be said for the fifteenth phase 107. Further, the configuration of the interface of the thirteenth phase 103 and the fourteenth phase 105, and the thirteenth phase 103 and the fifteenth phase 107 is circular or ellipsoidal.

The fourteenth phase 105 is a simple substance or solid solution of element A-2. Element A-2 is an element selected from the group consisting of Si, Sn, Al, Pb, Sb, Bi, Ge, In and Zn, and differs from element A-1. Element A-2 is an element that can occlude and discharge lithium.

Further, it is preferable that the thirteenth phase 103 is silicon with phosphorus or boron added thereto. By adding phosphorus or boron, the conductivity of silicon is enhanced. Indium and gallium can be used in place of phosphorus and arsenic may be used in place of boron. By increasing the conductivity of silicon in the thirteenth phase 103, the anode that utilizes such nanosized particle will have a smaller internal resistance, and becomes possible to conduct large currents, and will show superior high-rate characteristics. Furthermore, when the thirteenth phase 103 contains oxygen, sites that react with lithium can be suppressed. By containing oxygen, the capacity decreases, but volume expansion due to lithium occlusion can be suppressed. The amount of oxygen added z, is preferably in the range of AO_{z} (0<z<1). When z is larger than 1, the lithium occlusion site of A is suppressed, and the capacity will deteriorate.

The fifteenth phase 107 is a compound of element A and element D, and is crystalline. Element D is at least one element selected from the group consisting of Fe, Co. Ni, Ca, Sc, Ti, V, Cr, Mn, Sr, Y, Zr, Nb, Mo, Ru, Rh, Ba, lanthanoid elements (not including Ce and Pm), Hf, Ta, W, Re, Os and Ir. Element D is an element that hardly occludes lithium, and can form compound DAₓ (1<x≦3) with element A. For most elements A, x=2, as in FeSi₂ and CoSi₂. However, it may also be x=1.33, as in the case of Rh₃Si₄ (RhSi_{1.33}), or x=1.5, as in the case of Ru₂Si₃ (RuSi_{1.5}), or x=1.67, as in Sr₃Si₅ (SrSi_{1.67}), x=1.75, as in Mn₄Si₇ (MnSi_{1.75}) and Tc₄Si₇ (TcSi_{1.75}), or even x=3 as in the case of IrSi₃. The fifteenth phase 107 hardly occludes lithium, or occludes lithium at a minimal amount.

The average particle diameter of nanosized particle 101 is preferably 2 to 500 nm, and more preferably 50 to 300 nm. According to the Hall-Petch law, the smaller the particle size, the larger the yield stress is. Thus, if the average particle diameter of the nanosized particle 101 is 2 to 500 nm, the particle size is sufficiently small and the yield stress is sufficiently large. Hence, pulverization due to charge-and-discharge is less likely to occur. Note that when the average particle diameter is smaller than 2 nm, the handling of the nanosized particle after synthesis becomes difficult, and when the average particle size is larger than 500 nm, the particle size becomes too large, making its yield stress insufficient.

Note that particles usually exist as aggregates, and here, the average particle size of the nanosized particle refers to the average particle size of the primary particle. For the measurement of particle, image information obtained by an electron microscope (SEM) and volume-based median diameter obtained by the dynamic light scattering photometer (DLS) are used in combination. The average particle size can be obtained by confirming the particle configuration by SEM image beforehand, and using image analysis (for example, “A-zo-kun” (registered trademark) by Asahi Engineering Corporation), or by subjecting to measurement by DLS (for example, DLS-8000 by Otsuka Electronics Co. Ltd.) after dispersing in a solvent. If the particles are sufficiently dispersed and are not aggregated, the measurement results of SEM and DLS should be about equal. Further, the average particle size can also be obtained by defining the average particle size by its primary particle and analyzing its SEM image, even when the configuration of the nanosized particle is a highly developed structured configuration as in acetylene black. Moreover, the average particle size can be obtained by measuring the specific surface area through the BET method etc., and assuming that it is a spherical particle. This method must be applied by confirming that the nanosized particle is solid rather than porous by SEM observation and TEM observation.

The atomic ratio of element D in the sum of element A-1, element A-2, and element D is preferably 0.01 to 25%. If this atomic ratio is 0.01 to 25%, cycle characteristic and high capacity can coexist when the nanosized particle 101 is used as an anode material in lithium ion secondary batteries. On the other hand, when it is lower than 0.01%, the volume expansion of the nanosized particle 101 during lithium occlusion cannot be suppressed, and when it is larger than 25%, the amount of element A-1 bonding to element D becomes large, decreasing the number of element A-1-sites to which lithium can occlude, and thus, the advantage of being high capacity diminishes. Note that when the nanosized particle contains element D′, it is preferable that the atomic ratio of the sum of element D and element D′ to the sum of element A-1, element A-2, element D and element D′ is 0.01 to 25%.

Further, as with nanosized particle 109 shown in FIG. 10(b), a sixteenth phase 111, which is a compound of element A and element D, may be dispersed in the thirteenth phase 103. The sixteenth phase 111 is covered by the thirteenth phase 103. As with the fifteenth phase 107, the sixteenth phase 111 hardly occludes lithium. Further, as shown in FIG. 10(c), part of the sixteenth phase 111 may be exposed to the surface. That is, the thirteenth phase 103 does not necessarily have to cover the entire periphery of the sixteenth phase 111, and only part of the sixteenth phase 111 may be covered by the thirteenth phase 103.

Note that although in FIG. 10(b) a plurality of the sixteenth phase 111 are dispersed in the thirteenth phase 103, a single sixteenth phase 111 may be incorporated.

Further, as shown in nanosized particle 113 of FIG. 11(a), a seventeenth phase 115, which is a compound of element A and element D, may be bound to the fourteenth phase 105 via an interface, and be exposed to the outer surface. As with the fifteenth phase 107 the seventeenth phase 115 hardly occludes lithium.

Furthermore, the configuration of the surface of the fifteenth phase 107 other than the interface may more or less be a smooth spherical surface, as the fifteenth phase 107 shown in FIG. 10(a), or polyhedral as shown in the fifteenth phase 107′ in FIG. 11(b). The polyhedral configuration is generated by the nanosized particles 101, 109, 110, 113 or 117, binding via the fifteenth phase, and then exfoliating.

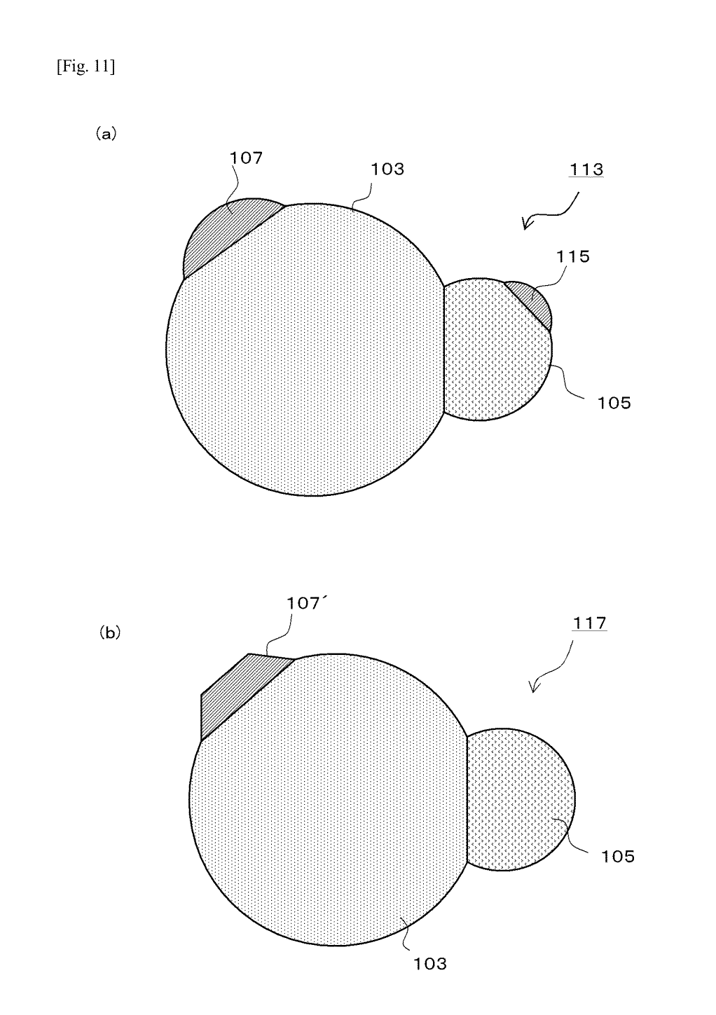

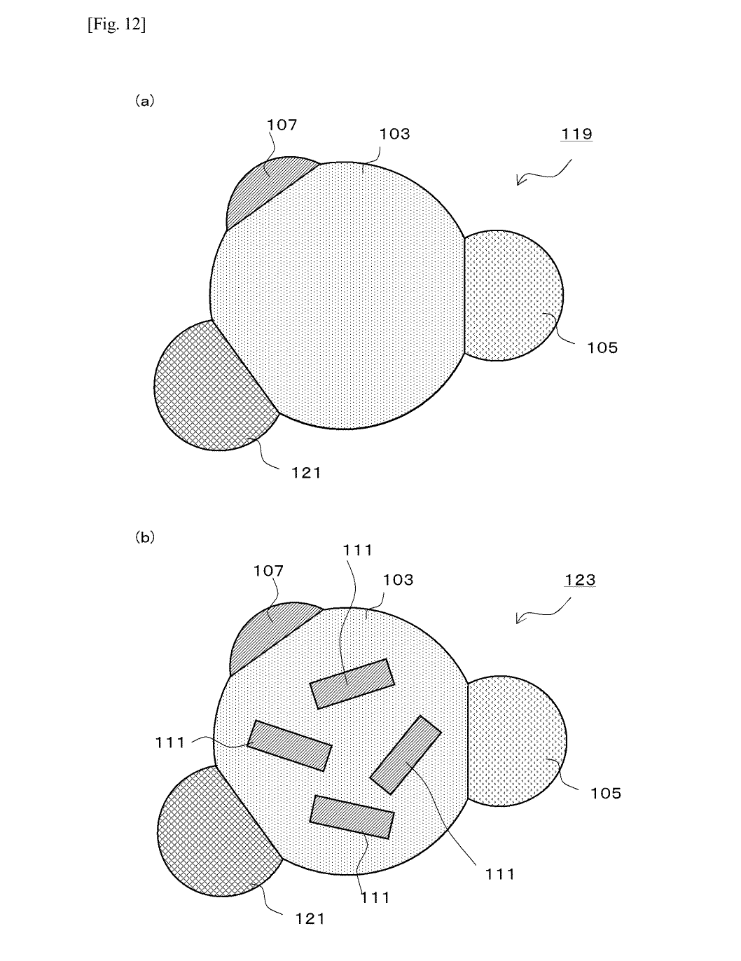

Further, nanosized particle 101 may comprise an eighteenth phase 121, along with a fourteenth phase 105, as nanosized particle 119 shown in FIG. 12(a). The eighteenth phase 121 is a simple substance or a solid solution of element A-3, and element A-3 is an element selected from the group consisting of Si, Sn, Al, Pb, Sb, Bi, Ge, In and Zn, and differs from element A-1 and element A-2. The outer surface of the eighteenth phase 121 is spherical and is exposed to the outer surface of nanosized particle 119. For example, as element A-1, silicon may be used, as element A-2, tin may be used, and as element A-3, aluminum may be used. Further, as nanosized particle 123 shown in FIG. 12(b), a sixteenth phase 111, which is a compound of element A and element D, may be dispersed in the thirteenth phase 103.

When element D is two or more elements selected from the group from which element D can be selected, the fifteenth phase 107 and/or sixteenth phase 111, which are compounds of one particular element D and element A, may contain another one of element D as a solid solution or a compound. That is, even when the nanosized particle contains two or more elements selected from the group from which element D can be selected, as with the later-described element D′, a nineteenth phase 127 may not be formed. For example, when element A is Si, one of element D is Ni, and the other element D is Fe, Fe may exist within NiSi₂ as a solid solution. Further, when observed by EDS, the distribution of Ni and the distribution of Fe may be approximately equal or different, and the other element D may be contained uniformly or partially in the fifteenth phase 107 and/or sixteenth phase 111.

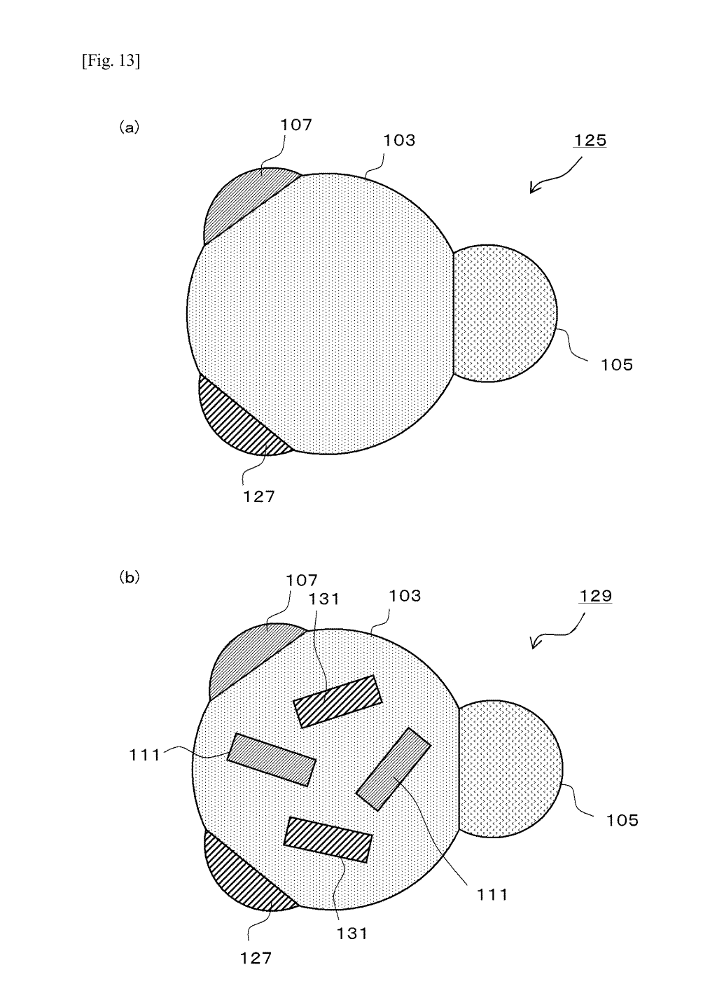

Furthermore, the nanosized particle may contain element D′, in addition to element D. Element D′ is an element selected from the group from which element D can be selected, and element D and element D′ are different elements. Nanosized particle 125 of FIG. 13(a) contains element D and element D′, and comprises a nineteenth phase 127, in addition to the fifteenth phase 107, which is a compound of element A and element D. The nineteenth phase 127 is a compound of element A and element D′. Nanosized particle 125 may contain a solid solution consisting of element D and element D′ (not shown in the figure). For example, a case where the fifteenth phase 107 is a compound of Si and Fe, the nineteenth phase 127 is a compound of Si and Co, and the solid solution consisting of element D and element D′ is a solid solution of Fe and Co, can be listed.

Further, as nanosized particle 129 shown in FIG. 13(b), a sixteenth phase 111 that is a compound of element A and element D, and a twentieth phase 131 that is a compound of element A and element D′, may be dispersed in the thirteenth phase 103. Furthermore, the sixteenth phase 111 or the twentieth phase 131 may be exposed to the surface as shown in FIG. 10(c).

Note that oxygen may be bonded to the outer-most surface of the nanosized particle 101. This is because when nanosized particle 101 is taken out into air, the oxygen in the air reacts with the elements on the surface of the nanosized particle 101. That is, the outer-most surface of the nanosized particle 101 may comprise an amorphous layer with a thickness of 0.5 to 15 nm. In particular, when the thirteenth phase is mainly crystalline silicon, it may comprise an oxide film layer.

### (5-2. Effect of the Nanosized Particle of the Fourth Embodiment)

According to the present invention, when the thirteenth phase 103 occludes lithium, volume expansion occurs, but the fourteenth phase 105 also expands with lithium occlusion. However, since the electrochemical potential of lithium occlusion for the thirteenth phase 103 and the fourteenth phase 105 differ, one phase occludes lithium preferentially, and while this phase undergoes volume expansion, the volume expansion of the other phase becomes relatively small. Thus, due to the other phase, one phase becomes less likely to undergo volume expansion. Hence, compared to a particle that comprises only one phase, nanosized particle 101, which comprises a thirteenth phase 103 and a fourteenth phase 105 hardly expands when occluding lithium, and the amount of lithium occlusion is suppressed. Therefore, according to the present invention, the volume expansion of nanosized particle 101 is suppressed, even when lithium is occluded, and the deterioration of discharge capacity after repeated charge-and-discharge is suppressed.

Further, when the thirteenth phase 103 occludes lithium, volume expansion occurs, but the expansion of the thirteenth phase 103, which is in contact with the fifteenth phase 107 is suppressed, since the fifteenth phase 107 hardly occludes lithium. That is, even though the thirteenth phase 103 tries to expand in volume by occluding lithium, the interface between the thirteenth phase 103 and the fifteenth phase 107 hardly slips, because the fifteenth phase 107 hardly expands, and the fifteenth phase 107 shows a wedge-like or pin-like effect to alleviate the volumetric distortion and suppresses the expansion of the entire nanosized particle. Thus, compared to a particle that does not have a fifteenth phase 107 the nanosized particle 101, which has a fifteenth phase 107, hardly expands during lithium occlusion. During lithium discharge, a restoring force works to return to its original configuration. The amount of lithium occlusion is controlled. Therefore, according to the present invention, in nanosized particle 101, the distortion accompanying volume expansion is suppressed even when lithium is occluded, and the deterioration of discharge capacity after repeated charge-and-discharge can be suppressed.

Furthermore, according to the present invention, since nanosized particle 101 hardly expands, even when nanosized particle 101 is taken out in the atmosphere, it hardly reacts with oxygen in the atmosphere. When a nanosized particle that comprise only one phase is left in the atmosphere without surface protection, reaction with oxygen begins at the surface, and oxidation advances into the particle from the surface, thus oxidizing the entire particle. However, when the nanosized particle 101 of the present invention is left in the atmosphere, although the outer-most surface of the particle reacts with oxygen, because the overall nanosized particle hardly expands, it is difficult for oxygen to penetrate into the particle, and oxidation does not extend to the center of the nanosized particle 101. Thus, although regular metallic nanoparticles have large specific surface areas and tend to oxidize and lead to heat generation and volume expansion, nanosized particle 101 of the present invention does not require a special surface coat of organic substances or metal oxides, can be handled on its own in the atmosphere as a powder, and is industrially useful.

According to the present invention, since the thirteenth phase 103 and the fourteenth phase 105 are both composed of elements that can occlude a much larger amount of lithium than carbon, nanosized particle 101 has a larger lithium-occlusion volume than anode active materials of carbon.

Furthermore, according to the present invention, since the fourteenth phase 105 has a higher conductivity than the thirteenth phase 103, nanosized particle 101 comprises current collecting spots of nano-level within nanosized particle 101, and becomes an anode material of good conductivity. Thus, an anode with superior current collectivity can be obtained. In particular, when the thirteenth phase 103 is formed of silicon, which has low conductivity, by using metal elements that show higher conductivity than silicon, such as tin and aluminum, in the fourteenth phase 105, an anode material with better conductivity than silicon-nanoparticles can be obtained.

Further, in nanosized particle 109, which contains a sixteenth phase 111 within the thirteenth phase 103, the expansion of the thirteenth phase 103 is more effectively suppressed, since a large part of the thirteenth phase 103 is in contact with a phase that hardly occludes lithium. As a result, in nanosized particle 109, volume expansion is suppressed even when lithium is occluded, and the deterioration of discharge capacity after repeated charge-and-discharge is further suppressed.

In nanosized particles 119 and 123, which comprise a fourteenth phase 105, a fifteenth phase 107, and an eighteenth phase 121, and in nanosized particles 125 and 129, which comprise a fourteenth phase 105, a fifteenth phase 107, and a nineteenth phase 127, the number of current collecting spots of nano-level are increased and the current collectivity is enhanced effectively.

Furthermore, in nanosized particle 123, which contain a sixteenth phase 111 within the thirteenth phase 103, and nanosized particle 129, which contain a sixteenth phase 111 and a twentieth phase 131 within the thirteenth phase 103, a large part of the thirteenth phase 103 is in contact with a phase that hardly occludes lithium, and thus, the expansion of the thirteenth phase 103 is further suppressed. As a result, in nanosized particle 123 and nanosized particle 129, volume expansion is suppressed, even when lithium is occluded, and the deterioration of discharge capacity after repeated charge-and-discharge is further suppressed.

### (5-3. Method for Producing Nanosized Particles)

A method for producing the nanosized particle will be described.

The nanosized particles are synthesized by the vapor phase synthesis method. In particular, by plasmatizing a raw material powder and heating up to about the equivalent of 10,000 K, then cooling, such nanosized particles can be produced. As for the method of plasma generation, (1) a method of utilizing high-frequency electromagnetic field to heat gas inductively; (2) a method of utilizing arc discharge between electrodes; (3) a method of heating gas by microwave, are known, and all are applicable.

A specific example of the production apparatus used for the production of the nanosized particle is the nanosized particle production apparatus 21 of FIG. 4.

Since the method of producing nanosized particle is a bottom-up method, wherein the nanosized particle is deposited from plasma, via gas and liquid to solid, the thirteenth phase 103 and the fourteenth phase 105 become approximately spherical, since a sphere is formed at the droplet stage. On the other hand, since the fracturing method and the mechanochemical method are a top down method where large particles are made smaller, the configuration of the particles become rugged, differing greatly from the spherical configuration of nanosized particle 101.

Note that by using a mixed powder of powders of element A-1, element A-2 and element D as the raw material, nanosized particles 101, 109, 113 and 117 can be obtained. On the other hand, when a mixed powder of a powder of each of element A-1, element A-2, element A-3, and element D is used as the raw material, nanosized particles 119 and 23 can be obtained. Further, when a mixed powder of a powder of each of element A-1, element A-2, element D, and element D′ is used as the raw material, nanosized particle 125 and 129 can be obtained. These nanosized particles, regardless of the plasma generation apparatus being DC or AC, etc., the element components are plasmatized, cooled to a gas, and the component elements are uniformly mixed. By cooling further, the gas turns to nanosized particles via nanosized droplets.

### (6. Preparation of Lithium Ion Secondary Battery)

### (6-1. Preparation of the Anode for Lithium Ion Secondary Battery)

First, the method for producing an anode for lithium ion secondary battery will be described. Raw materials are subjected to kneading in a mixer to form a slurry. The slurry raw materials are nanosized particle 1, conductive agent, binding agent, thickener, and solvent etc.

The solid content contain 25 to 90 wt % of nanosized particles, 5 to 70 wt % of conductive agents, 1 to 30 wt % of binding agents, and 0 to 25% of thickeners.

As the mixer, standard kneading machines used for the preparation of slurry may be used; various machines known as kneaders, agitators, dispersers, and mixers may be used. Further, to prepare aqueous slurries, it is preferable that latexes (dispersions of rubber particles) such as styrene-butadiene-rubber (SBR) are used as the binding agent, and one or mixtures of more than two polysaccharides such as carboxymethyl cellulose and methyl cellulose are used as the thickener. Furthermore, to prepare organic slurries, polyvinylidene fluoride (PVdF) etc. may be used as the binder and N-methyl-2-pyrrolidone may be used as the solvent.

The conductive agent is a powder of at least one conductive substance selected from the group consisting of carbon, copper, tin, zinc, nickel, silver etc. It may be a powder of a simple substance of carbon, copper, tin, zinc, nickel, silver, or a powder of their alloys. For example, standard carbon blacks such as furnace black and acetylene black may be used. In particular, when element A of nanosized particle 1 is silicon of low conductivity, silicon will be exposed on the surface of nanosized particle 1, making the conductivity low. Thus, it is preferable to add carbon nanohorn as a conductive agent. Here, carbon nanohorns (CNH) have a structure wherein a graphene sheet is rolled to form a cone, and exist as aggregates with its actual configuration radial like an urchin, with multiple CNHs having their apex pointing outward. The outer circumference of the urchin-like aggregate of the CNH is about 50 nm to 250 nm. In particular, CNH with an average particle diameter of about 80 nm is preferable.

The average particle diameter of the conductive agent also refers to the average particle diameter of the primary particle. When a highly structured configuration is formed, as in acetylene black (AB), here, the average particle diameter will be defined in terms of its primary particle diameter, and the average particle diameter may be obtained by image analysis of the SEM image.

Furthermore, a particle-shaped conductive agent and a wire-shaped conductive agent can both be used. A wire-shaped conductive agent is a wire of a conductive substance, and conductive agents listed as the particle-shaped conductive substance may be used. As the wire-shaped conductive agent, linear substances with outer diameter of 300 nm or less, such as carbon fiber, carbon nanotube, copper wire, nickel wire, etc. may be used. By using wire-shaped conductive agents, electric connection with the anode active material and current collector can be easily maintained, and the current collectivity increases. Also, fibrous materials increase on the porous membrane of the anode, and cracks are less likely to occur in the anode. For example, AB and copper powder may be used as the particle-shaped conductive agent, and vapor grown carbon fiber (AGCF) may be used as the wire-shaped conductive agent. Note that wire-shaped conductive agents alone may be used on its own without adding particle-shaped conductive agents, too.

The length of the wire-shaped conductive agent is preferably 0.1 μm to 2 mm. The outer diameter of the conductive agent is preferably 4 nm to 1000 nm, and more preferably, 25 nm to 200 nm. If the length of the conductive agent is 1 μm or more, it is long enough to increase the productivity of the conductive agent, and if the length is 2 mm or shorter, application of the slurry becomes easy. Further, when the outer diameter of the conductive agent is thicker than 4 nm, synthesis becomes easy, and when it is thinner than 1000 nm, it becomes easy to knead the slurry. The outer diameter and length of the conductive agent may be measured by image analysis of SEM.

The binding agent is a resin binding agent, and fluoro-resins and rubbers such as polyvinylidene fluoride (PVdF) and styrene-butadiene rubber (SBR), as well as organic materials such as polyimide (PI) and acrylic may be used.

Next, using, for example, a coater, the slurry is applied on one side of a current collector. The coater may be a standard coating device that allows the application of slurry on the current collector. For example, a roll coater, a coater that utilizes a doctor blade, a comma coater, and die coater are listed.

As for the current collector, it is a foil composed of at least one metal selected from the group consisting of copper, nickel and stainless steel. Each may be used on its own or may be used as an alloy. The thickness is preferably 4 μm to 35 μm, and more preferably 8 μm to 18 μm.

The prepared slurry is applied uniformly to the current collector, dried at 50 to 150° C., and roll-pressed to control its thickness to obtain an anode for lithium ion secondary battery.

### (6-2. Preparation of Cathode for Lithium Ion Secondary Battery)

First, a cathode active material, conductive agent, binding agent and solvent is mixed to prepare a cathode active material composition. Said cathode active material composition is then directly applied on to a metal current collector such as aluminum foil and dried to prepare a cathode.

As the cathode active material, those generally used may all be used. For example, compounds such as LiCoO₂, LiMn₂O₄, LiMnO₂, LiNiO₂, LiCo_{1/3}Ni_{1/3}Mn_{1/3}O₂, and LiFePO₄ are listed.

As the conductive agent, for example, carbon black may be used. As the binding agent, for example, polyvinylidene fluoride (PVdF) or aqueous acryl-type binder is used, and as the solvent, N-methyl-2-pyrolidone (NMP) or water is used. Here, the content of cathode active material, conductive agent, binding agent and solvent are of a level normally used in lithium ion secondary batteries.

### (6-3. Separator)

As the separator, anything that is normally used in lithium ion secondary batteries, that has a function of insulating the electron conduction between the cathode and anode, may be utilized. For example, a microporous poly-olefin film may be used.

### (6-4. Electrolytic Solution, Electrolyte)

As for the electrolyte solution and electrolyte in lithium ion secondary batteries and Li polymer batteries, organic electrolyte solutions (non-aqueous electrolyte solution), inorganic solid electrolyte, polymeric solid electrolyte, etc. may be used.

Specific examples of solvents for organic electrolyte solutions are: carbonates such as ethylene carbonate, propylene carbonate, butylene carbonate, diethyl carbonate, dimethyl carbonate, methyl ethyl carbonate; ethers such as diethyl ether, dibutyl ether, ethylene glycol dimethyl ether, ethylene glycol diethyl ether, ethylene glycol dibutyl ether, diethylene glycol dimethyl ether; non-protic solvents such as benzonitrile, acetonitrile, tetrahydrofuran, 2-methyl tetrahydrofuran, γ-butyrolactone, dioxolane, 4-methyl dioxolane, N,N-dimethyl formamide, dimethyl acetamide, dimethyl chlorobenzene, nitrobenzene; and mixed solvents containing two or more of these solvents.

As the electrolyte in an organic electrolyte solution, one or two or more electrolytes consisting of lithium salts such as LiPF₆, LiClO₄, LiBF₄, LiAlO₄, LiAlCl₄, LiSbF₆, LiSCN, LiCl, LiCF₃SO₃, LiCF₃ CO₃, LiC₄F₉SO₃, LiN(CF₃SO₂)₂, may be used.

As an additive for the organic electrolyte, it is preferable to add a compound that can form an effective solid electrolyte interface film on the surface of the anode active material. For example, a substance that contains unsaturated bonds within the molecule and can undergo reduction polymerization during charging, such as vinylene carbonate (VC), is added.

Furthermore, in addition to the above-described organic electrolyte solution, solid lithium ion conductors may be used. For example, a solid polymer electrolyte obtained by mixing the above-mentioned lithium salt(s) with a polymer comprising polyethylene oxide, polypropylene oxide, polyethylene imine etc., and a polymer gel electrolyte obtained by soaking an electrolyte solution in a polymer material may be used.

Furthermore, various inorganic materials such as lithium nitrides, lithium halides, lithium oxoates, Li₄SiO₄, Li₄SiO₄—LiI—LiOH, Li₃PO₄—Li₄SiO₄, Li₂SiS₃, Li₃PO₄—Li₂S—SiS₂, and phosphorus sulfide compounds, may be used as an inorganic solid electrolyte.

### (6-5. Assembly of Lithium Ion Secondary Battery)

As described above, a separator is installed between the cathode and the anode to form the battery component. This battery component is wound or laminated and inserted into a cylindrical battery case or a rectangular battery case, after which the electrolyte solution is injected, to obtain a lithium ion secondary battery.

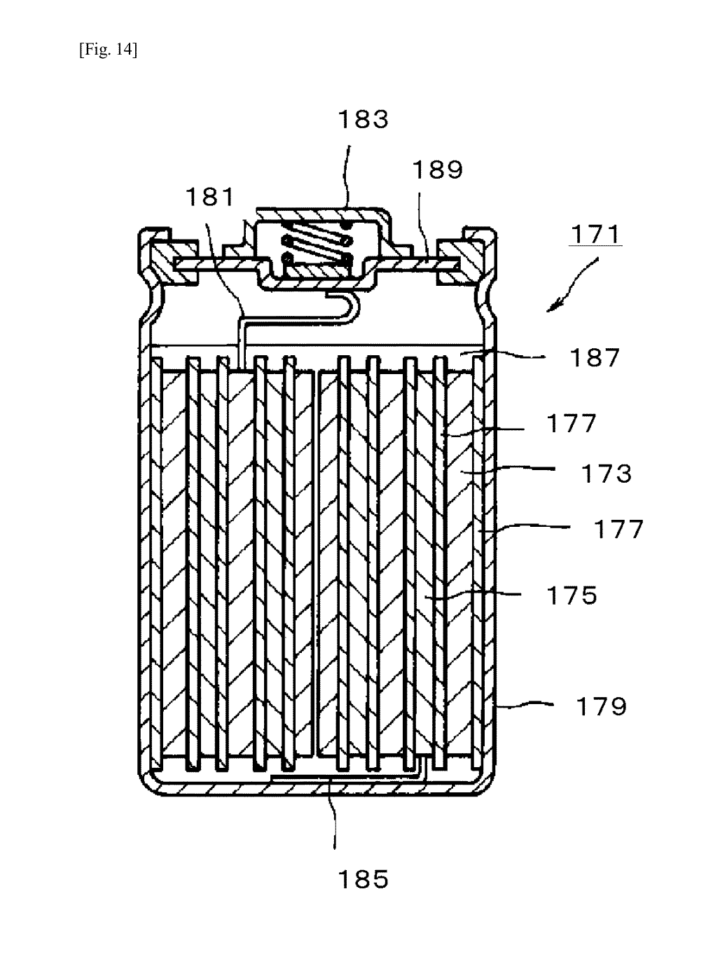

An example of the lithium ion secondary battery (sectional view) is shown in FIG. 14. In the lithium ion secondary battery 171, the cathode 173 and anode 175 are arranged in layers via the separator 177 in the order of separator-anode-separator-cathode, wound so that the group of electrodes is arranged with the cathode 173 on the inside, and inserted in a battery case 179. Then, the cathode 173 is connected to the cathode terminal 183 via a cathode lead 181, the anode is connected to the battery case 179 via an anode lead, so that the chemical energy generated within the lithium ion secondary battery 171 may be extracted out as electric energy. Subsequently, a non-aqueous electrolyte 187 is added to the battery case 179, so that the group of electrodes are covered, and a sealing material 189 comprising a circular cover plate and a cathode terminal 183 on its top, and a safety valve mechanism on the inside, is attached to the top end (opening) of the battery can 179 via a ring-shaped insulation gasket, to produce the lithium ion secondary battery 171 of the present invention.

### (6-6. Effect of the Lithium Ion Secondary Battery of the Present Invention)

Since the nanosized particle of the present invention contains element A, which has a higher per-unit-volume capacity than carbon, the lithium ion secondary battery, which utilizes the nanosized particle of the present invention as an anode material, has a higher capacity than conventional lithium ion secondary batteries. Further, since the nanosized particle of the present invention is not easily pulverized, the cycle characteristic is superior.

### EXAMPLE

Hereafter, the present invention is described more specifically using Examples and Comparative Examples.

### Example 1-1

### (Preparation of Nanosized Particles)

A raw material powder was prepared by mixing silicon powder and iron powder so that their molar ratio became Si:Fe=23:2, and drying the mixed powder. Using the apparatus of FIG. 4, the raw material powder was supplied continuously with a carrier gas into the plasma of Ar—H₂ mixed gas generated in the reaction chamber, to produce nanosized particles of silicon and iron.

More specifically, the nanosized particle was produced by the following method. After evacuating the reaction chamber with a vacuum pump, Ar gas was introduced to atmospheric pressure. This process of evacuation and Ar gas introduction was repeated three times to rid the reaction vessel of remaining air. Then, a mixed gas of Ar—H₂ was introduced into the reaction vessel at a flow rate of 13 L/min, and AC voltage was applied to the high-frequency coil, to generate high-frequency plasma by a high-frequency electromagnetic field (frequency of 4 MHz). Here, the plate electricity was set to 20 kW. Ar gas at a flow rate of 1.0 L/min was used as the carrier gas to supply the raw material powder. Gradual oxidation treatment was performed for more than 12 hours following reaction, and the fine powder obtained was recovered at the filter.

### (Evaluation of the Composition of the Nanosized Particle)

XRD analysis was performed to determine the crystallinity of the nanosized particle using RINT-UltimaIll of Rigaku Corporation. The XRD diffraction pattern of the nanosized particle of Example 1-1 is shown in FIG. 15. It was discovered that Example 1-1 comprises two components, Si and FeSi₂. Further, it was discovered that all of Fe exist as silicide FeSi₂, and Fe as a simple substance (0 valence) hardly existed.

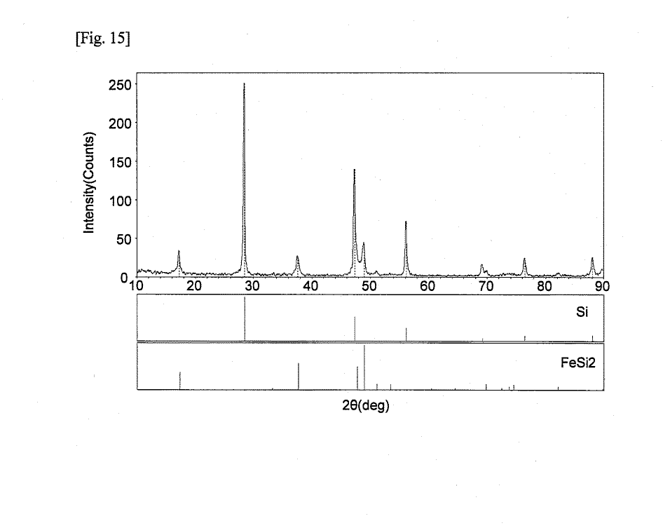

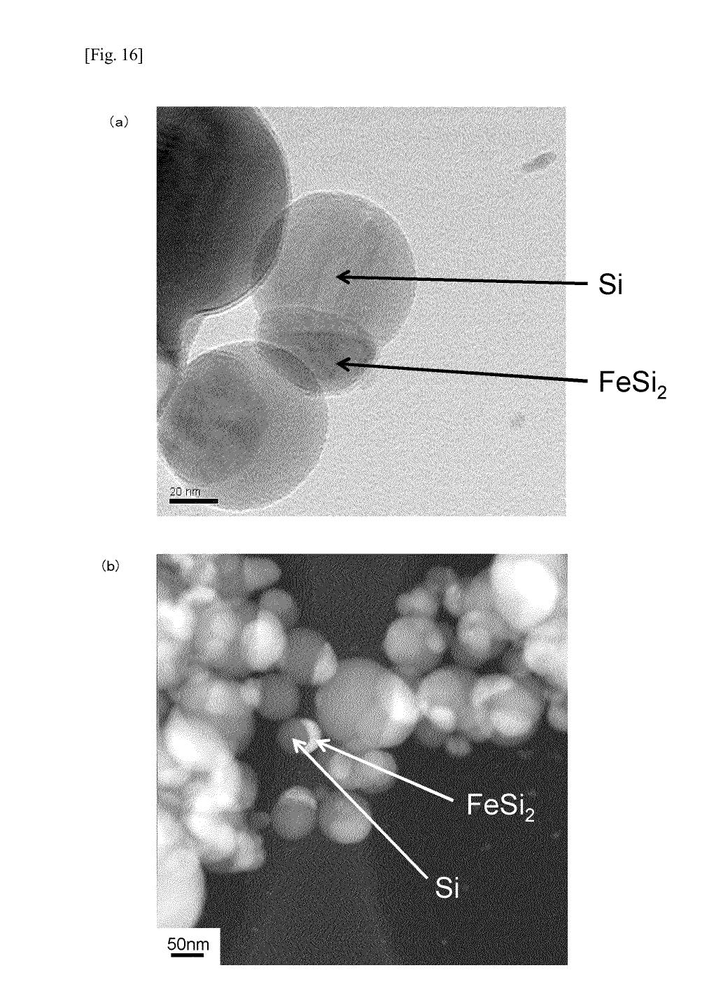

Observation of the particle configuration of the nanosized particle was performed using a scanning transmission electron microscope (JEM 3100FEF, by JEOL Ltd.). FIG. 16 (a) shows the BF-STEM (Bright-Field Scanning Transmission Electron Microscopy) image of the nanosized particle according to Example 1-1. Nanosized particles, wherein hemispherical particles are bound via an interface to particles of approximately spherical configuration with a particle diameter of about 80 to 100 nm, were observed. The relatively dark-colored parts within the same particle consist of iron silicide containing iron, and the relatively light-colored parts consist of silicon. Further, it can be seen that an amorphous oxide film of silicon with a thickness of 2 to 4 nm was formed on the surface of the nanosized particle. FIG. 16 (b) is a STEM image by HAADF-STEM (High-Angle-Annular-Dark-Field-Scanning-Transmission-Electron-Microscopy). In HAADF-STEM, the relatively light-colored parts within the same particle consist of iron silicide, and the relatively dark-colored parts consist of silicon.

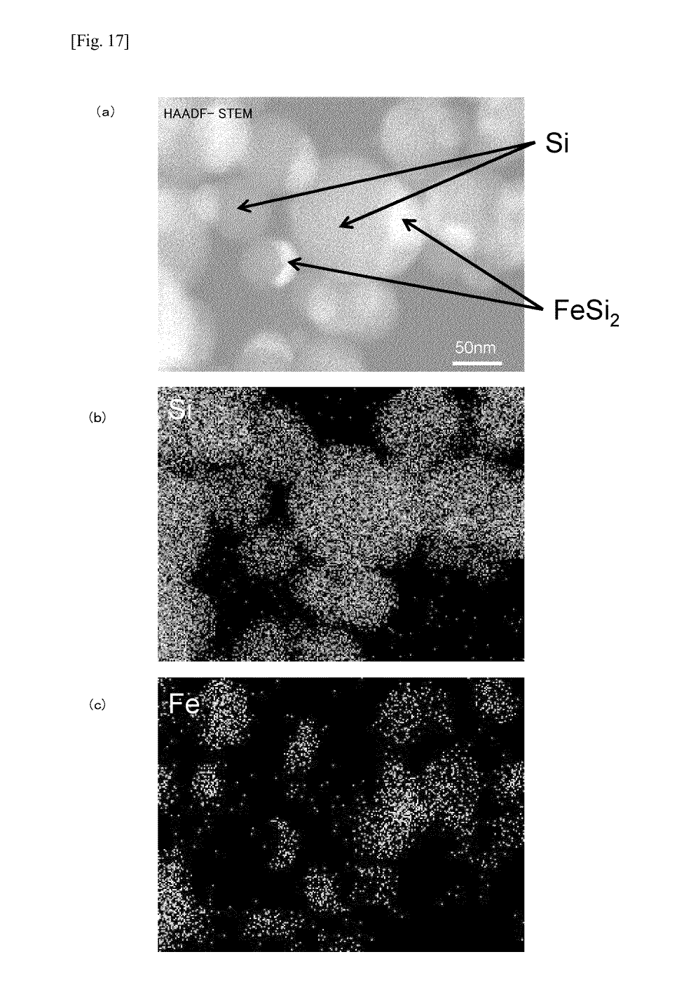

Using a scanning transmission electron microscope (JEM 3100FEF, by JEOL Ltd.), observation of the particle configuration was performed by HAADF-STEM, and the composition analysis was performed by EDS (Energy Dispersive Spectroscopy: energy dispersion-type X-ray analysis) analysis for the nanosized particles. FIG. 17 (a) shows the HAADF-STEM image of the nanosized particle, FIG. 17 (b) shows the EDS map of silicon atom at the same observation part, and FIG. 17 (c) shows the EDS map of iron atom at the same observation part.

According to FIG. 17 (a), nanosized particles with particle diameters of about 50 to 150 nm were observed, and each nanosized particle was of approximately spherical configuration. FIG. 17 (b) shows that silicon atoms exist throughout the entire nanosized particle and FIG. 17(c) shows that iron atoms are detected in the parts that were brightly observed in FIG. 17 (a). From these results, it was discovered that the nanosized particle has a structure in which a second phase consisting of a compound of silicon and iron is bound to a first phase consisting of silicon.

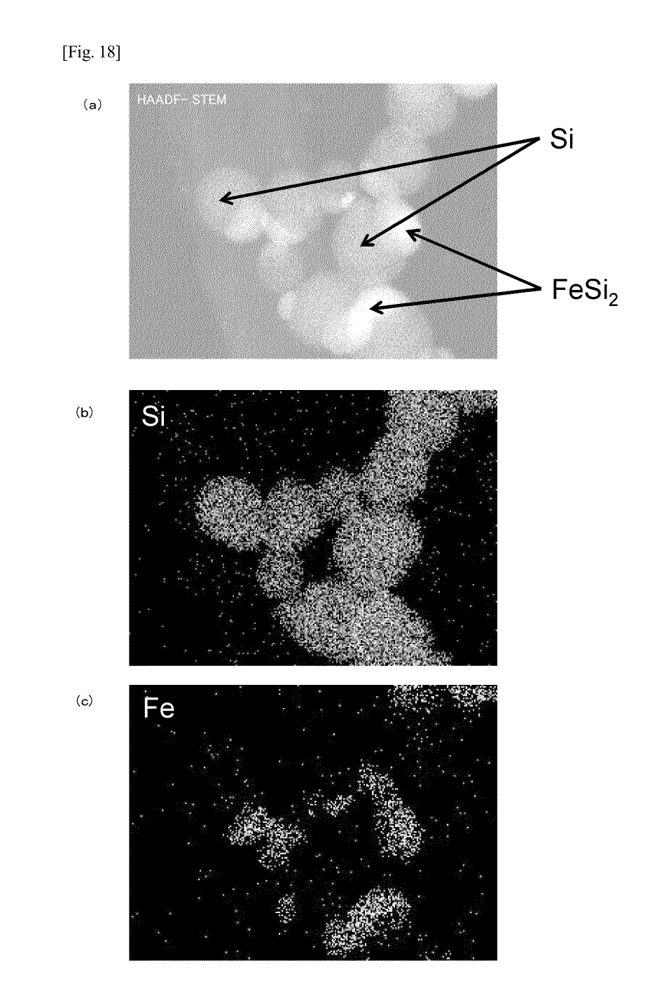

Similarly, in FIG. 18(a)-(c), the observation of the particle configuration and the composition analysis for the nanosized particle of Example 1-1 were performed. As with FIG. 17, FIG. 18 shows that a structure in which a second phase consisting of a compound of silicon and iron is bound to a first phase consisting of silicon exists.

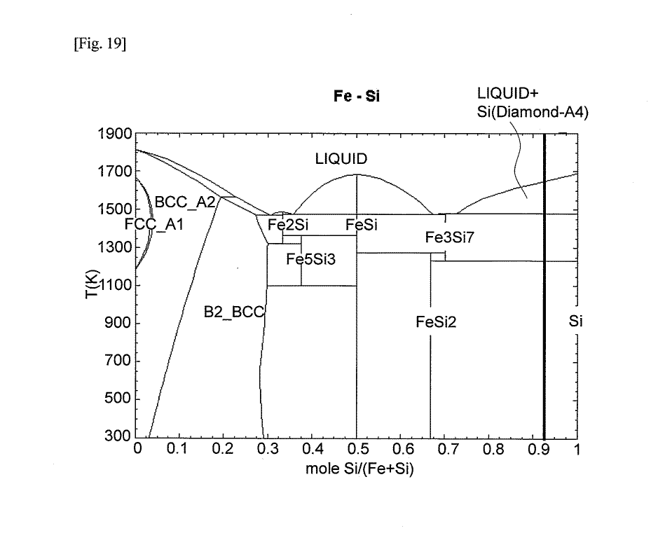

The formation process of the nanosized particle according to Example 1-1 will be discussed. FIG. 19 is a binary system phase diagram of iron and silicon. Since silicon powder and iron powder were mixed so that a molar ratio of Si:Fe=23:2 was obtained, mole Si/(Fe+Si)=0.92 for the raw material powder. The bold line in FIG. 19 is a line that indicates mole Si/(Fe+Si)=0.92. Since the plasma generated by the high-frequency coil was equivalent to 10,000 K, it exceeded the temperature range of the phase diagram by far, and plasma in which iron atoms and silicon atoms were uniformly mixed was obtained. When plasma is cooled, in the process of the change from plasma to gas, and gas to liquid, a spherical droplet grows. When it is cooled to about 1470 K, both Fe₃Si₇ and Si deposit. Then, by cooling to about 1220 K, Fe₃Si₇ undergoes phase change to FeSi₂ and Si. Therefore, when the plasma of silicon and iron is cooled, a nanosized particle, in which FeSi₂ and Si are bound via an interface, is formed.

### (Evaluation of the Powder Conductivity)

In order to evaluate the conductivity at the state of powder, the powder conductivity was evaluated using a powder resistance measurement system MCP-PD51 type of Mitsubishi Chemical Corporation. The conductivity was calculated from the resistance value obtained when a sample powder was compressed at an arbitrary pressure. The data shown in the later-shown Table 1 are values obtained when the sample powder was compressed at 63.7 MPa, and measured.

### (Evaluation of the Cycle Characteristic of the Nanosized Particle)

### (i) Preparation of the Anode Slurry

To a mixer was introduced the nanosized particle of Example 1-1 at a ratio of 45.5 parts by weight, and acetylene black (average particle diameter of 35 nm, powder, by DENKI KAGAKU KOGYO KABUSHIKI KAISHA) at a ratio of 47.5 parts by weight. Furthermore, as a binding agent, an emulsion of 40 wt % of styrene-butadiene rubber (SBR) (BM400B, by Nippon Zeon Co., Ltd.) at a solid content of 5 parts by weight, and as a thickener to control the viscosity of the slurry, a 1 wt % solution of sodium carboxymethyl cellulose (#2200, by Daicel Corporation) at a solid content of 10 parts by weight, were mixed to prepare a slurry.

### (ii) Preparation of Anode

Using a doctor blade of an automatic coating apparatus, the prepared slurry was applied on to a current collector electrolytic copper foil with a thickness of 10 μm (NC-WS by Furukawa Electric Co. Ltd.), at a thickness of 25 μm, and dried at 70° C., followed by a thickness control process by pressing, to produce an anode for lithium ion secondary battery.

(iii) Characteristic Evaluation

Three different lithium secondary batteries were prepared, using the anode for lithium ion secondary batteries, an electrolyte solution containing 1 mol/L of LiPF₆ and a mixed solution of ethylene carbonate and diethyl carbonate, and a counter electrode of metal Li foil, and the charge-and-discharge characteristic was investigated. As the characteristic evaluation, the initial discharge capacity and the discharge capacity after 50 cycles of charge-and-discharge were measured, and the maintenance factor of the discharge capacity was calculated. The discharge capacity was calculated based on the total weight of silicide and the active material Si effective for the occlusion and discharge of lithium. First, at an environment of 25° C., charging was performed up to a current of 0.1 C and a voltage of 0.02 V, under constant current constant voltage conditions, and charging was terminated when the current decreased to 0.05 C. Subsequently, at a condition of a current value of 0.1 C, discharge was performed until the voltage against metal Li became 1.5 V, and the initial discharge capacity at 0.1 C was measured. Note that 1 C refers to the value of current that can be fully charged in 1 hour. Further, both charge and discharge were performed under an environment of 25° C. Subsequently, the above-described charge-and-discharge at a charge-and discharge rate of 0.1 C was repeated for 50 cycles. The rate of the discharge capacity after repeating 50 cycles of charge-and-discharge against the initial discharge capacity at 0.1 C, was calculated in percentage, as the discharge capacity maintenance factor after 50 cycles. [Example 1-2]

Other than using a raw material powder prepared by mixing silicon powder and iron powder so that their molar ratio became Si:Fe=38:1 and drying the mixed powder, nanosized particles were synthesized by the same means as that of Example 1-1, and observed by XRD and STEM. Further, a lithium ion secondary battery was constructed by the same method as that of Example 1-1, and its cycle characteristic was measured.

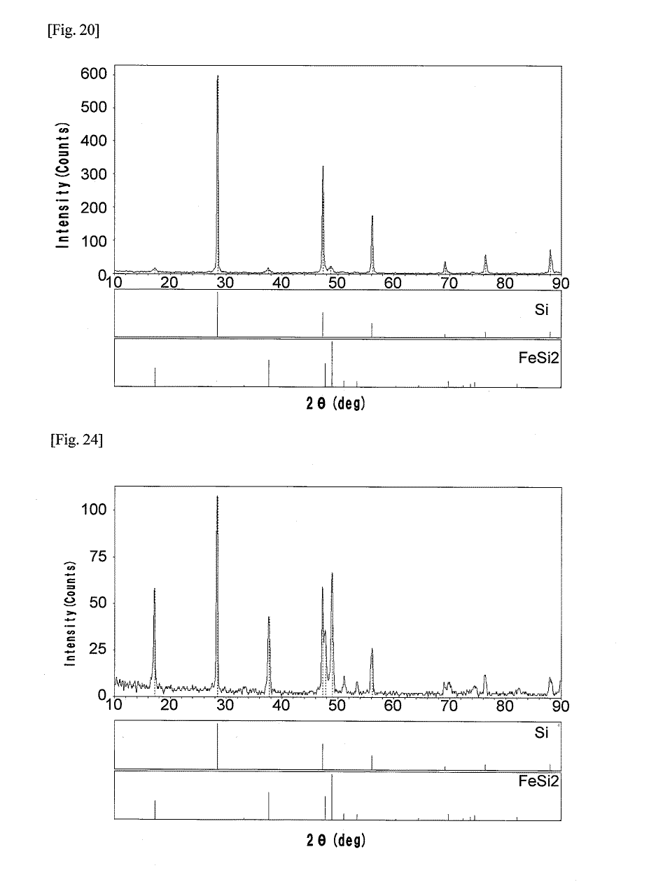

The XRD diffraction pattern of the nanosized particle of Example 1-2 is shown in FIG. 20. It was discovered that Example 1-2 comprises two components, Si and FeSi₂. Further, it was discovered that all of Fe exist as silicide FeSi₂, and Fe as a simple substance hardly existed. Further, compared to FIG. 15, the ratio of Fe was smaller than the nanosized particle of Example 1-1, and only traces of the peak derived from FeSi₂ was detected.

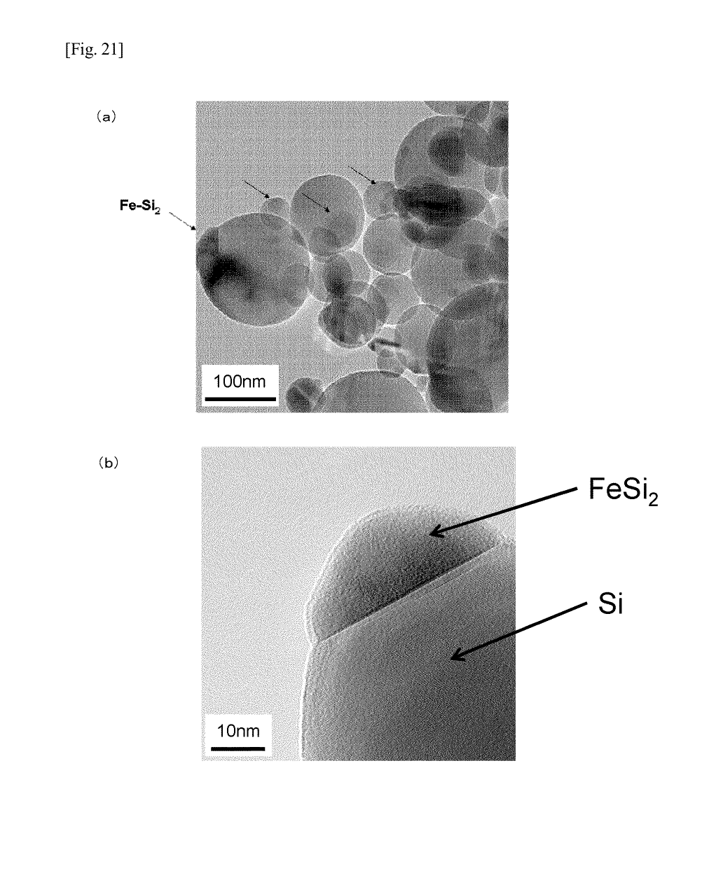

The observation result by STEM is shown in FIG. 21. According to FIG. 21(a), many particles of approximately spherical configuration with a diameter of about 50 to 150 nm were observed. It was determined that within particles that do not overlap, the dark-colored parts were iron silicide, and the light-colored parts were silicon. Further, from FIG. 21(b), it was observed that the atoms in the silicon part were arranged regularly, and that the silicon corresponding to the first phase was crystalline. Furthermore, it was determined that on the surface of the nanosized particle, an amorphous layer of about 1 nm thickness covered the silicon part, and an amorphous layer of about 2 nm thickness covered the iron silicide part. Furthermore, by comparing the STEM images of FIG. 16 and FIG. 21, the relative sizes of Si and FeSi₂ could be confirmed, and the FeSi₂ in the nanosized particle of Example 1-2, was smaller than the FeSi₂ in the nanosized particle of Example 1-1.

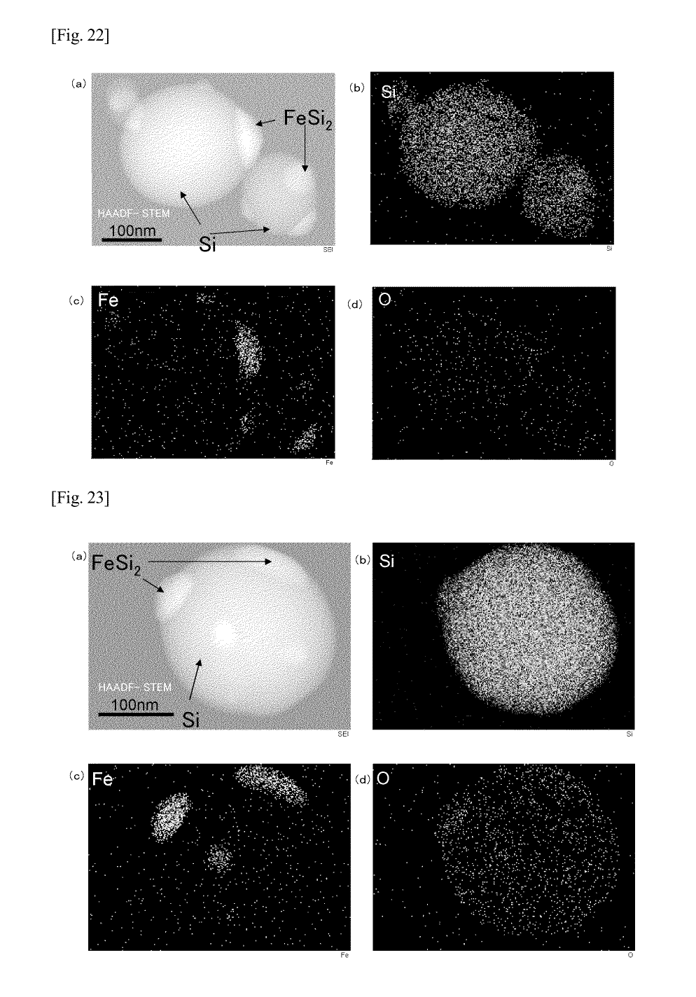

Observation of the particle configuration by HAADF-STEM and the result of EDS analysis are shown in FIG. 22 and FIG. 23. According to FIG. 22(a), nanosized particles with particle diameters of about 150 to 250 nm were observed, and each nanosized particle was approximately spherical in configuration. From FIG. 22(b), it was apparent that silicon atoms exist throughout the entire nanosized particle, and from FIG. 22(c), it was apparent that many iron atoms were detected in the part that was brightly observed in FIG. 22(a). FIG. 22 (d) shows that oxygen atoms presumably due to oxidization were slightly distributed throughout the entire nanosized particle.

Similarly, according to FIG. 23(a), nanosized particles of approximately spherical configuration with a particle diameter of about 250 nm were observed, and according to FIG. 23(b), silicon atoms were found to exist throughout the entire nanosized particle, and according to FIG. 23(c), many iron atoms were detected in the parts that were brightly observed in FIG. 23 (a). FIG. 23 (d) shows that oxygen atoms presumably due to oxidization were slightly distributed throughout the entire nanosized particle. From these findings, it was determined that the nanosized particle has a structure in which a second phase consisting of a compound of silicon and iron is bound to a first phase consisting of silicon.

### Example 1-3

Other than using a raw material powder prepared by mixing silicon powder and iron powder so that their molar ratio became Si:Fe=6:1 and drying the mixed powder, nanosized particles were synthesized by the same means as that of Example 1-1, and observed by XRD and STEM. Further, a lithium ion secondary battery was constructed by the same method as that of Example 1-1, and its cycle characteristic was measured.

The XRD diffraction pattern of the nanosized particle of Example 1-3 is shown in FIG. 24. As with Examples 1-1 and 1-2, it was discovered that Example 1-3 comprises two components, Si and FeSi₂. Further, it was discovered that all of Fe exist as silicide FeSi₂, and Fe as a simple substance (0 valence) hardly existed. Further, by comparing FIG. 24 to FIG. 15 or FIG. 20, the existence ratio of Fe for the nanosized particle of Example 1-3 was larger than those of the nanosized particle of Examples 1-1 or 1-2, and XRD peaks derived from FeSi₂ were clearly detected, indicating that the amount of iron silicide FeSi₂ was large.

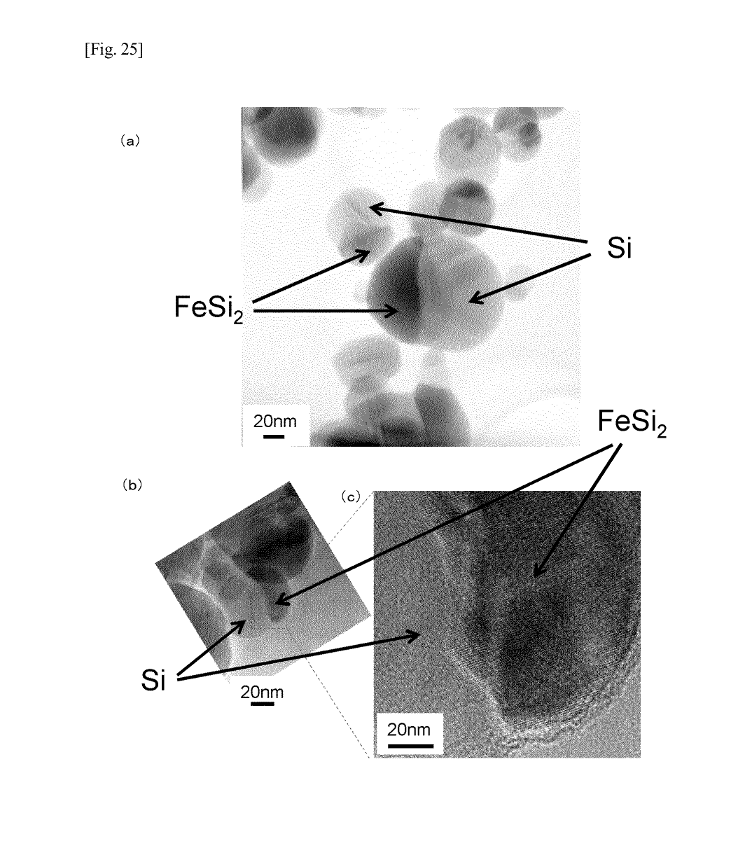

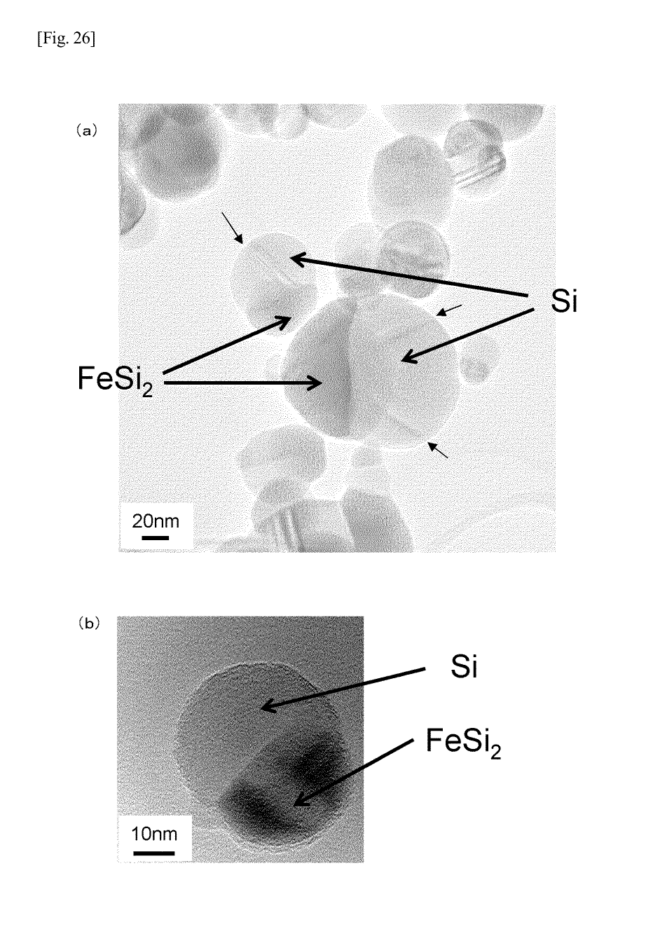

The observation results by STEM are shown in FIG. 25 and FIG. 26. The diameter was about 50 to 150 nm, and many particles comprised of particles with approximately spherical configuration bound via interfaces were observed. It was determined that within particles that do not overlap, the dark-colored parts were iron silicide, and the light-colored parts were silicon. Further, linear shadows were observed on the silicon, indicating that it is composed of a plurality of crystalline phases. By comparing the STEM images of FIG. 16 and FIG. 21, it was found that there were more dark-colored iron silicide parts. Furthermore, from FIGS. 25 (b) and (c), lattice image were observed in the iron silicide, thus indicating that iron silicide is crystalline.

FIG. 26 (a) shows a BF-STEM image from the same view point as that of FIG. 25 (a). Note that the shadow (such as that shown by the arrow) existing in the first phase (silicon part) appears to be the crystal interface, indicating that silicon is not a uniform crystal, but has different regions with different crystal orientation. FIG. 26 (b) shows the STEM image of an independent nanosized particle. A nanosized particle with a particle diameter of about 50 nm can be observed. It is determined that the light-colored part is silicon and the dark-colored part is FeSi₂.

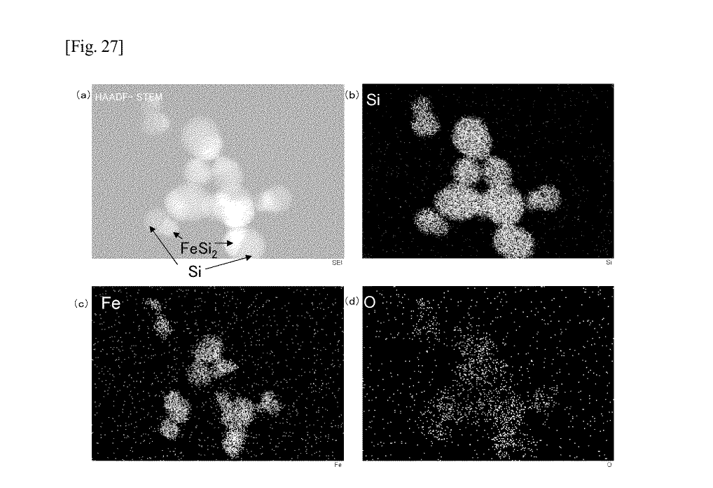

Observation of the particle configuration by HAADF-STEM and the result of EDS analysis are shown in FIG. 27. According to FIG. 27(a), nanosized particles of approximately spherical configuration are observed. From FIG. 27(b), it was apparent that silicon atoms exist throughout the entire nano sized particle, and from FIG. 27(c), it was determined that many iron atoms were detected in the part that was brightly observed in FIG. 27(a). FIG. 27 (d) shows that oxygen atoms presumably due to oxidization were slightly distributed throughout the entire nanosized particle.

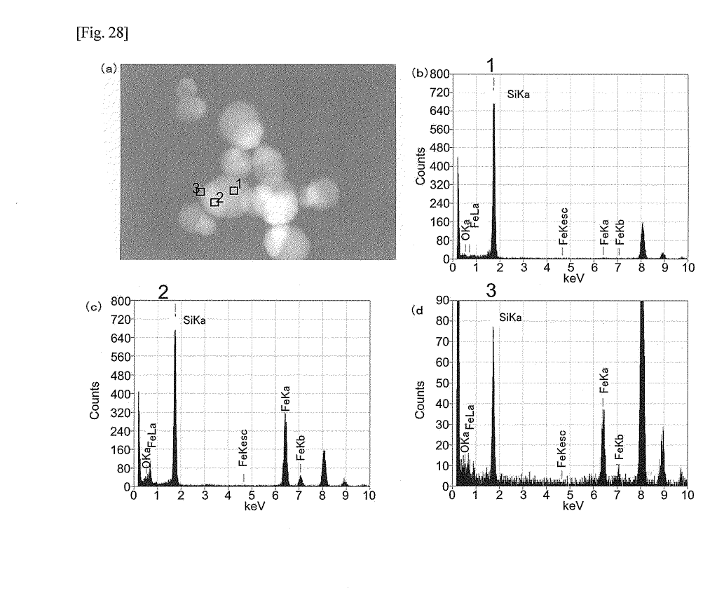

Further, the result of EDS point analysis is shown in FIG. 28. According to the HAADF-STEM image of FIG. 28(a), a Ka ray for Si was confirmed at point 1, and a Ka ray for Si and Fe were confirmed at point 2 and point 3. Together with the EDS mapping result of FIG. 27, the assignment of each component constituting the bound-type nanosized particle was determined.

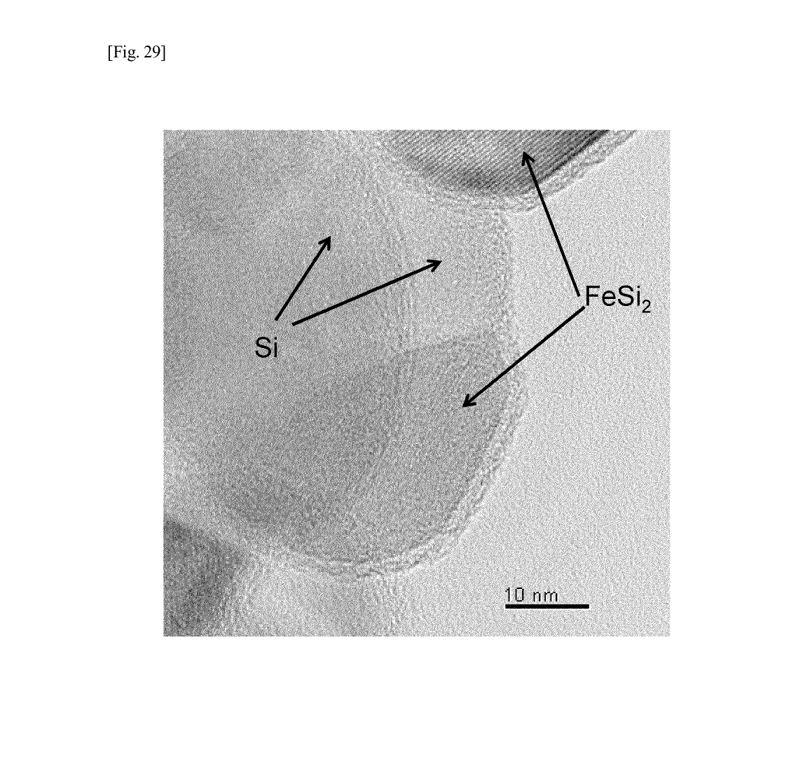

Furthermore, the high resolution TEM image is shown in FIG. 29. It was confirmed that an amorphous layer with a thickness of 2 to 4 nm existed on the exposed outer surface. Further, a lattice image of iron silicide was observed in the dark-colored part, indicating that a flat part existed on part of the outer periphery along the crystal surface.

### Example 1-4

Other than using a raw material powder prepared by mixing silicon powder and titanium powder so that their molar ratio became Si:Ti=11:1 and drying the mixed powder, nanosized particles were synthesized by the same means as Example 1-1, and observed by XRD and STEM. Further, a lithium ion secondary battery was constructed by the same method as that of Example 1-1, and its cycle characteristic was measured.

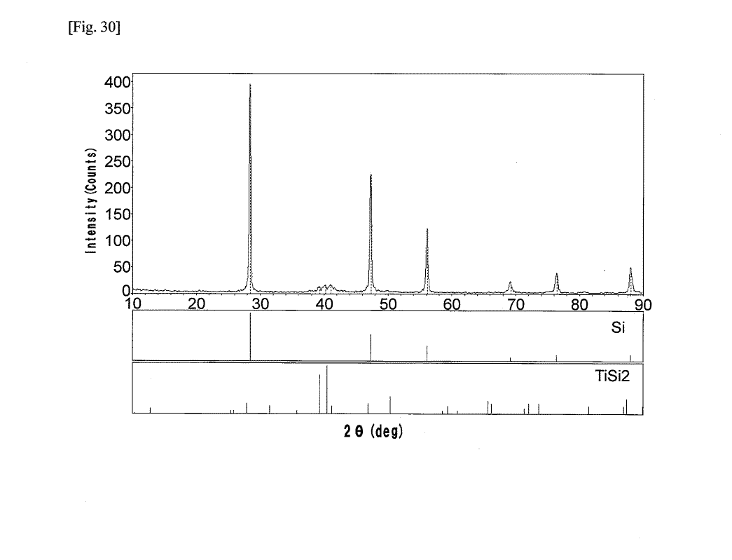

The XRD diffraction pattern of the nanosized particle of Example 1-4 is shown in FIG. 30. It was discovered that Example 1-4 comprises two components, Si and TiSi₂. Further, it was discovered that all of Ti exist as silicide TiSi₂, and Ti as a simple substance (0 valence) hardly existed.

The HAADF-STEM image and the result of EDS analysis for the nanosized particle of Example 1-4 are shown in FIG. 31. According to FIG. 31(a), nanosized particles with particle diameters of about 50 to 200 nm were observed, and each nanosized particle had a configuration, wherein other approximately hemispherical particles were bound to a large approximately spherical particle via an interface. From FIG. 31(b), it was apparent that silicon atoms exist throughout the entire nanosized particle, and from FIG. 31(c), it was apparent that many titanium atoms were detected in the part that was brightly observed in FIG. 31(a). These findings indicate that the nanosized particle comprises a structure in which a second phase consisting of a compound of silicon and titanium is bound to a first phase consisting of silicon. Further, FIG. 31(d) shows that oxygen atoms presumably due to oxidization were slightly distributed throughout the entire nanosized particle.

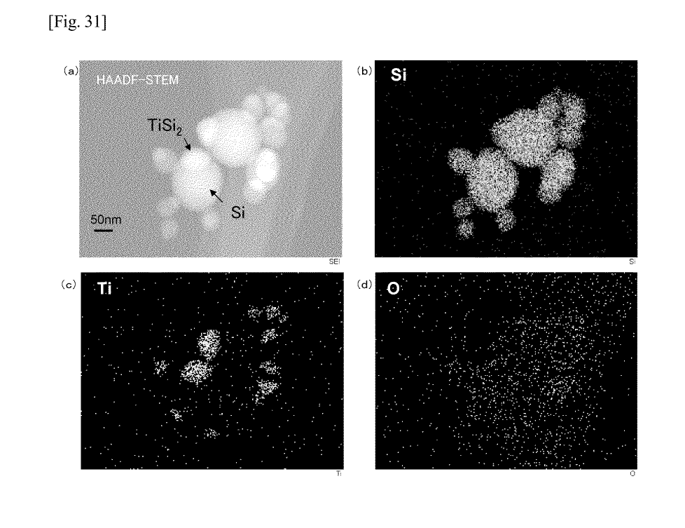

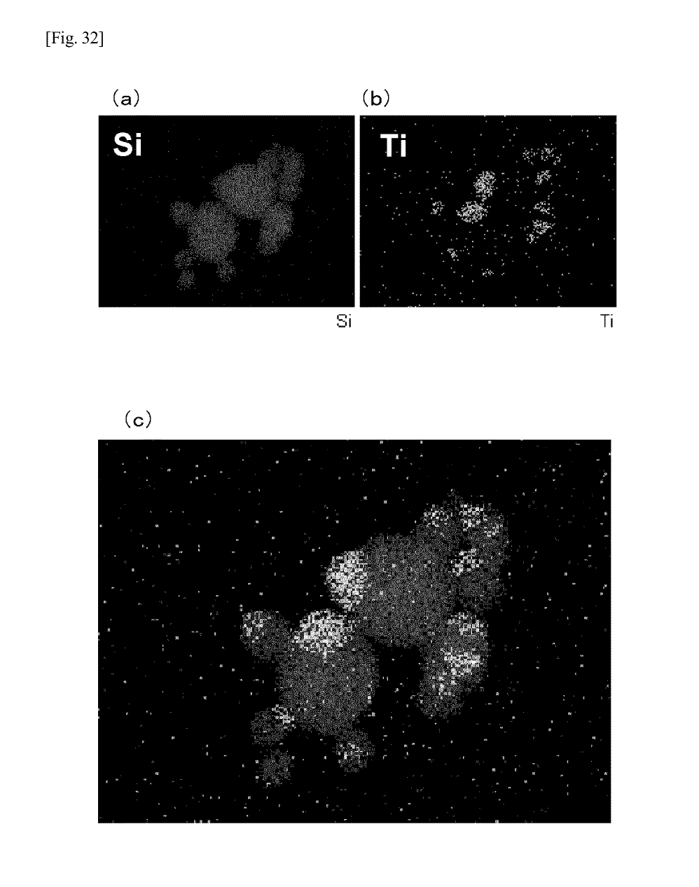

FIG. 32 further shows the EDS analysis result. FIG. 32(a) is the EDS map for silicon atom, FIG. 32(b) is the EDS map for titanium atom, and FIG. 32(c) is a superposition of FIG. 32(a) and FIG. 32(b). According to FIG. 32(c), it is apparent that a region consisting of titanium atom and silicon atom is bound to a region consisting of silicon atom.

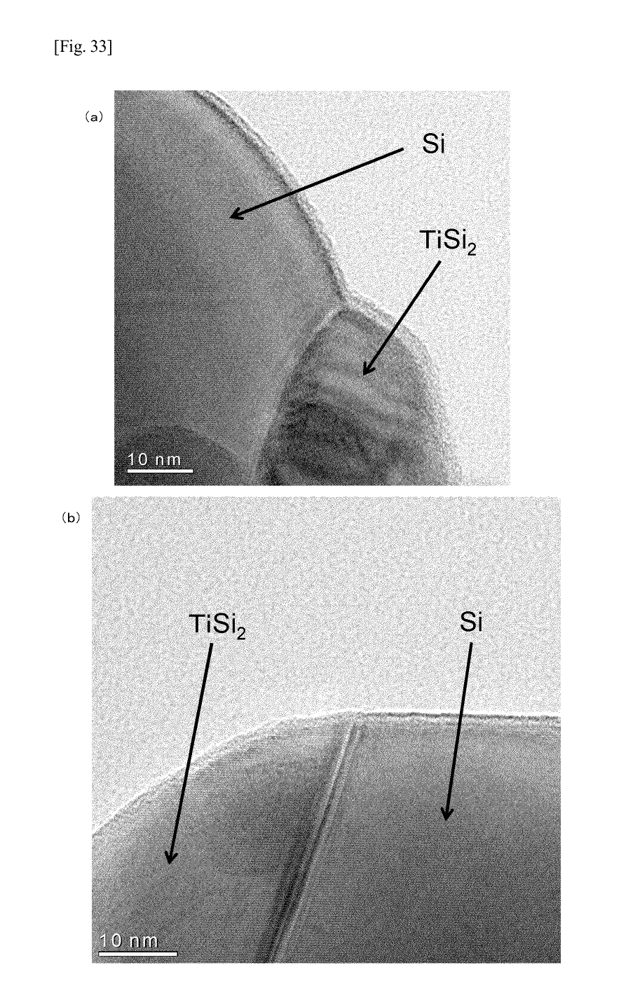

Furthermore, a high resolution TEM image is shown in FIG. 33. It was confirmed that an amorphous layer with a thickness of 2 to 4 nm existed on the exposed outer surface. Further, a lattice image was observed in parts of the silicon and titanium silicide, indicating that a flat part existed on part of the outer periphery along the crystal surface.

### Example 1-5

Other than using a raw material powder prepared by mixing silicon powder and nickel powder so that their molar ratio became Si:Ni=12:1 and drying the mixed powder, nanosized particles were synthesized by the same means as Example 1-1, and observed by XRD and STEM. Further, a lithium ion secondary battery was constructed by the same method as that of Example 1-1, and its cycle characteristic was measured.

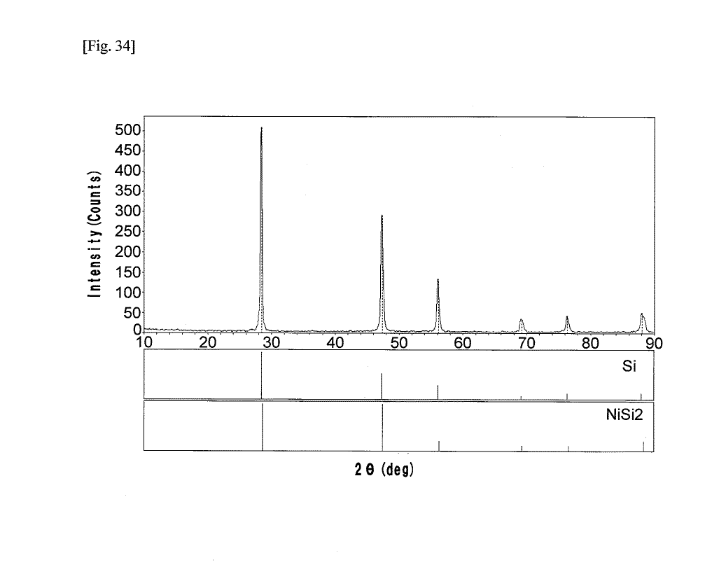

The XRD diffraction pattern of the nanosized particle of Example 1-5 is shown in FIG. 34. It was discovered that Example 1-5 comprises two components, Si and NiSi₂. Further, it was discovered that all of Ni exist as silicide NiSi₂, and Ni as a simple substance (0 valence) hardly existed. Further, it was found that the angle of diffraction 20 for Si and NiSi₂ coincide, indicating that their spacing almost completely coincide.

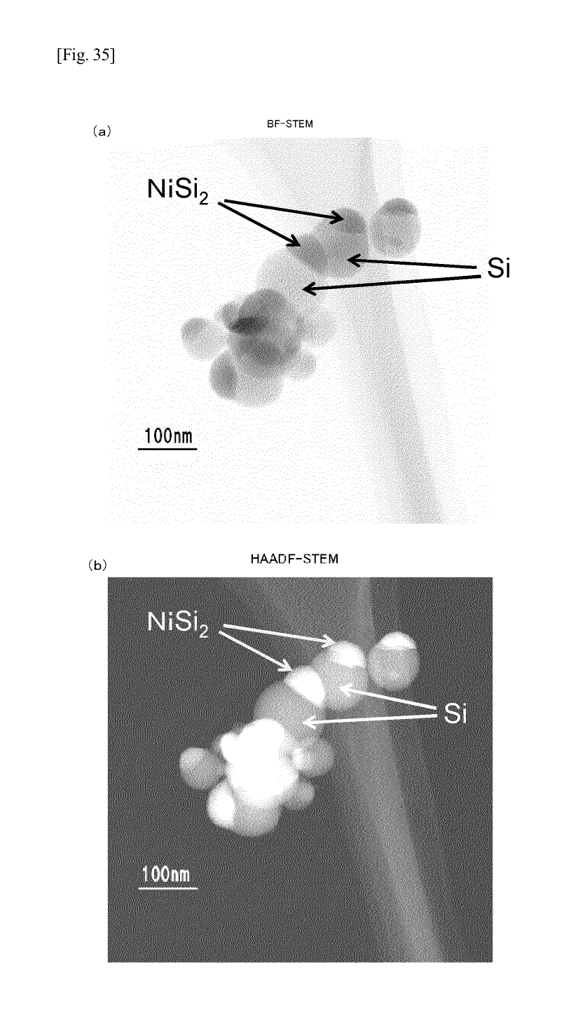

FIG. 35(a) is a BF-STEM image, and FIG. 35(b) is a HAADF-STEM image for the same view point. According to FIG. 35, nanosized particles with particle diameters of about 75 to 150 nm were observed, and each nanosized particle had a configuration, wherein other approximately hemispherical particles were bound to a large approximately spherical particle via an interface.

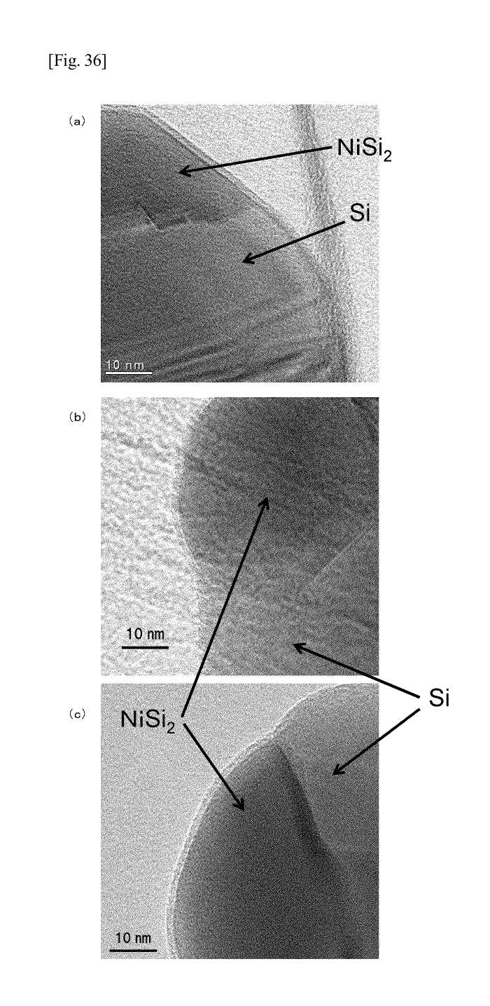

FIG. 36 is a high resolution TEM image of the nanosized particle of Example 1-5. Lattice images were seen in FIG. 36(a) to (c), and since the cross stripes of the silicon phase and the silicide phase mostly coincide, it may be said that the silicide has a polyhedral configuration. Further, the interface between the silicon phase and the silicide phase formed a straight line, a curve, or a step-wise configuration. Further, it was indicated that a silicon amorphous layer with a thickness of about 2 nm covered the surface of the nanosized particle.

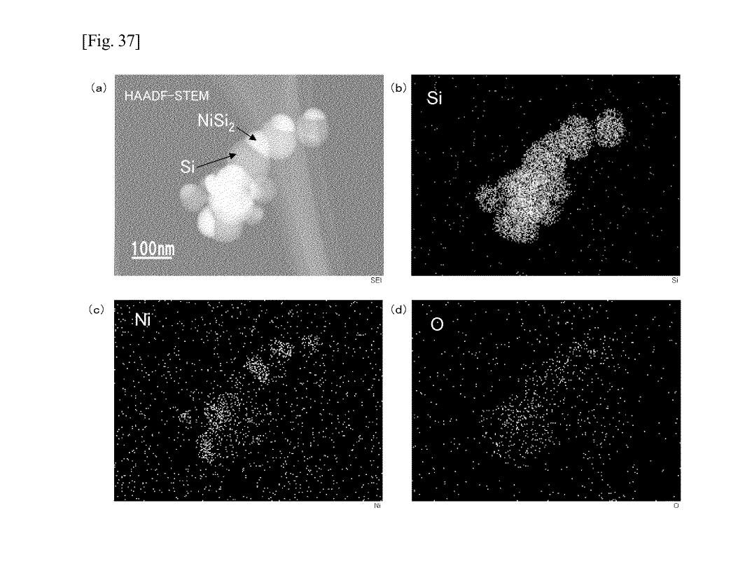

The HAADF-STEM image and the result of EDS analysis for the nanosized particle of Example 1-5 are shown in FIG. 37. According to FIG. 37(a), nanosized particles with particle diameters of about 75 to 150 nm were observed. From FIG. 37(b), it was apparent that silicon atoms exist throughout the entire nanosized particle, and from FIG. 37(c), it was apparent that many nickel atoms were detected in the part that was brightly observed in FIG. 37(a). These findings indicate that the nanosized particle comprises a structure in which a second phase consisting of a compound of silicon and nickel is bound to a first phase consisting of silicon. Further, FIG. 37(d) shows that oxygen atoms presumably due to oxidization were slightly distributed throughout the entire nanosized particle.

### Example 1-6

Other than using a raw material powder prepared by mixing silicon powder and neodymium powder so that their molar ratio became Si:Nd=19:1 and drying the mixed powder, nanosized particles were synthesized by the same means as that of Example 1-1, and observed by XRD and STEM. Further, a lithium ion secondary battery was constructed by the same method as that of Example 1-1, and its cycle characteristic was measured.

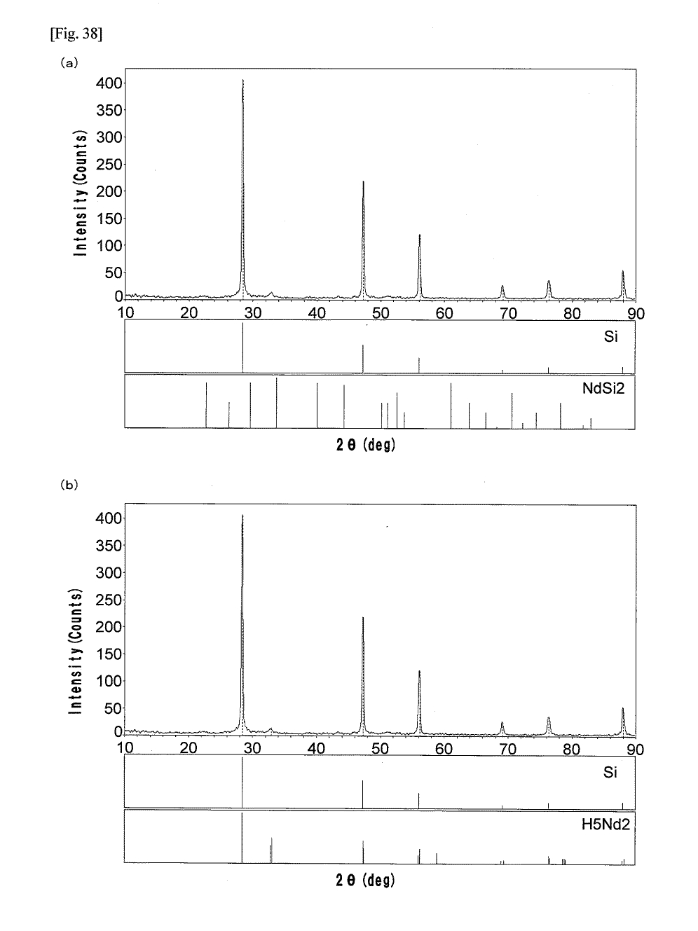

The XRD diffraction pattern of the nanosized particle of Example 1-6 is shown in FIG. 38. In FIG. 38(a), peaks derived from NdSi₂ could not be observed. Since a peak derived from H₅Nd₂ was observed in FIG. 38(b), existence of Nd as a simple metal and Nd silicide could not be confirmed in Example 1-6, and it was apparent that it was comprised of two components, crystalline Si and H₅Nd₂.

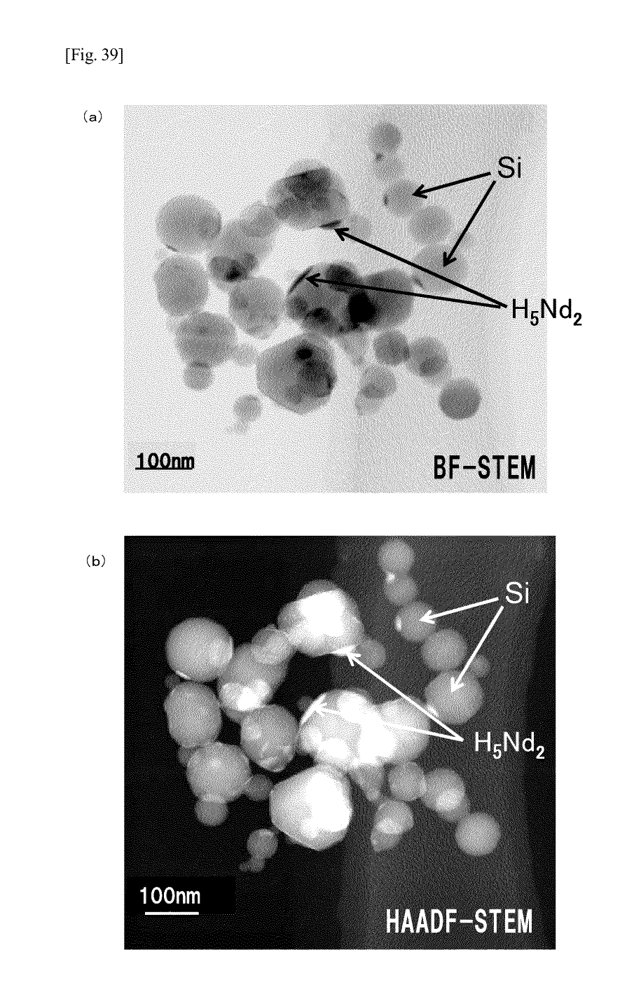

FIG. 39(a) is a BF-STEM image of the nanosized particle of Example 1-6, and FIG. 39(b) is a HAADF-STEM image for the same view point. According to FIG. 39, nanosized particles with article diameters of about 50 to 200 nm were observed, and each nanosized particle had an approximately spherical configuration. Further, part of the nanosized particle comprised a flat surface, which was due to hydrogenated neodymium exfoliating from the nanosized particle. Neodymium is a type of lanthanoid element, and is a metal with a large atomic weight that is easily oxidized. Thus, it can be assumed that volume expansion occurred by forming hydroxy neodymium etc. with water in the air, causing to exfoliate from the nanosized particle.

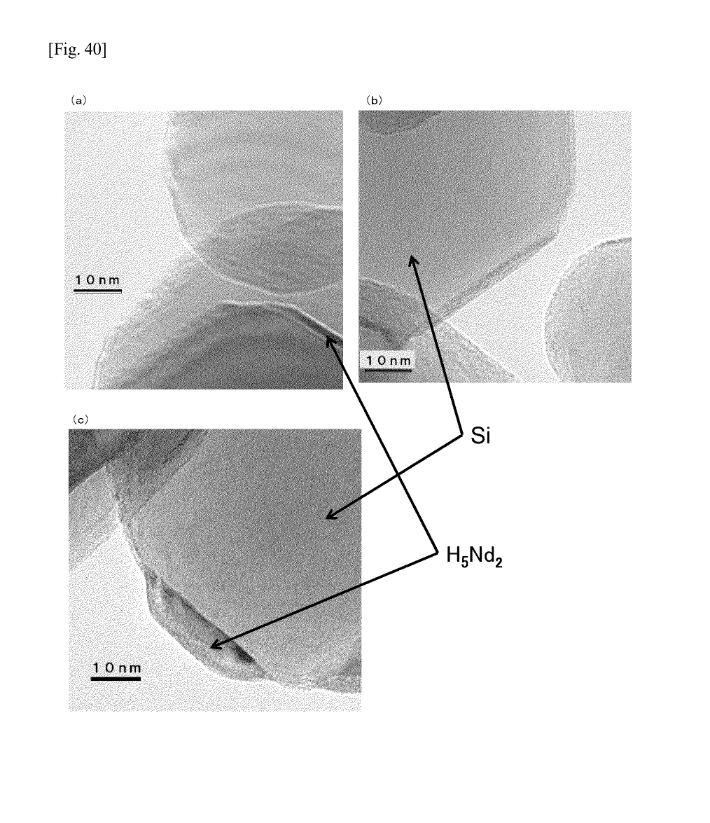

FIG. 40 is a high resolution TEM image. FIG. 40 (a) indicates that the surface of the nanosized particle consists of an approximately spherical surface and a flat surface. FIG. 40 (b) also shows the existence of a flat surface. These flat surfaces are the parts where the hydrogenated neodymium peeled off from the nanosized particle. In FIG. 40(c), it is apparent that a dark-colored region is formed in the approximately flat parts of (a) and (b). This dark-colored region is considered to be the region that contains neodymium atom, which has a larger atomic weight than silicon atom.

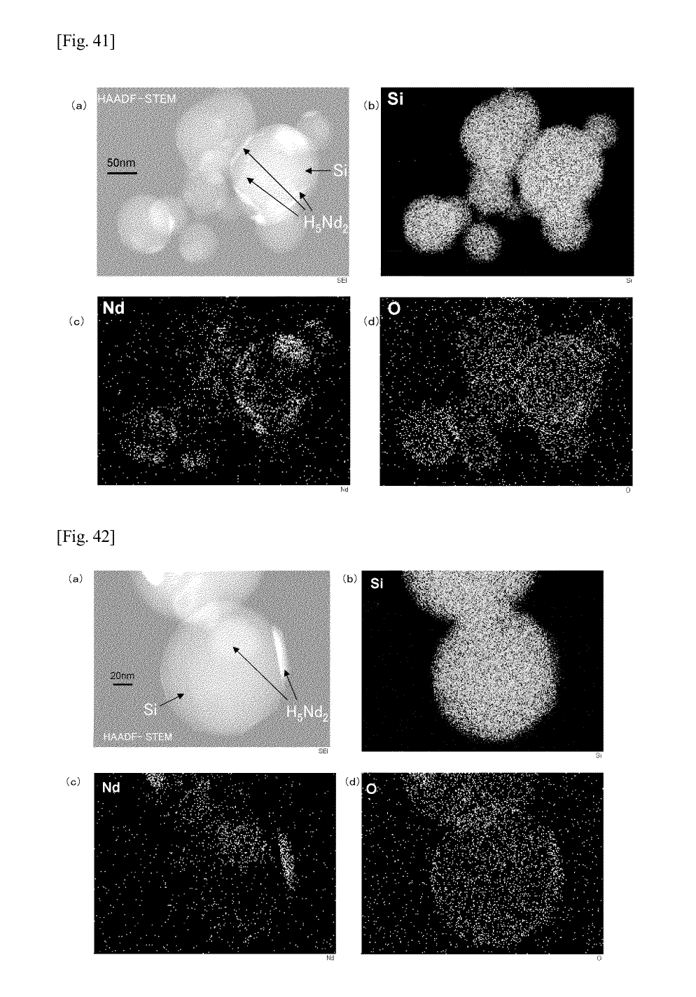

FIG. 41 and FIG. 42 show results of EDS analysis. According to FIG. 41(a), nanosized particles with particle diameters of about 50 to 150 nm were observed, and these nanosized particles had an approximately spherical configuration. From FIG. 41(b), it was apparent that silicon atoms exist in the nanosized particle, and from FIG. 41(c), it was apparent that many neodymium atoms were detected in the part that was brightly observed in FIG. 41(a). Further, from FIG. 41(d), a small amount of oxygen atoms were detected throughout the entire nanosized particle. However, the neodymium hydroxide within the nanosized particle of Example 1-6 reacts with water in the slurry, and is further oxidized while generating hydrogen gas, and exfoliates from the silicon particle. Thus, it cannot perform its roll in suppressing the volume stress due to lithium occlusion and discharge, and in enhancing its conductivity, decreasing in its function as an active material.

According to FIG. 42 (a), nanosized particles with a particle diameter of about 140 nm were observed, and each nanosized particle had an approximately spherical configuration. Further, part of the nanosized particle comprised a flat surface, which was due to hydrogenated neodymium exfoliating from the nanosized particle. FIG. 42(b) indicates that silicon atoms exist in the dark region of FIG. 42(a), and FIG. 42(c) indicates that neodymium atoms exist in the brightly-observed region in FIG. 42(a). Further, FIG. 42(d) indicates that a small amount of oxygen due to oxidation exist throughout the entire nanosized particle.

### Example 1-7

The nanosized particle prepared in Example 1-1 is used. Other than supplying 65 parts by weight of the precision mixture obtained by subjecting nanosized particle and carbon nanohorn (average particle diameter of 80 nm, by NEC Corporation) to precision mixing at a ratio of nanosized particle: CNH=7:3 (weight ratio) by a miller (MIRALO, by Nara Machinery Co. Ltd.), and 28 parts by weight of acetylene black, a lithium ion battery was constructed by the same method as that of Example 1-1, and cycle characteristic was measured.

### Example 1-8

Other than using a raw material powder prepared by mixing silicon powder, iron powder, and silica (phosphorus) powder so that their molar ratio was Si:Fe:P=139:3:1 and drying the mixed powder, nanosized particles were synthesized by the same means as Example 1-1, a lithium ion secondary battery was constructed, and its cycle characteristic was measured.

### Example 1-9, 10

In Example 1-9, silicon powder, iron powder, and silica (SiO₂) powder were mixed so that the molar ratio became Si:Fe:O=38:1:6, and nanosized particles were synthesized by the same method as that of Example 1-1. A lithium ion secondary battery was constructed and cycle characteristics were measured by the means of Example 1-1. For Example 1-10, silicon powder, iron powder, silica (SiO₂) powder, and phosphorus powder were mixed so that the molar ratio became Si:Fe:O:P=139:3:24:1, and nanosized particles were synthesized by the same method as that of Example 1-1. A lithium ion secondary battery was constructed and cycle characteristics were measured by the same means as that of Example 1-1.

### Comparative Example 1-1

Using silicon nanoparticles (by Hefei Kai'er NanoTech) with an average particle diameter of 60 nm, in place of the nanosized particle, a lithium ion secondary battery was constructed by the same method as that of Example 1-1 and its cycle characteristics were measured.

### Comparative Example 1-2

Using silicon nanoparticles (SIE23PB, by Kojundo Chemical Laboratory Co., Ltd.) with an average particle diameter of 5 μm, in place of the nanosized particle, a lithium ion secondary battery was constructed by the same method as that of Example 1-1 and its cycle characteristics were measured.

### (Evaluation of Nanosized Particles)

For the Si-type nanosized particles prepared in Examples 1-1 to 1-6, and Comparative Examples 1-1 to 1-2, the powder conductivity measured by the method of Example 1-1, under the condition of powder compression at 63.7 MPa, are shown in Table 1.

The powder conductivities of Examples 1-1 to 1-6 were 4×10⁻⁸ [S/cm] or more, while those for Comparative Example 1-1 to 1-2 were 4×10⁻⁸ [S/cm] or less. Note that in Comparative Examples 1-1 to 1-2, the values were below to measurement limit of 1×10⁻⁸ [S/cm]. When the powder conductivity is high, the amount of conductive agent mixed can be decreased, thereby increasing the per-volume capacity of the electrode, and becoming advantageous in high rate characteristics.

### [Table 1]

TABLE 1

| | | | | | | | Comparative | Comparative |
|---|---|---|---|---|---|---|---|---|
| | Example | Example | Example | Example | Example | Example | Example | Example |
| | 1-1 | 1-2 | 1-3 | 1-4 | 1-5 | 1-6 | 1-1 | 1-2 |
| Anode | Si:Fe = 23:2 | Si:Fe = 38:1 | Si:Fe = 6:1 | Si:Ti = 11:1 | Si:Ni = 12:1 | Si:Nd = 19:1 | Si (60 nm) | Si (5 μm) |
| Active Material | | | | | | | | |
| Powder | 3.33 × 10⁻⁷ | 1.46 × 10⁻⁶ | 1.18 × 10⁻⁷ | 1.26 × 10⁻⁷ | 5.06 × 10⁻⁷ | 7.03 × 10⁻⁸ | <1.00 × 10⁻⁸ | <1.00 × 10⁻⁸ |
| Conductivity | | | | | | | | |
| [S/cm] | | | | | | | | |

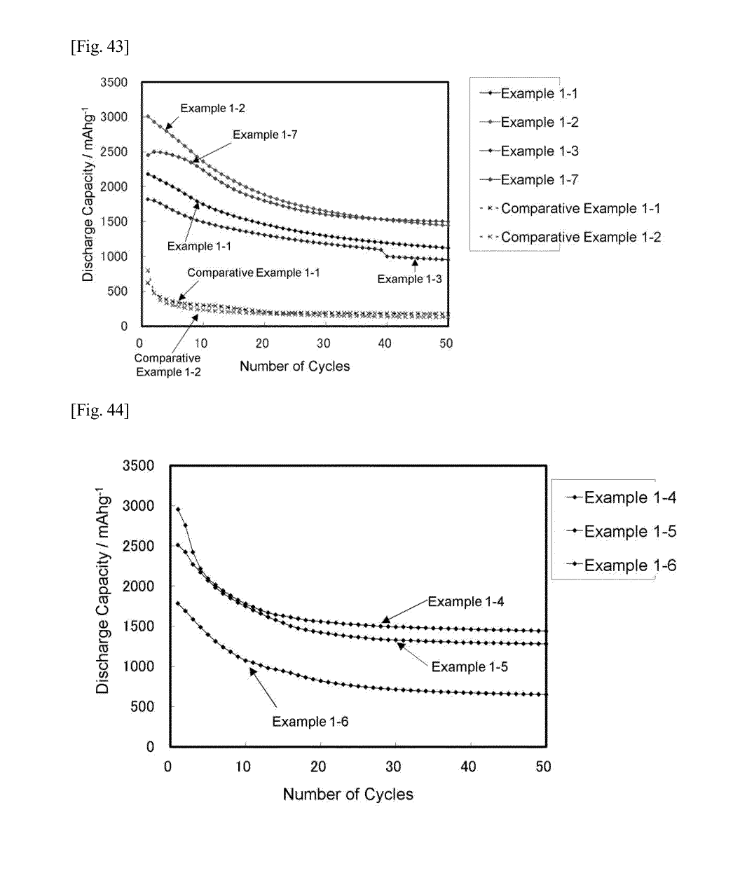

Further, graphs of the number of cycles and the discharge capacity for each of the batteries of Examples 1-1 to 1-7 and Comparative Examples 1-1 to 1-2 are shown in FIG. 43 and FIG. 44. Furthermore, the discharge capacity and the capacity maintenance factor of Examples 1-1 to 1-7 and Comparative Examples 1-1 to 1-2 are shown in Table 2. The numerical values in Table 2 are average values of the three batteries.

### [Table 2]

TABLE 2

| | | | | | | | | Comparative | Comparative |
|---|---|---|---|---|---|---|---|---|---|
| | Example | Example | Example | Example | Example | Example | Example | Example | Example |
| | 1-1 | 1-2 | 1-3 | 1-4 | 1-5 | 1-6 | 1-7 | 1-1 | 1-2 |
| Anode Active | Si:Fe = 23:2 | Si:Fe = 38:1 | Si:Fe = 6:1 | Si:Ti = 11:1 | Si:Ni = 12:1 | Si:Nd = 19:1 | Si:Fe = 23:2 | Si (60 nm) | Si (5 μm) |
| Material | | | | | | | (with CNH) | | |
| Initial | 2200 | 3000 | 1800 | 2950 | 2500 | 1800 | 2450 | 620 | 800 |
| Discharge | | | | | | | | | |
| Capacity (mAhg⁻¹) | | | | | | | | | |
| Discharge | 1120 | 1440 | 950 | 1440 | 1280 | 670 | 1500 | 170 | 130 |
| Capacity | | | | | | | | | |
| after 50 cycles | | | | | | | | | |
| (mAhg⁻¹) | | | | | | | | | |
| Capacity | 51 | 48 | 53 | 49 | 51 | 37 | 61 | 27 | 16 |
| Maintenance | | | | | | | | | |
| Factor after | | | | | | | | | |
| 50 cycles (%) | | | | | | | | | |

As shown in Table 2, the initial electric discharge capacities of Examples 1-1 to 1-6 are higher than those of Comparative Examples 1-1 and 1-2. This is because in Comparative Examples 1-1 and 1-2, which consisted only of silicon, most of the silicon could not be used because their conductivities were low. On the other hand, in Examples 1-1 to 1-5, because metal silicides were bound to the nanosized particles, the conductivities were high, the silicon utilization rate was high, and the discharge capacity was large.

As shown in Table 2, the capacity maintenance factor after 50 cycles was 51% for Example 1-1, but decreases to 27% in Comparative Example 1-1. It is apparent that the nanosized particle of Example 1-1 suppresses the decrease of capacity and shows superior cycle characteristics, compared to silicon nanoparticles.

Further, by comparing Example 1-1 and Example 1-7, it can be seen that by adding carbon nanohorn, the initial capacity becomes high and the capacity maintenance factor after 50 cycles also improves.

Further, Example 1-6, which contains neodymium, has an initial discharge capacity similar to that of Example 1-3 containing iron; however, its degree of deterioration of the discharge capacity after charge-and-discharge is larger. This appears to be because part of the hydrogenated neodymium in the nanosized particle exfoliates from the silicon particle during production of the electrode and charge-and-discharge, as observed in FIG. 39 to FIG. 42. Such characteristic of the anode active material containing neodymium is due to fact that it tends to react with water to form a stable hydroxide. Thus, by avoiding moisture absorption during storage and watching out for moisture absorption by using nonaqueous slurry such as N-methyl-2-pyrolidone during electrode production, it is possible to control the exfoliation from silicon particles. Such characteristic of the active material containing neodymium is common among lanthanoid elements such as lanthanum and praseodymium.

Moreover, by comparing Table 1 and Table 2, it appears that the initial discharge capacity and the cycle characteristics are superior under conditions wherein the powder conductivity is 4.0×10⁻⁸ [S/cm] or more.

Furthermore, the discharge capacity and the capacity maintenance factor of the batteries of Example 1-2 and Examples 1-8 to 1-10 are shown in Table 3. The numerical values in Table 3 are the average of three batteries.

TABLE 3

| | Example | Example | Example | Example |
|---|---|---|---|---|
| | 1-2 | 1-8 | 1-9 | 1-10 |
| Anode | Si:Fe = 38:1 | Si:Fe:P = 139:3:1 | Si:Fe:O = | Si:Fe:O:P = |
| Active | | | 38:1:6 | 139:3:24:1 |
| Material | | | | |
| Initial | 3000 | 3000 | 2200 | 2200 |
| Discharge | | | | |
| Capacity | | | | |
| (mAhg⁻¹) | | | | |
| Capacity | 48 | 51 | 53 | 54 |
| Maintenance | | | | |
| Factor after | | | | |
| 50 cycles | | | | |
| (%) | | | | |

From Table 3, it is apparent that although the initial discharge capacity of Example 1-8 is nearly at the same level as that of Example 1-2, the capacity maintenance factor is improved. By adding phosphorus, the powder conductivity of Example 1-8 increased by about 50%, compared to Example 1-2. Further, it is apparent that although the discharge capacity of Example 1-9 is nearly the same level as that of Example 1-1 the capacity maintenance factor is improved. It is thought that, although the amount of silicon site capable of occluding lithium that exist in Example 1-9 is about the same as that of Example 1-1, distortion accompanying volume change of silicon is alleviated by the existence of oxygen, and the capacity maintenance factor improved. Furthermore, in Example 1-10, the powder conductivity improved by the addition of phosphorus, and the capacity maintenance factor improved further.

### (Discussion on the Nanosized Particle Formation Process)

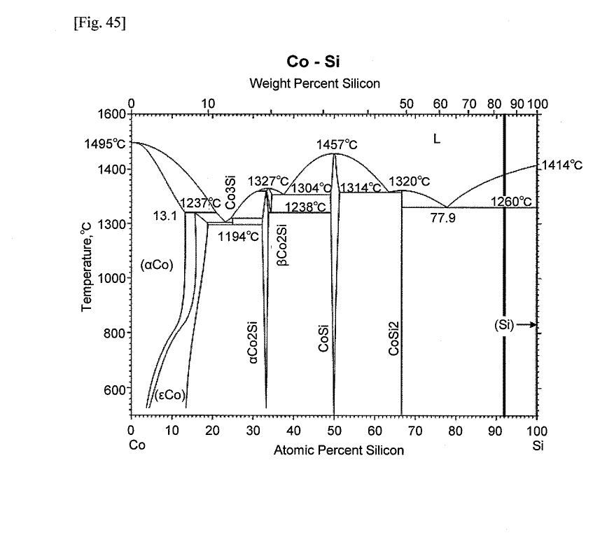

Note that although a nanosized particle was prepared by a binary system of silicon and iron in Example 1-1, nanosized particle of the present invention is not limited to the binary system of silicon and iron. For example, even in the binary system phase diagram of Co (cobalt) and Si (silicon) shown in FIG. 45, when a plasma of mole Si/(Co+Si)=0.92 is cooled, CoSi₂ and Si are deposited. Thus, a nanosized particle in which CoSi₂ and Si are bound via an interface will be obtained. The bold line in FIG. 45 is the line that indicates mole Si/(Co+Si)=0.92.

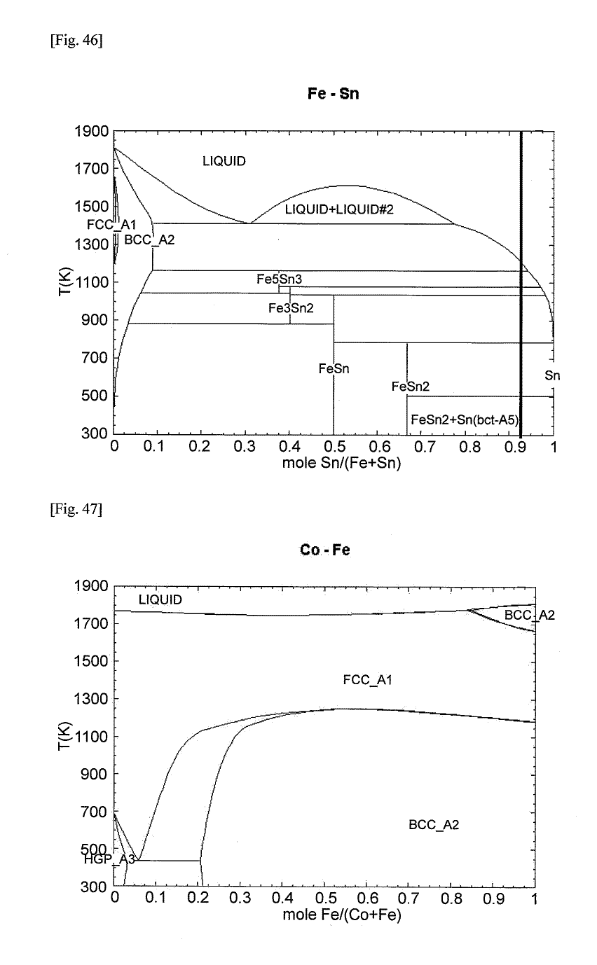

Similarly, in the binary system phase diagram of Fe (iron) and Sn (tin) shown in FIG. 46, since FeSn₂ and Sn are deposited when a plasma of mole Sn/(Fe⁺ Sn)=0.92 is cooled, it can be assumed that a nanosized particle in which FeSn₂ and Sn are bound via an interface is obtained. The bold line in FIG. 46 is a line which shows mole Sn/(Fe⁺ Sn)=0.92. In the binary system of Fe and Sn, Sn acts as the active material, which occludes and discharges lithium.

Although Si, Sn, Al, Pb, Sb, Bi, Ge, In and Zn are exemplified as element A that can occlude and discharge lithium, Si is especially superior from the view point of capacity. Si forms a similar binary system phase diagram with any one of Fe, Co, Ni, Ca, Sc, Ti, V, Cr, Mn, Sr, Y, Zr, Nb, Mo, Tc, Ru, Rh, Ba, lanthanoid element (other than for Ce and Pm), Hf, Ta, W, Re, Os and Ir as element D, and forms the compound DAₓ (1<x≦3). Therefore, it is assumed that nanosized particles comprising a second phase and a first phase bound via an interface are obtained for the above combinations of element A and element D.

The formation process of the nanosized particle comprising a fourth phase is discussed. FIG. 47 is a binary system phase diagram of cobalt and iron. When a mixed powder of cobalt powder and iron powder is cooled from plasma, only a simple substance of cobalt and a solid solution of iron cobalt, a simple substance of iron and a solid solution of iron cobalt, or a solid solution of iron cobalt will be deposited. Therefore, cooling a plasma containing silicon, iron, and cobalt will form a nanosized particle in which FeSi₂, CoSi₂, and Si are bound via an interface. In this case, depending on the content of silicon, iron, and cobalt, an iron cobalt solid solution may be deposited within the nanosized particle.

### Example 2-1

### (Preparation of Nanosized Particle)

Using the apparatus of FIG. 4, a raw material powder prepared by mixing silicon powder and copper powder so that their molar ratio became Si:Cu=3:1, and drying the mixed powder, was supplied continuously with a carrier gas into the plasma of Ar gas generated in the reaction chamber, to produce nanosized particles of silicon and copper.

More specifically, the nanosized particle was produced by the following method. After evacuating the reaction chamber with a vacuum pump, Ar gas was introduced to atmospheric pressure. This process of evacuation and Ar gas introduction was repeated three times to rid the reaction vessel of remaining air. Then, Ar gas was introduced into the reaction vessel as a plasma gas at a flow rate of 13 L/min, and AC voltage was applied to the high-frequency coil, to generate high-frequency plasma by a high-frequency electromagnetic field (frequency of 4 MHz). Here, the plate electricity was set to 20 kW. Ar gas at a flow rate of 1.0 L/min was used as the carrier gas to supply the raw material powder. Gradual oxidation treatment was performed for more than 12 hours following reaction, and the fine powder obtained was recovered at the filter.

Then, the nanosized particle was oxidized by heating at 250° C. for 1 hour in the atmosphere.

### (Evaluation of the Composition of the Nanosized Particle)

The nanosized particle was identified by a powder X-ray diffraction device (RINT-UltimaIII, by Rigaku Corporation) using a CuKα ray. FIG. 48 shows the X-ray diffraction (XRD) pattern of the nanosized particle of Example 2-1 prior to oxidation treatment. It was found that the nanosized particle of Example 2-1 comprises crystalline Si. Further, it was found that Cu as a simple substance (0 valence) did not exist.

Observation of the particle configuration of the nanosized particle was performed using a transmission electron microscope (H-9000UHR, by Hitachi High-Technologies Corporation). The TEM images of the nanosized particle prior to oxidation treatment are shown in FIG. 49(a) to (c). From FIG. 49 (a) to (c), nanosized particles with particle diameters of about 50 to 120 nm were observed, each with two spherical particles bound. The dark-colored part appears to be a compound of Cu and Si, and the light-colored part appears to be Si.

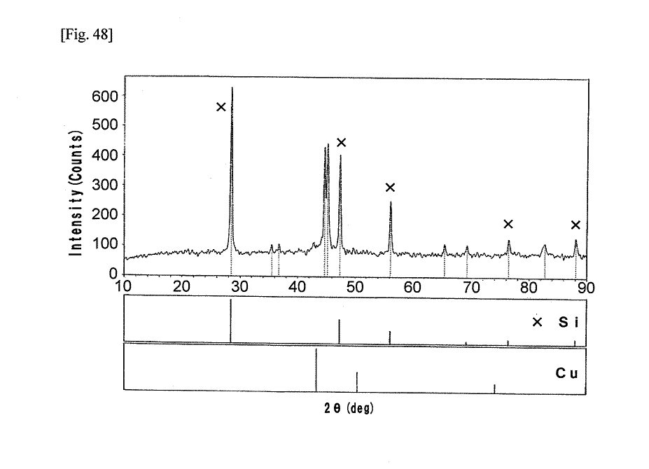

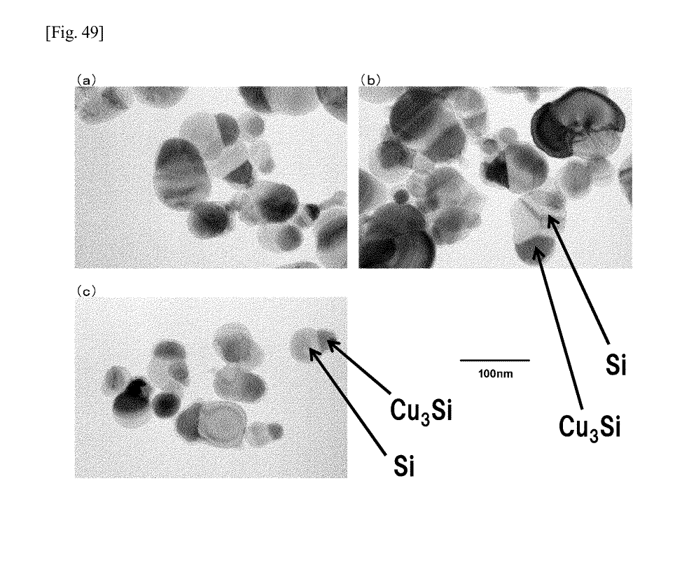

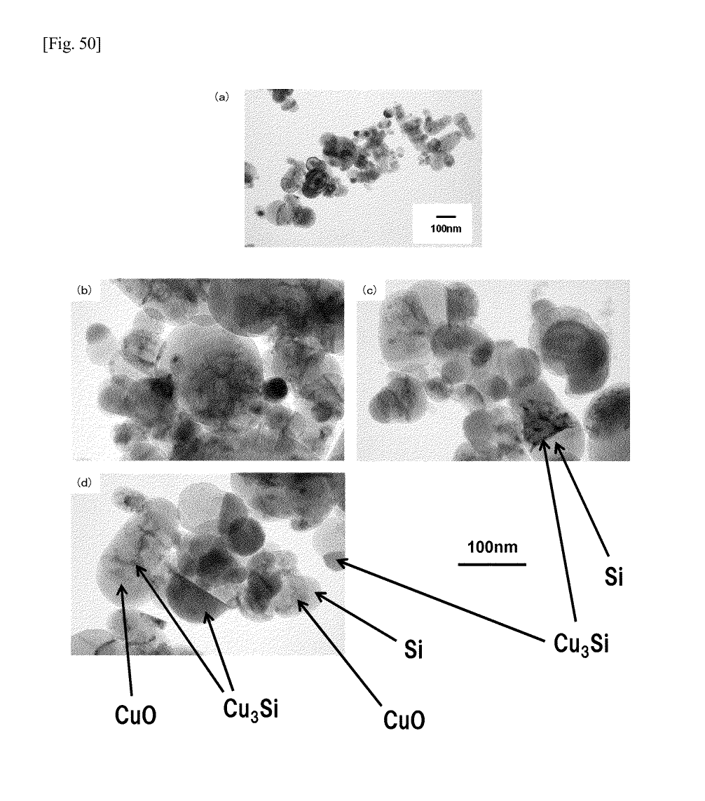

Further, the TEM image of the nanosized particle after oxidation treatment is shown in FIG. 50. Nanosized particles with particle diameters of about 50 to 150 nm were observed, each with two spherical particles bound. It was confirmed that due to the invasion of oxygen, the oxidized particle deformed into an elongated configuration from an approximately spherical configuration. Further, it is presumed that the dark shadows observed in the particles are Cu or oxygen diffused into Si, causing volume expansion. As oxidization advances, Cu₃Si, SiO, and CuO are diffused within Si, and the Si—Si bond decreases, decreasing the number of Si sites that bond with Li, thereby suppressing expansion and contributing to cycle characteristics.

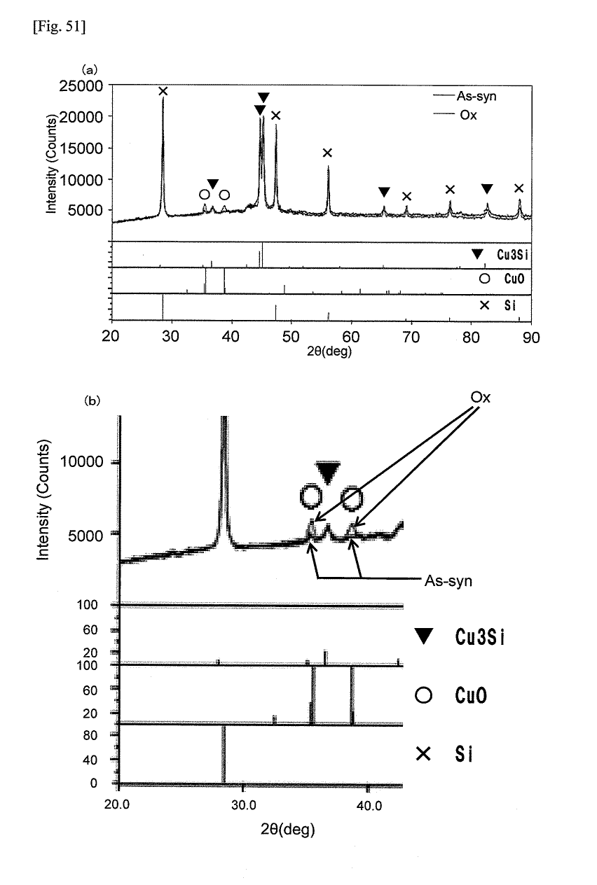

FIGS. 51 (a) and (b) show the X-ray diffraction (XRD) pattern of the nanosized particle of Example 2-1 prior to oxidation treatment (As-syn) and after oxidation treatment (Ox). According to XRD analysis results, it was found that in samples that generated heat by oxidation, the strength of Si and Cu₃Si deteriorated, and CuO increased. Combined with the TEM observation results, it can be presumed that oxygen invaded into the approximately spherical particles by oxidization, producing CuO, which diffused in to Si in the longitudinal direction, changing the configuration to an elongated configuration.

The aforementioned analysis results indicate that in the nanosized particle of Example 2-1, prior to oxidation, an approximately spherical seventh phase 55 of Cu₃Si and an approximately spherical sixth phase 53 of Si are bound via an interface.

### (Evaluation of the Powder Conductivity)

In order to evaluate the conductivity for the powder, the powder conductivity was evaluated using a powder resistance measurement system MCP-PD51 type of Mitsubishi Chemical Corporation. The conductivity was calculated from the resistance value obtained when a sample powder was compressed at an arbitrary pressure. The data shown in the later-shown Table 4 are values obtained when the sample powder was compressed at 63.7 MPa, and measured.

### (Evaluation of the Cycle Characteristic of the Nanosized Particle)

### (i) Preparation of the Anode Slurry

The nanosized particle of Example 2-1 was used. To a mixer was introduced the nanosized particle at a ratio of 45.5 parts by weight, and acetylene black (average particle diameter of 35 nm, powder, by DENKI KAGAKU KOGYO KABUSHIKI KAISHA) at a ratio of 47.5 parts by weight. Furthermore, as a binding agent, an emulsion of 40 wt % of styrene-butadiene rubber (SBR) (BM400B, by Nippon Zeon Co., Ltd.) at a solid content of 5 parts by weight, and as a thickener to control the viscosity of the slurry, a 1 wt % solution of sodium carboxymethyl cellulose (#2200, by Daicel Corporation) at a solid content of 10 parts by weight were mixed to prepare a slurry.

### (ii) Preparation of Anode

Using a doctor blade of an automatic coating apparatus, the prepared slurry was applied on a current collector electrolytic copper foil with a thickness of 10 μm (NC—WS by Furukawa Electric Co. Ltd.), at a thickness of 15 μm, dried at 70° C., followed by a thickness control process by pressing, to produce an anode for lithium ion secondary battery.

(iii) Characteristic Evaluation

Using the anode for lithium ion secondary batteries, an electrolyte solution containing 1 mol/L of LiPF₆ and a mixed solution of ethylene carbonate and diethyl carbonate, and a counter electrode of metal Li foil, a lithium secondary battery was constructed, and its charge-and-discharge characteristic was investigated. For characteristic evaluation, the initial discharge capacity and the discharge capacity after 50 cycles of charge-and-discharge were measured, and the decreasing rate of the discharge capacity was calculated. The discharge capacity was calculated based on the total weight of silicide and the active material Si effective for the occlusion and discharge of lithium. First, at an environment of 25° C., charging was performed up to a current of 0.1 C and a voltage of 0.02 V, under constant current constant voltage conditions, and charging was terminated when the current decreased to 0.05 C. Subsequently, at a condition of a current value of 0.1 C, discharge was performed until the voltage against metal Li became 1.5 V, and the initial discharge capacity at 0.1 C was measured. Note that 1 C refers to the value of current that can be fully charged in 1 hour. Further, both charge and discharge were performed under an environment of 25° C. Subsequently, the above-described charge-and-discharge at a charge-and discharge rate of 0.1 C was repeated for 50 cycles. The rate of the discharge capacity after repeating 50 cycles of charge-and-discharge against the initial discharge capacity at 0.1 C was calculated in percentage, as the discharge capacity maintenance factor after 50 cycles.

### Example 2-2

Other than using a raw material powder prepared by mixing silicon powder, iron powder, and copper powder so that their molar ratio became Si:Fe:Cu=24:1:6 and drying the mixed powder, nanosized particles were synthesized by the same means as those of Example 2-1, and observed by XRD and STEM. Further, a lithium ion secondary battery was constructed by the same method as that of Example 2-1 (not including the oxidation treatment process), and its cycle characteristic was measured.

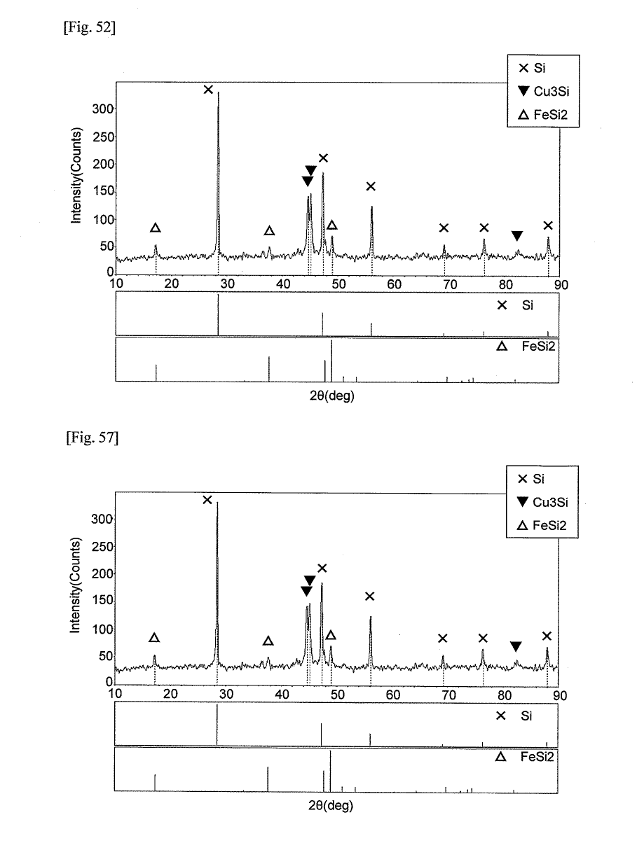

FIG. 52 shows the X-ray diffraction (XRD) pattern of the nanosized particle of Example 2-2. It was found that the nanosized particle of Example 2-2 comprises crystalline Si, Cu₃Si, and FeSi₂.

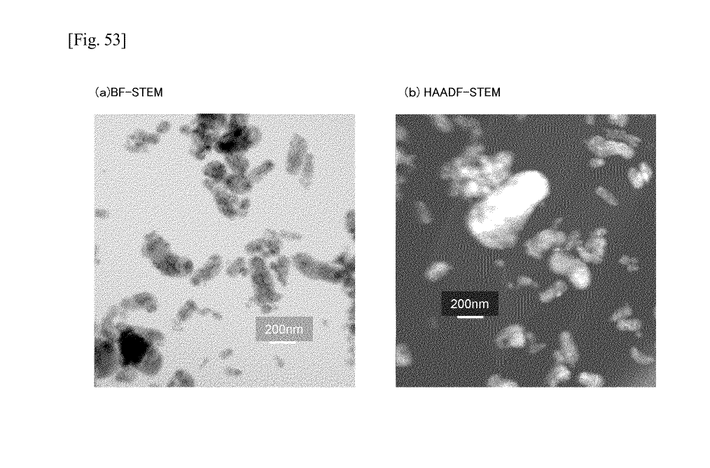

Using a scanning transmission electron microscope (JEM 3100FEF, by JEOL Ltd.), observation of the particle configuration of the nanosized particle was performed. STEM images of the nanosized particle of Example 2-2 are shown in FIG. 53(a) to (b). FIG. 53(a) shows the BF-STEM (Bright-Field Scanning Transmission Electron Microscopy) image. FIG. 53 (b) is a STEM image by HAADF-STEM (High-Angle-Annular-Dark-Field-Scanning-Transmission-Electron-Microscopy). Nanosized particles of about 50 to 600 nm were observed. In FIG. 53(a), the dark-colored part is thought to be the compound of Cu and Si or Fe and Si, and the light-colored part is thought to be Si.

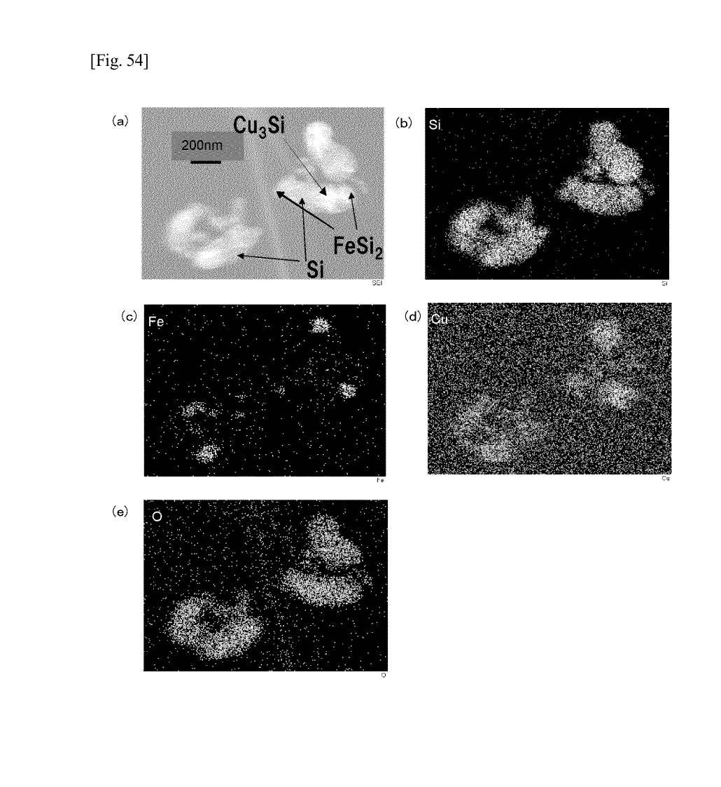

Particle configuration observation and composition analysis of the nanosized particle was performed by HAADF-STEM and EDS (Energy Dispersive Spectroscopy: energy dispersion-type X-ray analysis) analysis, using a scanning transmission electron microscope (JEM 3100FEF, by JEOL Ltd.). FIG. 54 (a) shows that nanosized particles with particle diameters of about 600 nm were observed, FIG. 54(b) shows that silicon atoms exist throughout the entire nanosized particle, and FIG. 54(c) shows that iron atoms are detected in the parts that were brightly observed in FIG. 54(a). FIG. 54(d) shows that many copper atoms are detected in the parts that were brightly observed in FIG. 54(a). Note that in FIG. 54(d), the background originating from the TEM mesh that holds the sample during observation is largely observed. FIG. 54(e) shows that oxygen atoms presumably due to oxidation are dispersed throughout the entire nanosized particle.

FIG. 55 (a) shows that nanosized particles with particle diameters of about 600 nm were observed, FIG. 55(b) shows that silicon atoms exist throughout the entire nanosized particle, and FIG. 55(c) shows that iron atoms are detected in parts of the portion that were brightly observed in FIG. 55(a). FIG. 55(d) shows that many copper atoms are detected in the parts that were brightly observed in FIG. 55(a). Note that in FIG. 55(d), the background originating from the TEM mesh that holds the sample during observation is largely observed. FIG. 55(e) shows that oxygen atoms presumably due to oxidation are dispersed throughout the entire nanosized particle.

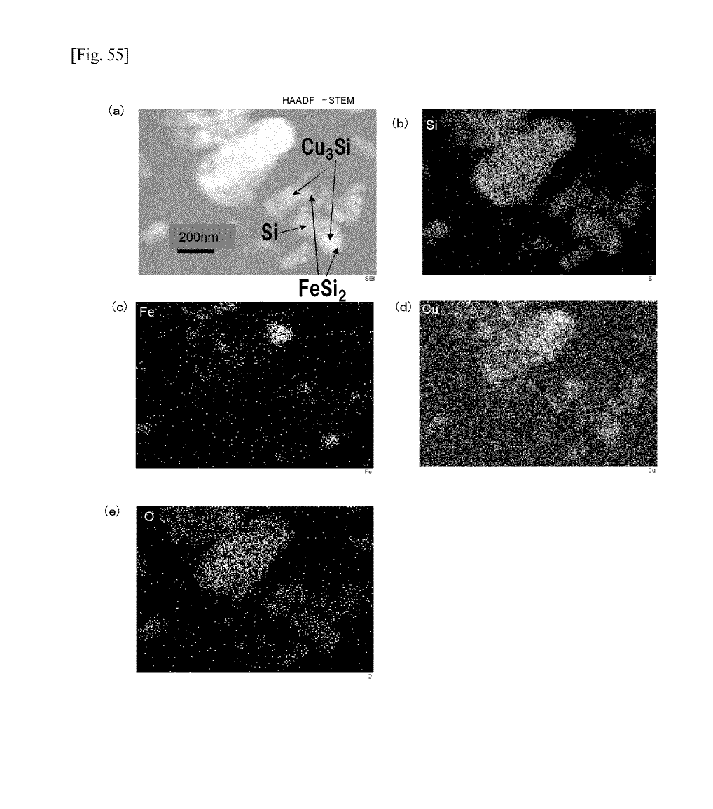

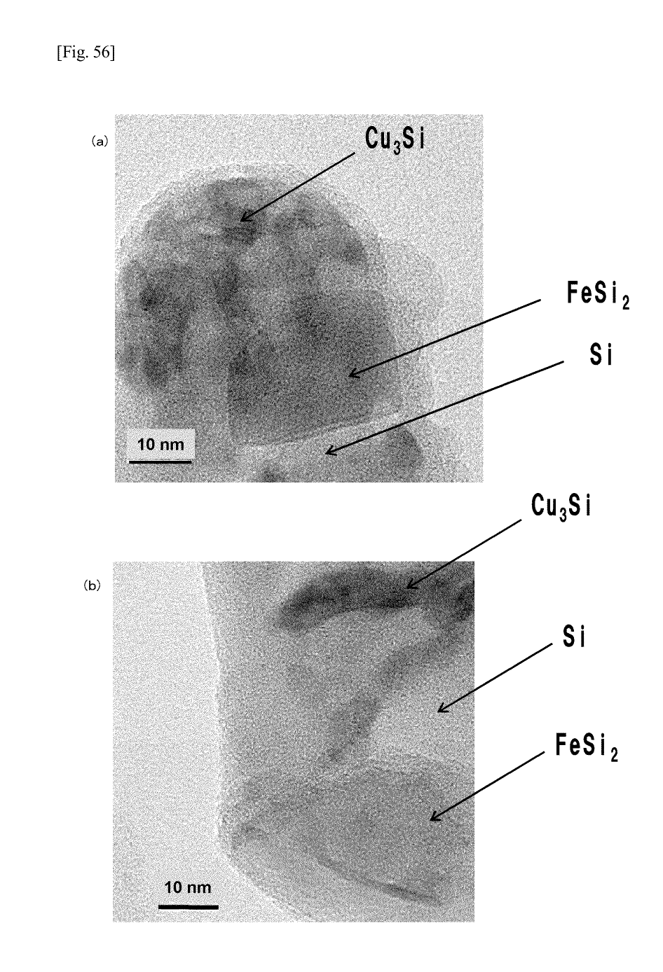

Further, the TEM image of the nanosized particle of Example 2-2 is shown in FIG. 56. A nanosized particle consisting of Si, FeSi₂, and Cu₃Si (or Cu₁₉Si₆) is observed, and an amorphous layer was confirmed around the particles.

From these results, it was determined that the nanosized particle of Example 2-2 comprises a structure wherein a seventh phase formed of Cu₃Si and a ninth phase formed of FeSi₂ are bound to a sixth phase formed of silicon, with a tenth phase that consists of FeSi₂ contained thereto.

### Example 2-3

Other than using a raw material powder prepared by mixing silicon powder, iron powder, and copper powder so that their molar ratio became Si:Fe:Sn=37:1:4 and drying the mixed powder, nanosized particles were synthesized by the same means as that of Example 2-1, and observed by XRD and STEM. Further, a lithium ion secondary battery was constructed by the same method as that of Example 2-1 (not including the oxidation treatment process), and its cycle characteristic was measured.

FIG. 57 shows the X-ray diffraction (XRD) pattern of the nanosized particle of Example 2-3. It was found that the nanosized particle of Example 2-2 comprises crystalline Si, Cu₃Si, and FeSi₂. Note that compared to FIG. 52, the peak intensity of Cu₃Si, and FeSi₂ were decreased.

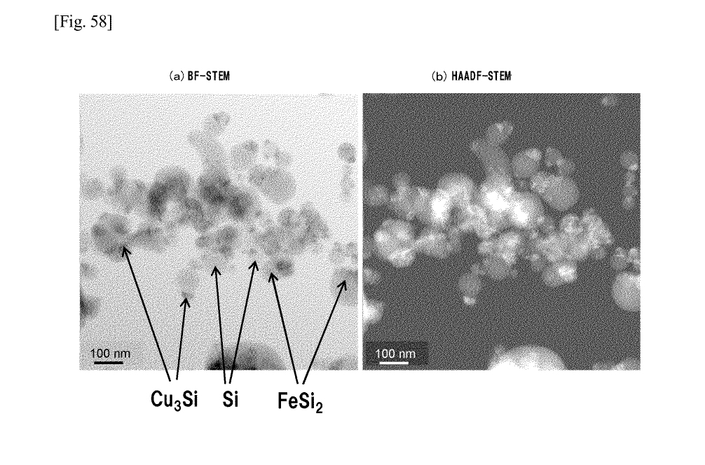

The STEM images of the nanosized particle of Example 2-3 are shown in FIG. 58(a) to (b). Nanosized particles with a particle diameter of about 50 to 120 nm were observed. In FIG. 58 (a), it is presumed that the dark-colored part indicates the compound of Cu and Si, or the compound of Fe and Si, and the light-colored part is Si.

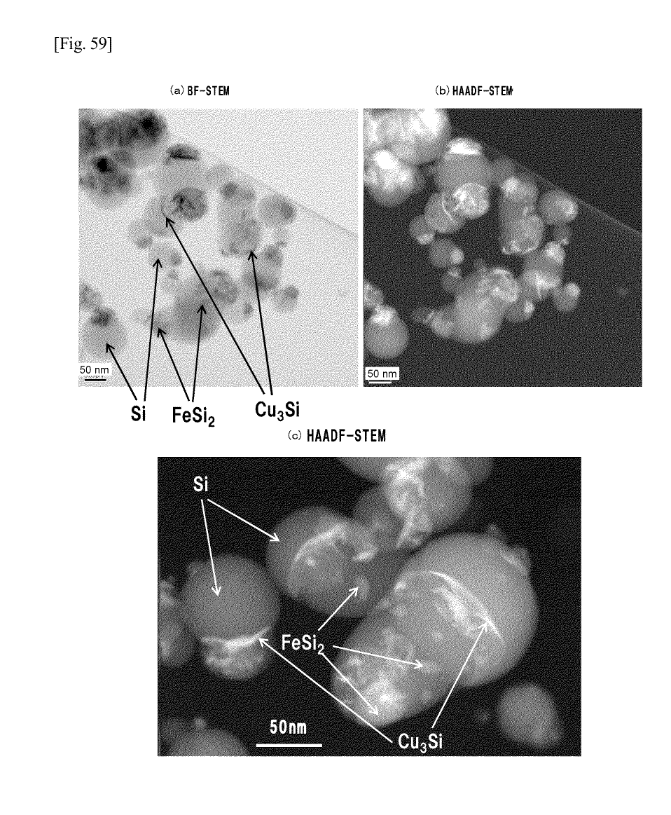

Further, the STEM images of the nanosized particle of Example 2-3 are shown in FIG. 59(a) to (c). Nanosized particles with particle diameters of about 50 to 150 nm were observed. In FIG. 59 (a) to (c), a streaky phase (Cu₃Si) and an ellipsoidal phase (FeSi₂) were observed in the particle.

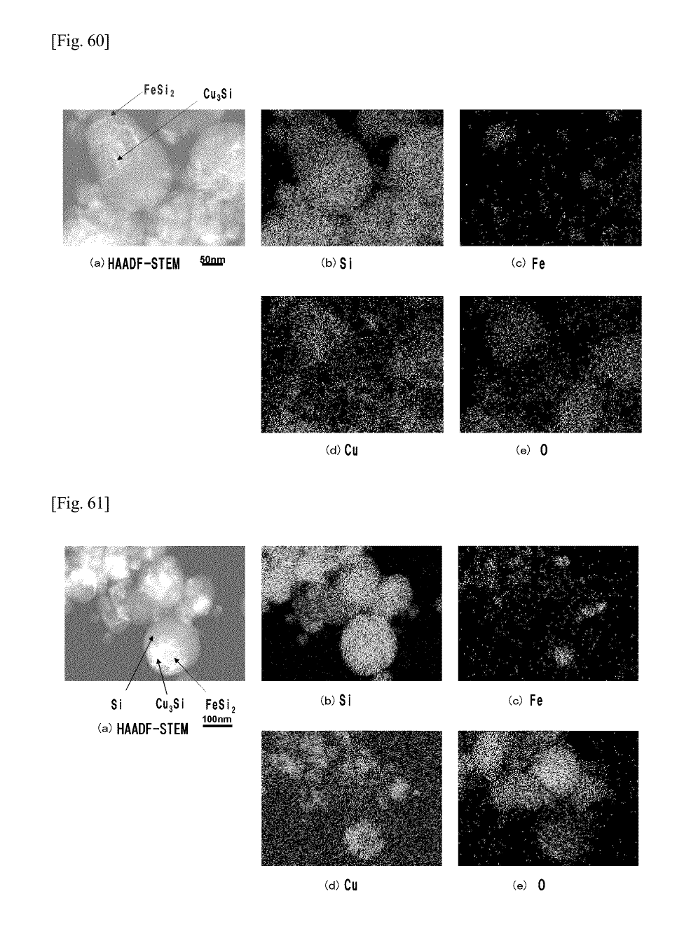

FIG. 60 (a) shows that nanosized particles with particle diameters of about 200 nm were observed, FIG. 60(b) shows that silicon atoms exist throughout the entire nanosized particle, and FIG. 60(c) shows that many iron atoms are detected in the parts that were observed to be slightly brighter in FIG. 60(a). FIG. 60(d) shows that copper atoms are detected in the parts that were brightly observed in FIG. 60(a). Note that in FIG. 60(d), background originating from the TEM mesh that holds the sample during observation is largely observed. FIG. 60(e) shows that oxygen atoms presumably due to oxidation are dispersed throughout the entire nanosized particle.

FIG. 61(a) shows that nanosized particles with particle diameters of about 150 nm were observed, FIG. 61(b) shows that silicon atoms exist throughout the entire nanosized particle, and FIG. 61(c) shows that many iron atoms are detected in parts of the portion that were brightly observed in FIG. 61(a). FIG. 61(d) shows that copper atoms are detected in the parts that were brightly observed in FIG. 61(a). Note that in FIG. 61(d), background originating from the TEM mesh that holds the sample during observation is largely observed. FIG. 61(e) shows that oxygen atoms presumably due to oxidation are dispersed throughout the entire nanosized particle.

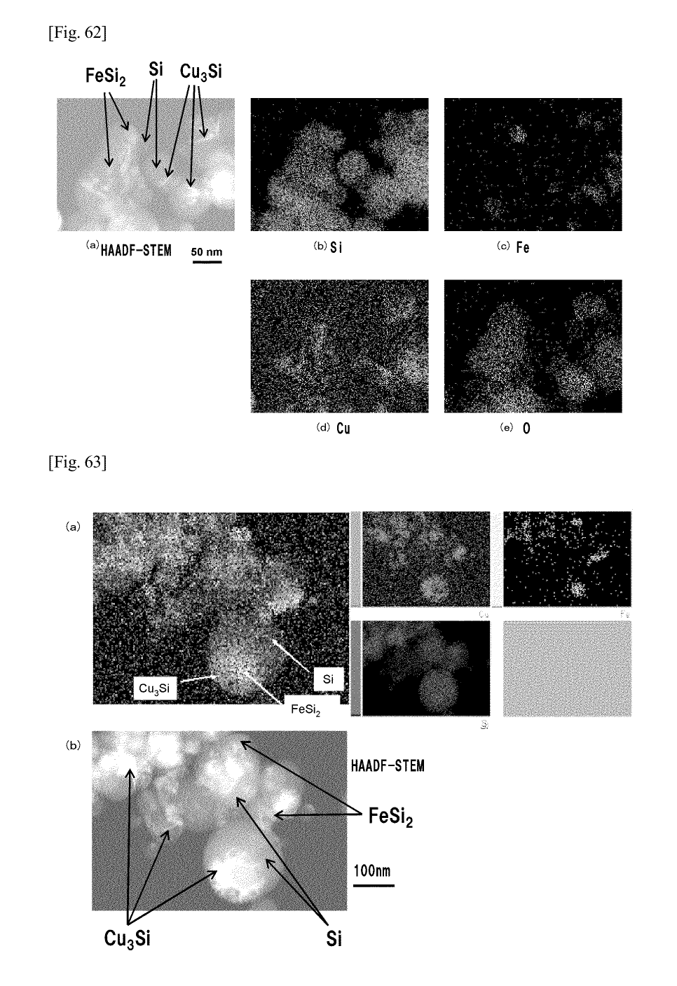

FIG. 62 (a) shows that nanosized particles with particle diameters of about 200 nm were observed, FIG. 62(b) shows that silicon atoms exist throughout the entire nanosized particle, and FIG. 62(c) shows that many iron atoms are detected in the parts that were observed to be slightly brighter in FIG. 62(a). FIG. 62(d) shows that many copper atoms are detected in the parts that were brightly observed in FIG. 62(a). Note that in FIG. 62(d), background originating from the TEM mesh that holds the sample during observation is largely observed. FIG. 62(e) shows that oxygen atoms presumably due to oxidation are dispersed throughout the entire nanosized particle. FIG. 62 indicates that the streaky phase in the nanosized particle is Cu₃Si and the slightly brighter phase other than those is FeSi₂.

FIG. 63 further shows the EDS analysis result. FIG. 63(a) is the EDS map for Cu, Fe and Si and the superposition of these. FIG. 63(b) is the HAADF-STEM image from the same view point. FIG. 63(a) indicates that a region consisting of Cu₃Si and FeSi₂ are bound to a region consisting of silicon atom.

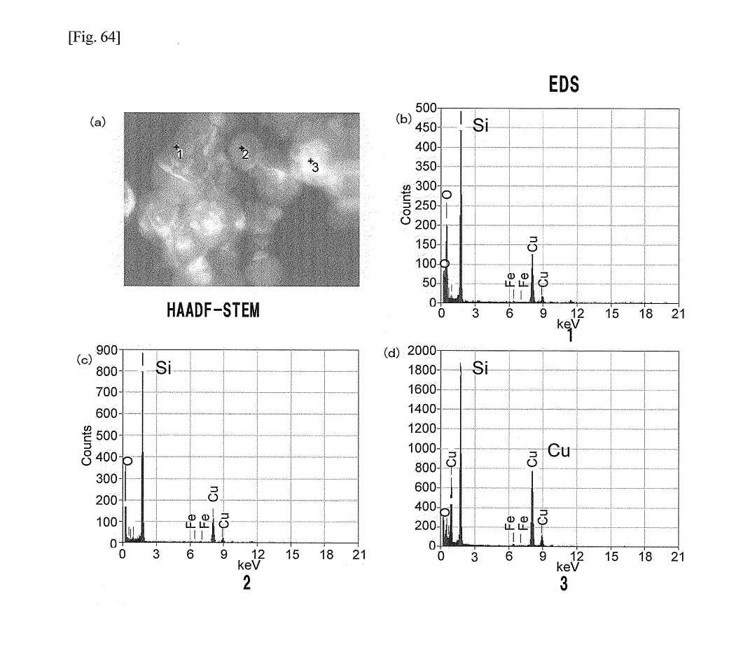

FIG. 64 shows the EDS analysis result for points 1 to 3 within the nanosized particle. In point 1, Si, Cu, O and a small amount of Fe were observed. In the point 2, Si, Cu and a small amount of Fe were observed but 0 was not observed. In the point 3, Si, Cu, O and a small amount of Fe were observed. It is apparent that the particles in the second point are not oxidized. Note that the Cu background originating from the TEM mesh that holds the sample during observation is widely observed.

From these results, it was determined that the nanosized particle of Example 2-3 comprises a structure wherein a seventh phase formed of Cu₃Si and a ninth phase formed of FeSi₂ are bound to a sixth phase formed of silicon, with a tenth phase that consists of FeSi₂ contained thereto.

### Example 2-4

The nanosized particle of Example 2-1 was used. A precision mixture obtained by subjecting the nanosized particle and carbon nanohorn (average particle diameter of 80 nm, by NEC Corporation) to precision mixing at a ratio of nanosized particle: CNH=7:3 (weight ratio) by a miller (MIRALO, by Nara Machinery Co. Ltd.) was supplied to a mixer at a content of 65 parts by weight, along with 28 parts by weight of acetylene black. Further, a slurry was prepared by the method of Example 2-1, using the same binding agent and thickening agent as that of Example 2-1, at the same ratio as that of Example 2-1. A lithium ion battery was constructed by the same method as that of Example 2-1, and its cycle characteristic was measured.

### Comparative Example 2-1

Using silicon nanoparticles (by Hefei Kai'er NanoTech) with an average particle diameter of 60 nm in place of the nanosized particle, a lithium ion secondary battery was constructed by the same method as that of Example 2-1 and its cycle characteristics were measured.

### Comparative Example 2-2

Using silicon nanoparticles (SIE23PB, by Kojundo Chemical Laboratory Co., Ltd.) with an average particle diameter of 5 μm, in place of the nanosized particle, a lithium ion secondary battery was constructed by the same method as that of Example 2-1 and its cycle characteristics were measured.

### (Evaluation of the Nanosized Particle)

For the Si-type nanosized particles prepared in Examples 2-1 to 2-3, and Comparative Examples 2-1 to 2-2, the powder conductivity measured by the method of Example 2-1, under the condition of powder compression at 63.7 MPa, are shown in Table 4.

The powder conductivities of Examples 2-1 to 2-3 were 4×10⁻⁸ [S/cm] or more, while those for Comparative Example 2-1 to 2-2 were 4×10⁻⁸ [S/cm] or less. Note that in Comparative Examples 2-1 to 2-2, the values were below to measurement limit of 1×10⁻⁸ [S/cm]. When the powder conductivity is high, the amount of conductive agent mixed can be decreased, thereby increasing the per-volume capacity of the electrode, and becoming advantageous in the high rate characteristics.

TABLE 4

| | | | | Comparative | Comparative |
|---|---|---|---|---|---|
| | Example | Example | Example | Example | Example |
| | 2-1 | 2-2 | 2-3 | 2-1 | 2-2 |
| Anode | Si:Cu = 3:1 | Si:Fe:Cu = 24:1:6 | Si:Fe:Cu = 37:1:4 | Si (60 nm) | Si (5 μm) |
| Active | | | | | |
| Material | | | | | |
| Powder | 1.32 × 10⁻⁶ | 1.69 × 10⁻⁶ | 1.85 × 10⁻⁶ | <1.00 × 10⁻⁸ | <1.00 × 10⁻⁸ |
| Conductivity | | | | | |
| [S/cm] | | | | | |

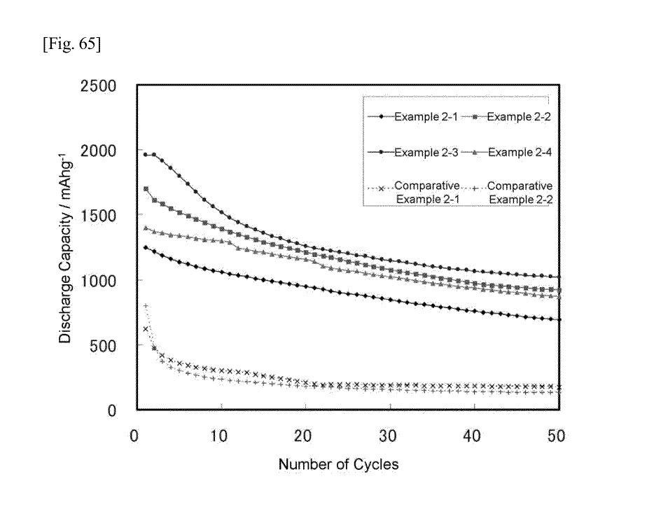

Further, graphs of the number of cycles and the discharge capacity for the batteries of Examples 2-1 to 2-4 and Comparative Examples 2-1 to 2-2 are shown in FIG. 65. Furthermore, the discharge capacity and the capacity maintenance factor for Examples 2-1 to 2-4 and Comparative Examples 2-1 to 2-2 are shown in Table 5.

TABLE 5

| | | | | | Comparative | Comparative |
|---|---|---|---|---|---|---|
| | Example | Example | Example | Example | Example | Example |
| | 2-1 | 2-2 | 2-3 | 2-4 | 2-1 | 2-2 |
| Anode Active | Si:Cu = 3:1 | Si:Fe:Cu = 24:1:6 | Si:Fe:Cu = 37:1:4 | Si:Cu = 3:1 | Si (60 nm) | Si (5 μm) |
| Material | | | | (with CNH) | | |
| Initial | 1250 | 1700 | 1960 | 1400 | 620 | 800 |
| Discharge | | | | | | |
| Capacity | | | | | | |
| (mAhg⁻¹) | | | | | | |
| Discharge | 690 | 920 | 1020 | 870 | 170 | 130 |
| Capacity | | | | | | |
| after 50 cycles | | | | | | |
| (mAhg⁻¹) | | | | | | |
| Capacity | 55 | 54 | 52 | 62 | 27 | 16 |
| Maintenance | | | | | | |
| Factor after | | | | | | |
| 50 cycles (%) | | | | | | |

As shown in Table 5, the initial electric discharge capacities of Examples 2-1 to 2-3 are higher than those of Comparative Examples 2-1 and 2-2. This is because in Comparative Examples 2-1 and 2-2, which consisted only of silicon, most of the silicon could not be used because their conductivities were low, and their discharge capacity is low. On the other hand, in Examples 2-1 to 2-3, because copper silicides and iron silicides were bound to the nanosized particles, the conductivities were high, the silicon utilization rate was high, and the discharge capacity became large.

As shown in Table 5, the capacity maintenance factor after 50 cycles was 55% for Example 2-1, but decreases to 27% in Comparative Example 2-1. It is apparent that the nanosized particle of Example 2-1 suppresses the decrease of capacity and shows superior cycle characteristics, compared to silicon nanoparticles.

Further, by comparing Example 2-1 and Example 2-4, it can be seen that by adding carbon nanohorn, the initial capacity becomes high and the capacity maintenance factor after 50 cycles also improves.

### (Discussion on the Nanosized Particle Formation Process)

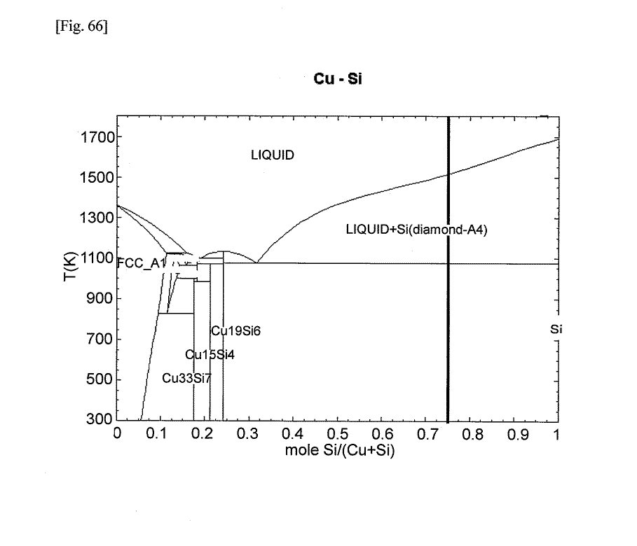

The formation process of the nanosized particle of Example 2-1 is discussed. FIG. 66 is binary system phase diagram of copper and silicon. Since silicon powder and copper powder were mixed so that their molar ratio becomes Si:Cu=3:1, mole Si/(Cu⁺ Si)=0.75 in the raw material powder. The bold line in FIG. 66 shows the line of mole Si/(Cu⁺ Si)=0.75. Since the plasma generated by the high-frequency coil was equivalent to 10,000 K, it exceeded the temperature range of the phase diagram by far, and plasma in which copper atoms and silicon atoms were uniformly mixed was obtained. When plasma is cooled, in the process of changing from plasma to gas, and gas to liquid, a spherical droplet grows, and both copper silicide Cu₁₉Si₆ (or Cu₃Si) and Si are deposited. Therefore, when the plasma of silicon and copper is cooled, a nanosized particle comprising Cu₁₉Si₆ (or Cu₃Si) and Si, is formed. In such a case, silicide Cu₁₉Si₆ (or Cu₃Si) and Si form a configuration where two particles are bound, so that the surface area of both are minimized to minimize the free energy.

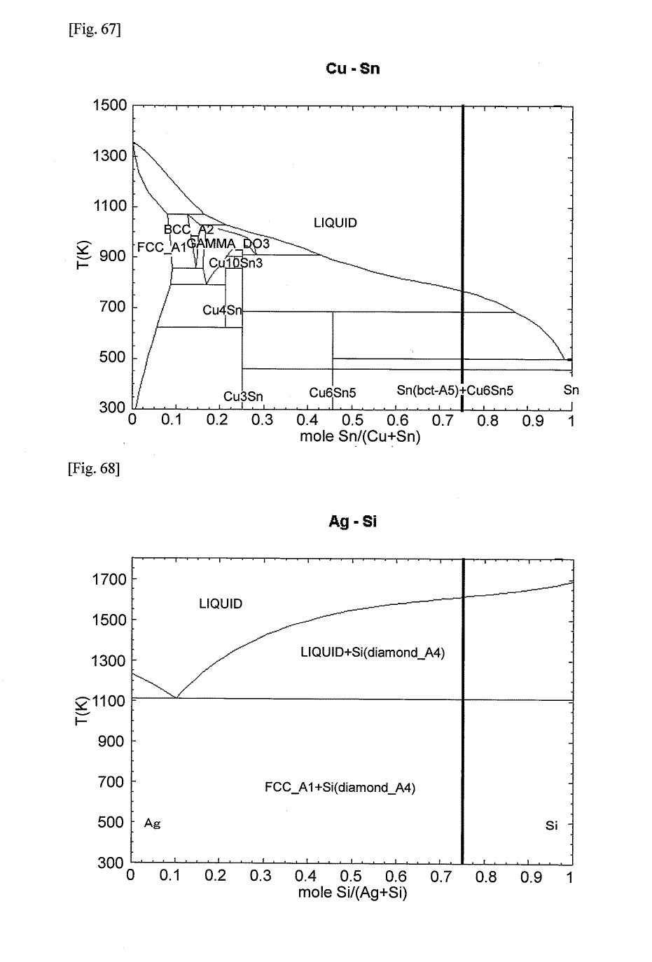

Note that although a nanosized particle was prepared by a binary system of silicon and copper in Example 2-1, the nanosized particle of the present invention is not limited to the binary system of silicon and copper. For example, in the binary system phase diagram of Tin (Sn) and Copper (Cu) shown in FIG. 67, when a plasma of mole Sn/(Cu⁺ Sn)=0.75 is cooled, Cu₃Sn and Sn are deposited. Thus, it is presumed that a nanosized particle in which Cu₃Sn particle and Sn particle are bound will be obtained. The bold line in FIG. 67 is the line that indicates mole Sn/(Cu⁺ Sn)=0.75.

Further, in the binary system phase diagram of silicon (Si) and silver (Ag) shown in FIG. 68, when the plasma of mole Si/(Ag⁺ Si)=0.75 is cooled, Si and Ag are deposited. Since Si and Ag have low affinity, it can be assumed that a nanosized particle, in which a particle of Si and a particle of Ag are bound, will obtained so that the surface area of the part where Si and Ag come in contact is minimized. The bold line in FIG. 68 is a line that shows mole Si/(Ag⁺ Si)=0.75.

In all combinations other than using Si as element A and Cu as element M, i.e., selecting element A from Si, Sn, Al, Pb, Sb, Bi, Ge, In and Zn, and selecting element M from Cu, Ag and Au, compound MAₓ (where x≦1, 3<x) is obtained, or element A and element M do not make a compound, and instead form a seventh phase that is a simple substance or solid solution of element M. Therefore, it can be assumed that in the above combination of element A and element M, both the sixth phase and the seventh phase are exposed to the outer surface, and a nanosized particle, wherein the sixth phase and seventh phase are bound will be obtained.

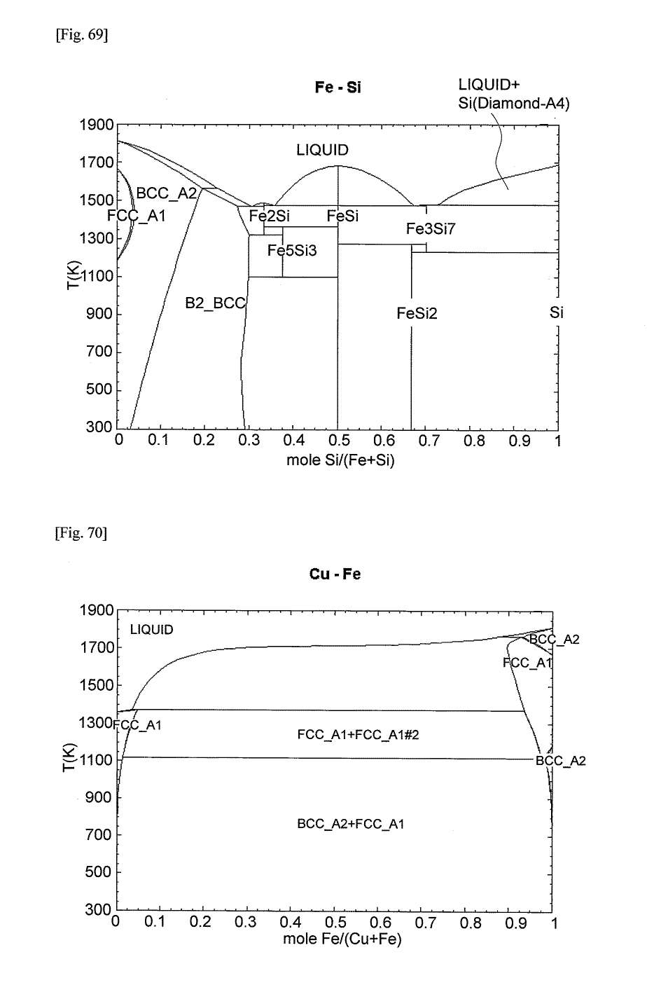

The formation process of nanosized particle 61 of the third embodiment will be discussed. FIG. 69 is a binary system phase diagram of iron (Fe) and silicon (Si). Since the plasma generated by the high-frequency coil is equivalent to 10,000 K, it exceeded the temperature range of the phase diagram by far, and plasma in which iron atoms and silicon atoms are uniformly mixed is obtained. When plasma is cooled, in the process of changing to gas, to liquid, FeSi₂ and Si are deposited. Therefore, due to the fact that the surface tension becomes the controlling factor because a droplet of silicon and iron is formed in between, a nanosized particle wherein FeSi₂ and Si are bound via an interface, as shown in FIG. 5, is formed.

Further, FIG. 70 is binary system phase diagram of copper (Cu) and iron (Fe). If plasma containing copper and iron is cooled, copper and iron do not create a solid solution but instead, copper and iron are deposited. Therefore, a solid solution of iron and copper is not deposited in nanosized particle 61.

The nanosized particle of the present invention is not limited to the binary system of silicon and iron. For example, in the binary system phase diagram of Co (cobalt) and Si (silicon) shown in FIG. 45, since CoSi₂ and Si are deposited when the plasma is cooled, it can be assumed that a nanosized particle wherein CoSi₂ and Si are bound via an interface is obtained.

In all combinations other than using Si as element A and Fe as element D, i.e., selecting element D from Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, a binary system phase diagram similar to that of Fe—Si is obtained, and compound DAₓ (1<x≦3) is obtained. Therefore, in the above combination of element A and element D, it is assumed that a nanosized particle, comprising a structure wherein a ninth phase and a sixth phase are bound via an interface, is obtained. However, as in Si—Nd, some combinations easily react with water and lack stability in air; in such case, they may be selected according to the process environment.

As mentioned above, when a raw material powder obtained by mixing a powder of element A, a powder of element M, and a powder of element D is supplied to a nanosized particle production apparatus, plasma containing element A, element M, and element D is generated. When this plasma is cooled, a sixth phase consisting of element A, a seventh spherical phase of a compound of element A and element M, and a ninth phase consisting of a compound etc. of element A and element D are generated, and a nanosized particle, comprising a structure wherein the sixth phase and seventh phase are bound via an interface and the ninth phase and sixth phase are bound via an interface, is obtained.

Furthermore, according to the third embodiment, the formation process of nanosized particle 73, which comprises an eleventh phase 75, will be discussed. From the binary system phase diagram of Co (cobalt) and Si (silicon) shown in FIG. 45, it is assumed that a nanosized particle wherein CoSi₂ and Si are bound via an interface is obtained.

FIG. 47 is a binary system phase diagram of cobalt and iron. If a mixed powder of cobalt powder and iron powder is cooled from plasma, a simple substance of cobalt and a solid solution of iron cobalt, a simple substance of iron and a solid solution of iron cobalt, or a solid solution of iron cobalt alone, will be deposited. Therefore, when a plasma containing silicon, iron, and cobalt is cooled, a nanosized particle comprising FeSi₂, CoSi₂, and Si will be formed. In such a case, it is assumed that FeSi₂ and Si are bound and CoSi₂ and Si are bound. Further, depending on the content of silicon, iron, and cobalt, a solid solution of iron cobalt may be deposited within the nanosized particle.

As described above, when a raw material powder wherein a powder of element A, a powder of element M, a powder of element D, and a powder of element D′ are mixed is supplied to a nanosized particle production apparatus, a plasma containing element A, element M, element D, and element D′ will be generated. When this plasma is cooled, a sixth phase consisting of element A, a seventh phase consisting of a compound of element A and element M etc., a ninth phase consisting of a compound of element A and element D, and an eleventh phase consisting of a compound of element A and element D′, are generated, and a nanosized particle wherein the sixth phase and seventh phase are bound together, the ninth phase and sixth phase are bound together, and the eleventh phase and sixth phase are bound together, is obtained.

### Example 3-1

### (Preparation of Nanosized Particle)

Using the apparatus of FIG. 4, a raw material powder prepared by mixing silicon powder, iron powder, and tin powder so that their molar ratio became Si:Fe:Sn=12:1:12, and drying the mixed powder, was supplied continuously with a carrier gas into the plasma of Ar—H₂ mixed gas generated in the reaction chamber, to produce nanosized particles.

More specifically, the nanosized particle was produced by the following method. After evacuating the reaction chamber with a vacuum pump, Ar gas was introduced to atmospheric pressure. This process of evacuation and Ar gas introduction was repeated three times to rid the reaction vessel of remaining air. Then, Ar—H₂ gas was introduced into the reaction vessel as the plasma gas at a flow rate of 13 L/min, and AC voltage was applied to the high-frequency coil, to generate high-frequency plasma by a high-frequency electromagnetic field (frequency of 4 MHz). Here, the plate electricity was set to 20 kW. Ar gas at a flow rate of 1.0 L/min was used as the carrier gas to supply the raw material powder. The fine powder obtained was recovered at the filter.

### (Evaluation of the Composition of the Nanosized Particle)

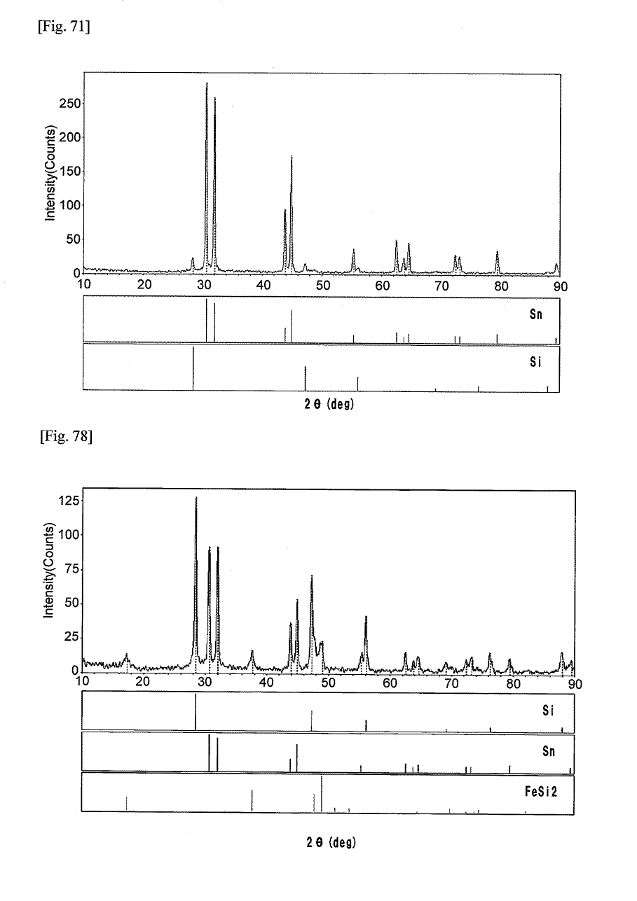

The nanosized particle was identified by a powder X-ray diffraction device (RINT-UltimaIll, by Rigaku Corporation) using a CuKα ray. FIG. 71 shows the X-ray diffraction (XRD) pattern of the nanosized particle of Example 3-1. It was found that the nanosized particle of Example 3-1 comprises crystalline Si and Sn.

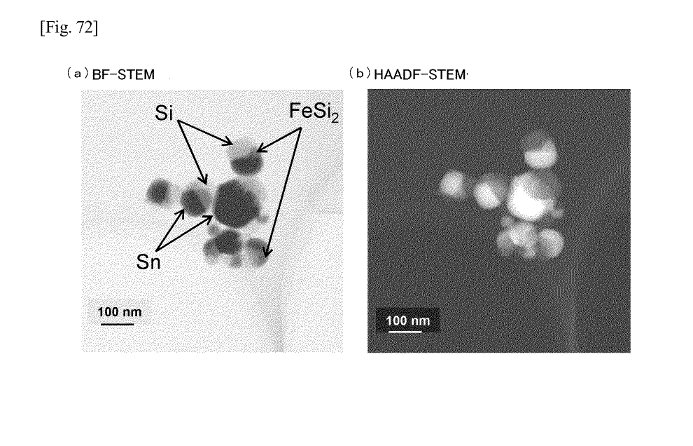

Using a scanning transmission electron microscope (JEM 3100FEF, by JEOL Ltd.), observation of the particle configuration of the nanosized particle was performed. The STEM images of the nanosized particle of Example 3-1 are shown in FIG. 72(a) to (b). FIG. 72(a) is the BF-STEM (Bright-Field Scanning Transmission Electron Microscopy) image. FIG. 72(b) is a STEM image by HAADF-STEM (High-Angle-Annular-Dark-Field-Scanning-Transmission-Electron-Microscopy). According to FIG. 72 (a) to (b), nanosized particles of about 50 to 200 nm were observed, and each showed a configuration of two approximately spherical particles bound together. The dark-colored part in (a) is presumably Sn, and the light-colored part is presumably Si.

Further, the STEM image of the nanosized particle is shown in FIG. 73. Nanosized particles with a particle diameter of about 70 to 130 nm were observed, each with two approximately spherical particles bound together. The white-colored part presumably indicates Sn, and the dark-colored part appears to be Si.

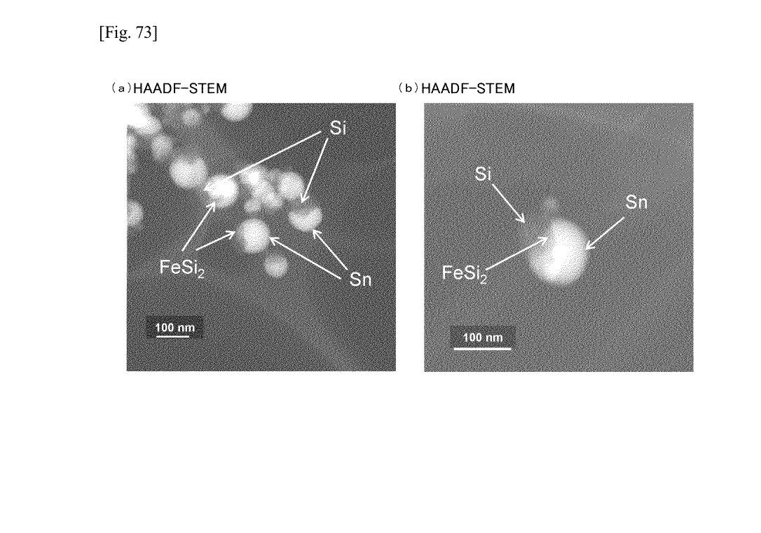

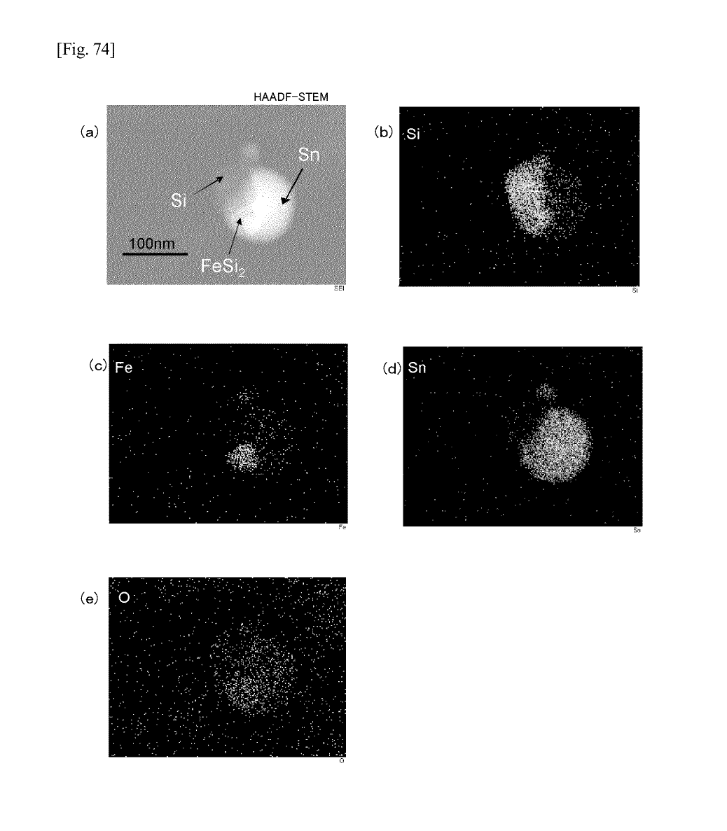

Particle configuration observation and composition analysis of the nanosized particle was performed by HAADF-STEM and EDS (Energy Dispersive Spectroscopy: energy dispersion-type X-ray analysis) analysis, using a scanning transmission electron microscope (JEM 3100FEF, by JEOL Ltd.). FIG. 74 (a) shows that nanosized particles with particle diameters of about 130 nm were observed, FIG. 74(b) shows that silicon atoms exist in the dark-colored region on the left half of the nanosized particle, and FIG. 74(c) shows that many iron atoms are detected in parts of the brightly observed portion in FIG. 74(a). FIG. 74(d) shows that many tin atoms are detected in the parts that were brightly observed in FIG. 74(a). According to FIG. 74(e), oxygen atoms presumably due to oxidation are dispersed throughout the entire nanosized particle.

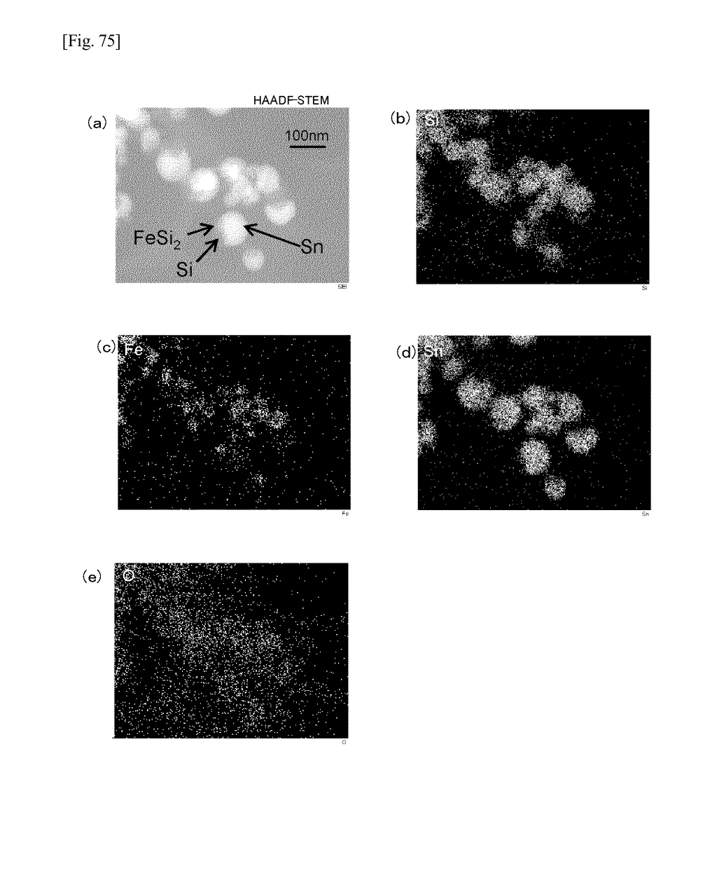

FIG. 75 (a) shows that nanosized particles with particle diameters of about 50 to 100 nm were observed, FIG. 75(b) shows that silicon atoms exist in the dark-colored area of the nanosized particle, and FIG. 75(c) shows that iron atoms are detected in parts of the brightly observed part in FIG. 75(a). FIG. 75(d) shows that many tin atoms are detected in the parts that were brightly observed in FIG. 75(a). FIG. 75(e) shows that oxygen atoms presumably due to oxidation are dispersed throughout the entire nanosized particle.

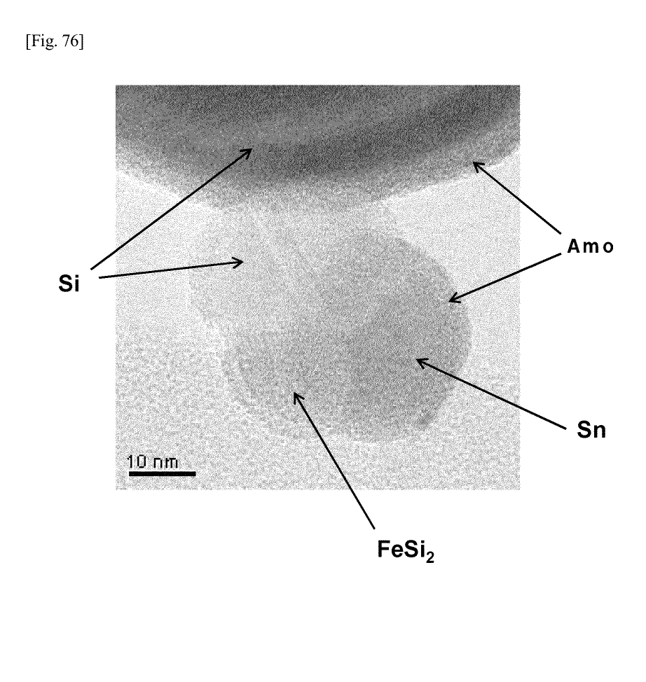

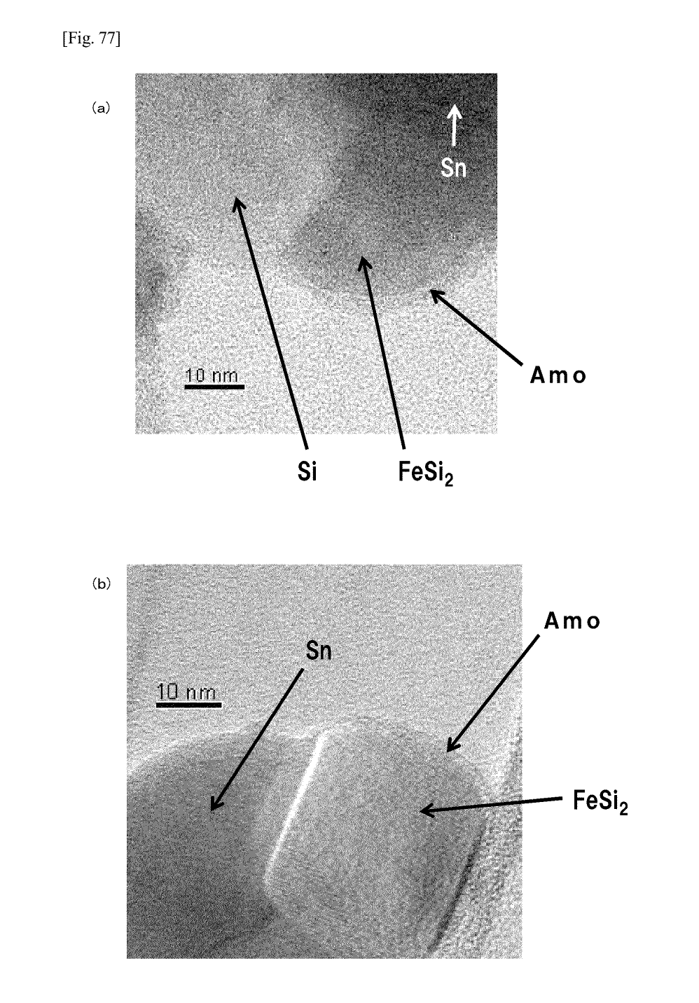

Further, observation of the particle configuration of the nanosized particle was performed using a transmission electron microscope (H-9000 UHR, by Hitachi High-Technologies Corporation). The TEM image of the nanosized particle of Example 3-1 is shown in FIG. 76. Nanosized particles with particle diameters of about 40 nm, each comprising two approximately spherical particles bound together, were observed, and an amorphous layer (Amo) was confirmed around the particle (shown by an arrow). In FIG. 77(a) to (b), nanosized particles comprising two particles of approximately spherical configuration bound together, and an amorphous layer (Amo) around the particle (shown by the arrow) were confirmed.

From the above analysis results, it was confirmed that in the nanosized particle of Example 3-1, Sn with an approximately spherical outer surface and an approximately spherical Si are bound, and that FeSi₂ with an approximately spherical outer surface and a spherical Si or Sn are bound.

### (Evaluation of the Powder Conductivity)

In order to evaluate the conductivity at a state of powder, the powder conductivity was evaluated using a powder resistance measurement system, MCP-PD51, of Mitsubishi Chemical Corporation. The conductivity was calculated from the resistance value obtained when a sample powder was compressed at an arbitrary pressure. The data shown in the later-described Table 6 are values obtained when the sample powder was compressed at 63.7 MPa, and measured.

### (Evaluation of the Cycle Characteristic of the Nanosized Particle)

### (i) Preparation of the Anode Slurry

The nanosized particle of Example 3-1 was used. To a mixer was introduced the nanosized particle at a ratio of 45.5 parts by weight, and acetylene black (average particle diameter of 35 nm, powder, by DENKI KAGAKU KOGYO KABUSHIKI KAISHA) at a ratio of 47.5 parts by weight. Furthermore, as a binding agent, an emulsion of 40 wt % of styrene-butadiene rubber (SBR) (BM400B, by Nippon Zeon Co., Ltd.) at a solid content of 5 parts by weight, and as a thickener to control the viscosity of the slurry, a 1 wt % solution of sodium carboxymethyl cellulose (#2200, by Daicel Corporation) at a solid content of 10 parts by weight were mixed to prepare a slurry.

### (ii) Preparation of Anode

Using a doctor blade of an automatic coating apparatus, the prepared slurry was applied on to a current collector electrolytic copper foil with a thickness of 10 μm (NC—WS by Furukawa Electric Co. Ltd.), at a thickness of 15 μm, and dried at 70° C., followed by a thickness control process by pressing, to produce an anode for lithium ion secondary battery.

(iii) Characteristic Evaluation

Using the anode for lithium ion secondary batteries, an electrolyte solution containing 1 mol/L of LiPF₆ and a mixed solution of ethylene carbonate and diethyl carbonate, and a counter electrode of metal Li foil, a lithium secondary battery was constructed, and its charge-and-discharge characteristic was investigated. For characteristic evaluation, the initial discharge capacity and the discharge capacity after 50 cycles of charge-and-discharge were measured, and the maintenance factor of the discharge capacity was calculated. The discharge capacity was calculated based on the total weight of silicide and the active material Si effective for the occlusion and discharge of lithium. First, at an environment of 25° C., charging was performed up to a current of 0.1 C and a voltage of 0.02 V, under constant current constant voltage conditions, and charging was terminated when the current decreased to 0.05 C. Subsequently, at a condition of a current value of 0.1 C, discharge was performed until the voltage against metal Li became 1.5 V, and the initial discharge capacity at 0.1 C was measured. Note that 1 C refers to the value of current that can be fully charged in 1 hour. Further, both charge and discharge were performed under an environment of 25° C. Subsequently, the above-described charge-and-discharge at a charge-and discharge rate of 0.1 C was repeated for 50 cycles. The rate of the discharge capacity after repeating 50 cycles of charge-and-discharge against the initial discharge capacity at 0.1 C was calculated in percentage, as the discharge capacity maintenance factor after 50 cycles.

### Example 3-2

Other than using a raw material powder prepared by mixing silicon powder, iron powder, and tin powder so that their molar ratio became Si:Fe:Sn=10:1:1 and drying the mixed powder, nanosized particles were synthesized by the same means as Example 3-1, and observed by XRD and STEM. Further, a lithium ion secondary battery was constructed by the same method as that of Example 3-1, and its cycle characteristic was measured.

FIG. 78 shows the X-ray diffraction (XRD) pattern of the nanosized particle of Example 3-2. It was found that the nanosized particle of Example 3-2 comprises crystalline Si, Sn, and FeSi₂.

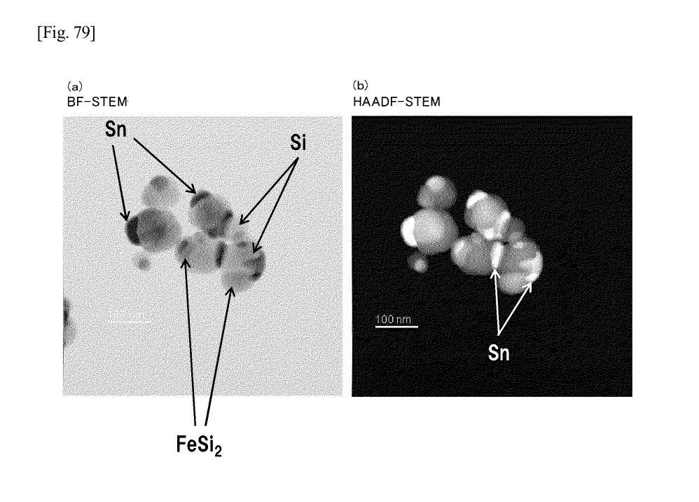

The STEM images of the nanosized particle of Example 3-2 are shown in FIG. 79(a) to (b). Nanosized particles with a particle diameter of about 50 to 130 nm were observed. In FIG. 79 (a), the dark-colored part appears to be Sn and the light-colored part appears to be Si.

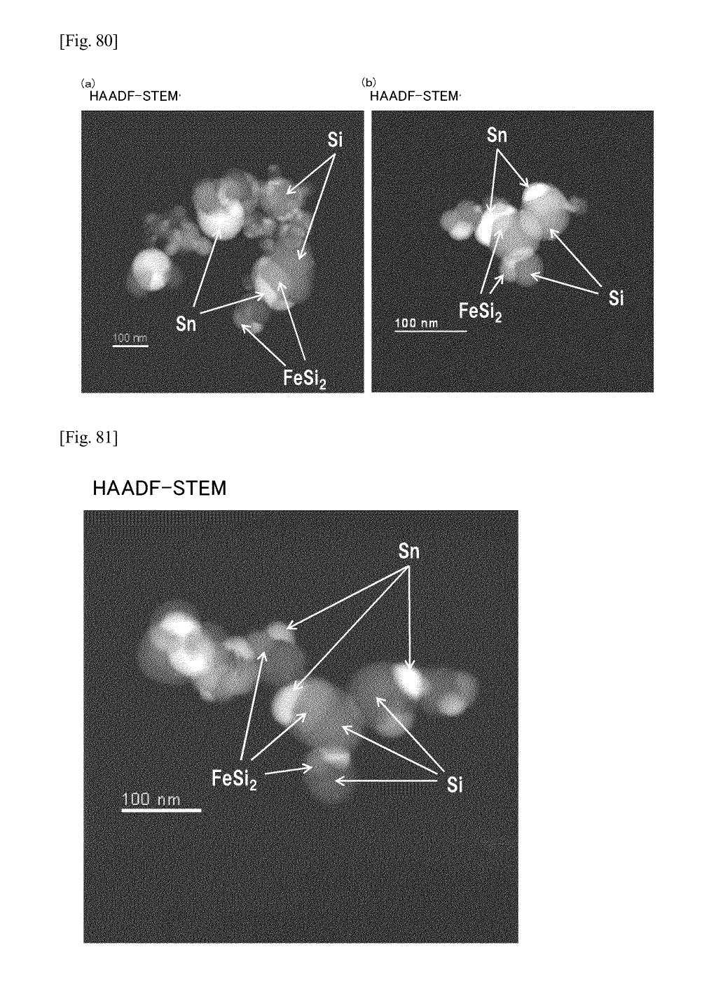

The STEM images of the nanosized particle of Example 3-2 are shown in FIG. 80(a) to (b). Nanosized particles with a particle diameter of about 60 to 180 nm were observed. The bright region appears to be comprised mainly of Sn and the dark region appears to mainly comprise Si.

The STEM image of the nanosized particle of Example 3-2 is shown in FIG. 81. Nanosized particles with a particle diameter of about 80 to 120 nm were observed. The bright region appears to be comprised mainly of Sn and the dark region appears to mainly comprise Si.

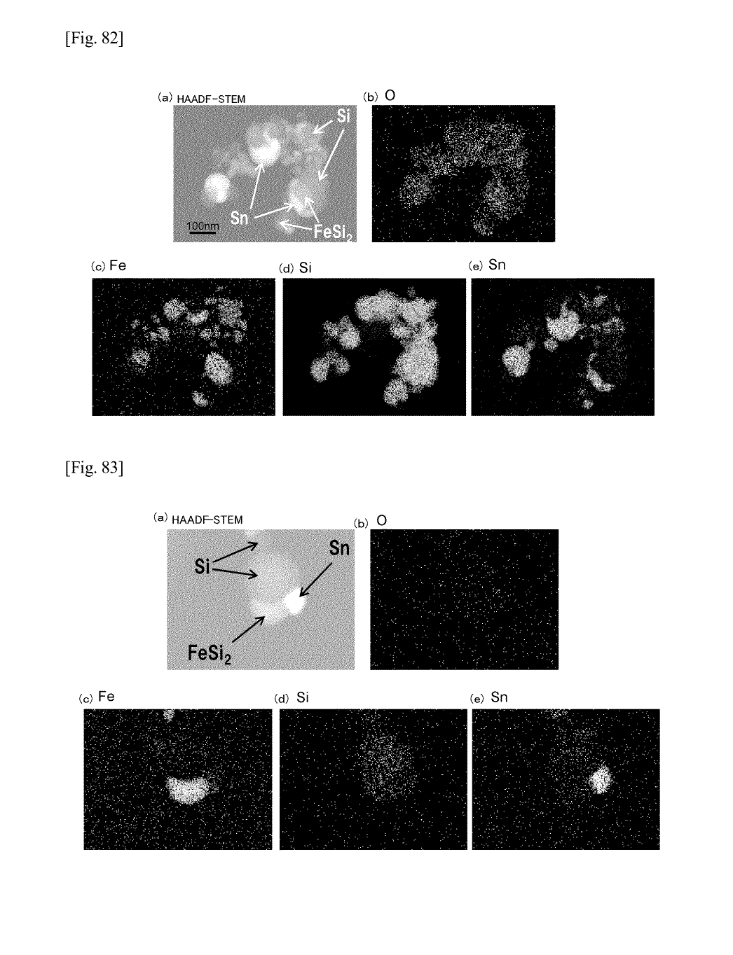

FIG. 82(a) indicate that nanosized particles with particle diameters of about 100 to 150 nm were observed, and FIG. 82(b) shows that oxygen atoms presumably due to oxidation are dispersed throughout the entire nanosized particle. FIG. 82(c) indicates that many iron atoms are detected in parts of the area that were brightly observed in FIG. 82(a). FIG. 82(d) shows that many silicon atoms are detected in the parts that were darkly observed in FIG. 82(a). FIG. 82(e) shows that many tin atoms are detected in the parts that were brightly observed in FIG. 82(a).

According to FIG. 83(a), nanosized particles, wherein silicon, tin, and iron silicide are bound, were observed, and FIG. 83(b) indicates that oxygen atoms presumably due to oxidation are dispersed throughout the entire nanosized particle. FIG. 83(c) indicates that many iron atoms are detected in the parts that were observed slightly brighter in FIG. 83(a). FIG. 83(d) shows that many silicon atoms are detected in the parts that were darkly observed in FIG. 83(a). FIG. 83(e) shows that many tin atoms are detected in the parts that were brightly observed in FIG. 83(a).

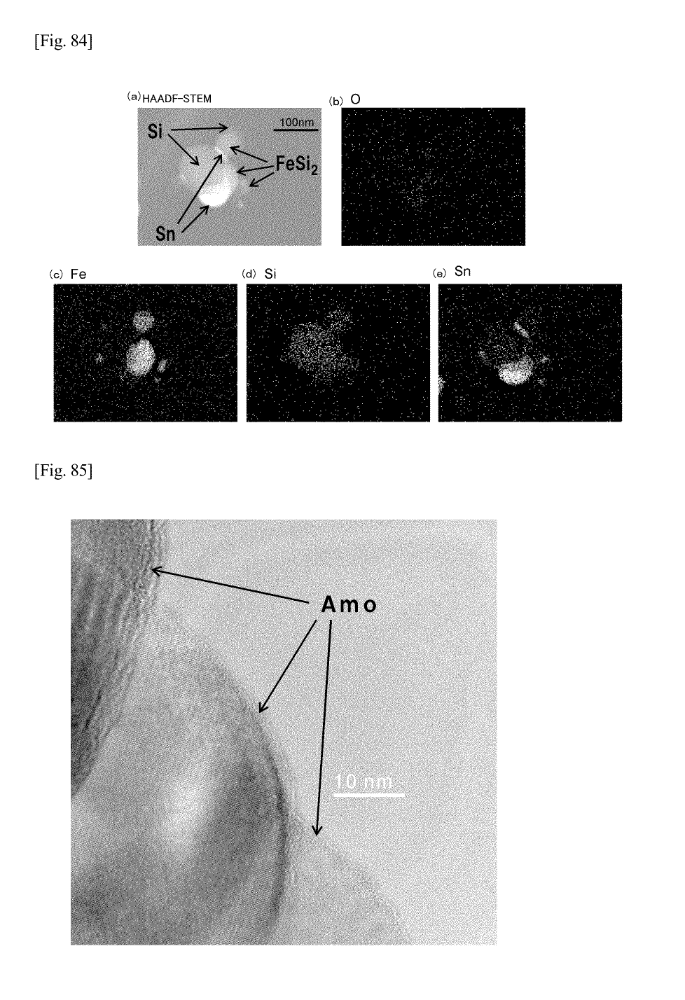

According to FIG. 84(a), nanosized particles, wherein silicon, tin, and iron silicide are bound, with a particle diameter of about 140 nm, were observed, and FIG. 84(b) indicates that oxygen atoms presumably due to oxidation are dispersed throughout the entire nanosized particle. FIG. 84(c) indicates that many iron atoms are detected in the parts that were observed slightly brighter in FIG. 84(a). FIG. 84(d) shows that many silicon atoms are detected in the parts that were darkly observed in FIG. 84(a). FIG. 84(e) shows that many tin atoms are detected in the parts that were brightly observed in FIG. 84(a).

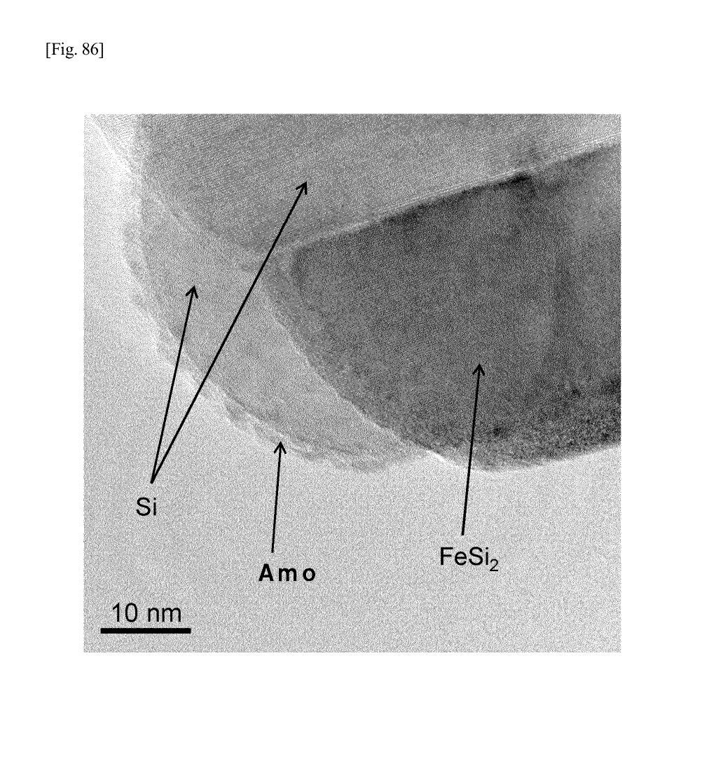

Further, the high resolution TEM images of the nanosized particle of Example 3-2 are shown in FIGS. 85 and 86. A lattice image was confirmed inside the particles and an amorphous layer was confirmed around the particles.

From these findings, it was determined that the nanosized particle of Example 3-2 comprises a structure, wherein a fourteenth phase formed of Sn with an approximately spherical outer surface is bound to an approximately spherical thirteenth phase formed of silicon, and a fifteenth phase with an outer surface that is approximately spherical that is formed of FeSi₂, is further bound.

### Example 3-3

Other than using a raw material powder prepared by mixing silicon powder, iron powder, and tin powder so that their molar ratio became Si:Fe:Sn=21:1:1 and drying the mixed powder, nanosized particles were synthesized by the same means as Example 3-1, and observed by XRD and STEM. Further, a lithium ion secondary battery was constructed by the same method as that of Example 3-1, and its cycle characteristic was measured.

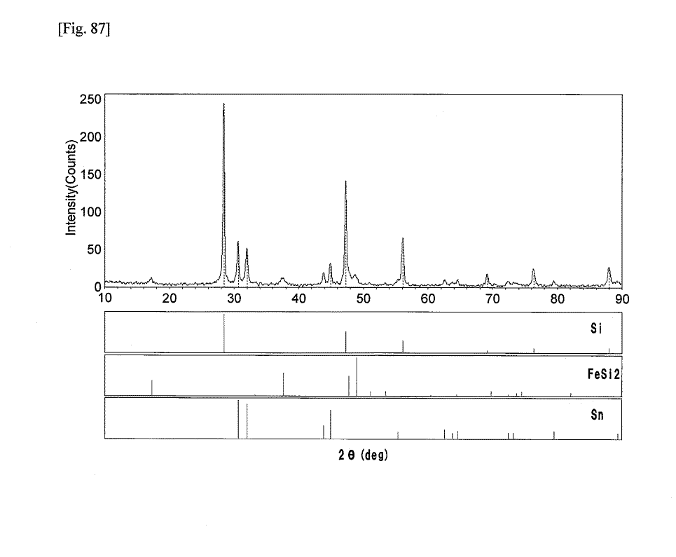

FIG. 87 shows the X-ray diffraction (XRD) pattern of the nanosized particle of Example 3-3. It was found that the nanosized particle of Example 3-3 comprises crystalline Si, Sn, and FeSi₂. Compared to Example 3-2, the height of the peak derived from Sn is decreased.

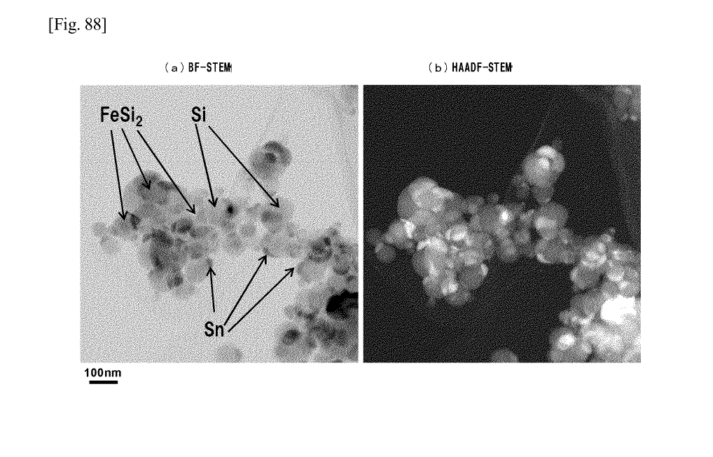

The STEM images of the nanosized particle of Example 3-3 are shown in FIG. 88(a) to (b). Nanosized particles with particle diameters of about 50 to 150 nm with an approximately spherical outer surface were observed. In FIG. 88 (a), the dark-colored part appears to be Sn and the light-colored part appears to be Si.

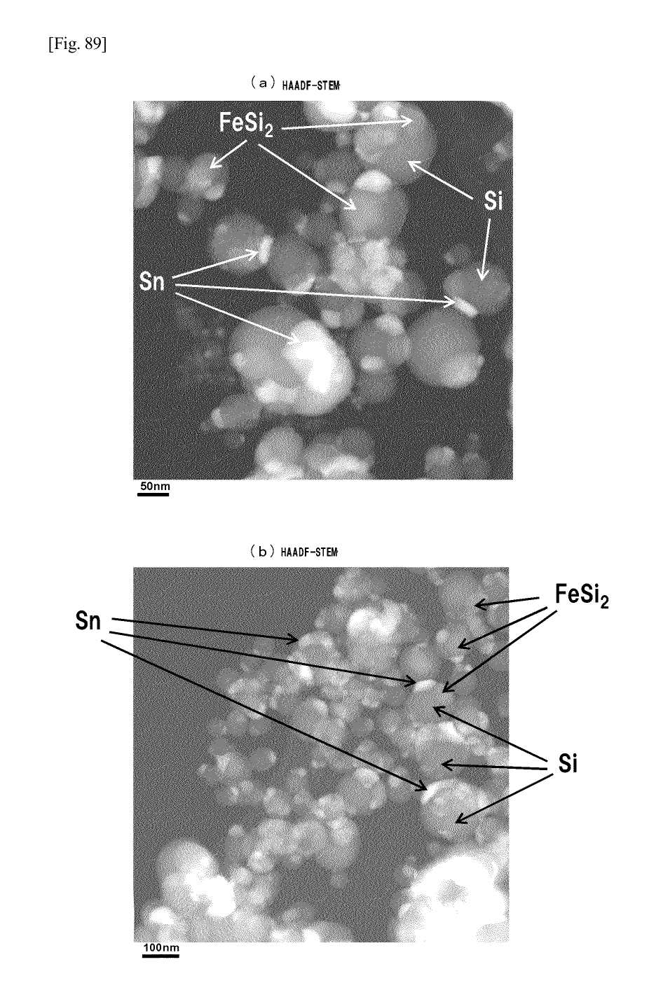

The STEM images of the nanosized particle of Example 3-3 are shown in FIG. 89(a) to (b). Nanosized particles with particle diameters of about 50 to 150 nm with an approximately spherical outer surface were observed. The bright region appears to be consisted of Sn and the dark region appears to be consisted of Si.

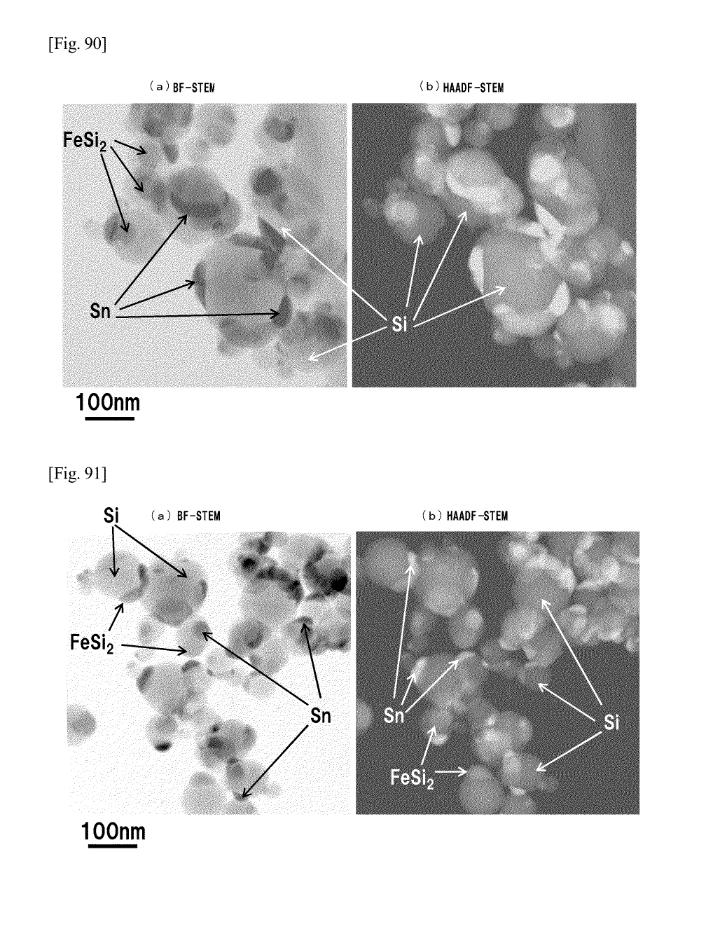

The STEM images of the nanosized particle of Example 3-3 are shown in FIG. 90(a) to (b). Nanosized particles with particle diameters of about 50 to 200 nm with an approximately spherical outer surface were observed. In FIG. 90(a), the dark-colored part appears to be Sn and the light-colored part appears to be Si.

The STEM images of the nanosized particle of Example 3-3 are shown in FIG. 91(a) to (b). Nanosized particles with particle diameters of about 30 to 140 nm with an approximately spherical outer surface were observed. In FIG. 91(a), the dark-colored part appears to be Sn and the light-colored part appears to be Si.

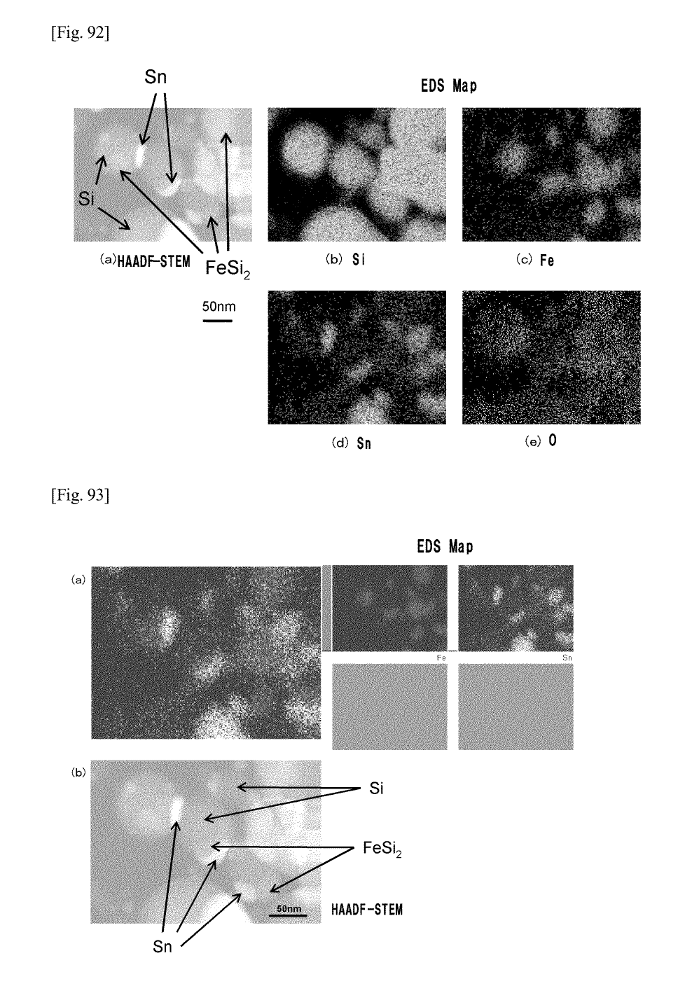

According to FIG. 92 (a), nanosized particles with particle diameters of about 100 to 150 nm were observed, and FIG. 92(b) shows that many silicon atoms were detected in the darkly observed part. FIG. 92(c) shows that many iron atoms were detected in the parts that were observed slightly brighter in FIG. 92(a). FIG. 92(d) shows that many tin atoms were detected in the parts that were brightly observed in FIG. 92(a). FIG. 92(e) shows that oxygen atoms presumably due to oxidation are dispersed throughout the entire nanosized particle.

FIG. 93 further shows the EDS analysis result. FIG. 93(a) is the EDS map for Fe and Sn and the superposition of these, and FIG. 93(b) is the HAADF-STEM image from the same view point. FIG. 93(a) indicates that there are very few overlaps in the detection points of Sn and Fe. Since peaks derived from Sn—Fe alloy could not be found in the XRD analysis, there are no Sn—Fe alloys formed in this nanosized particle. Further, since Si and Sn do not form an alloy, Sn exists as a simple substance.

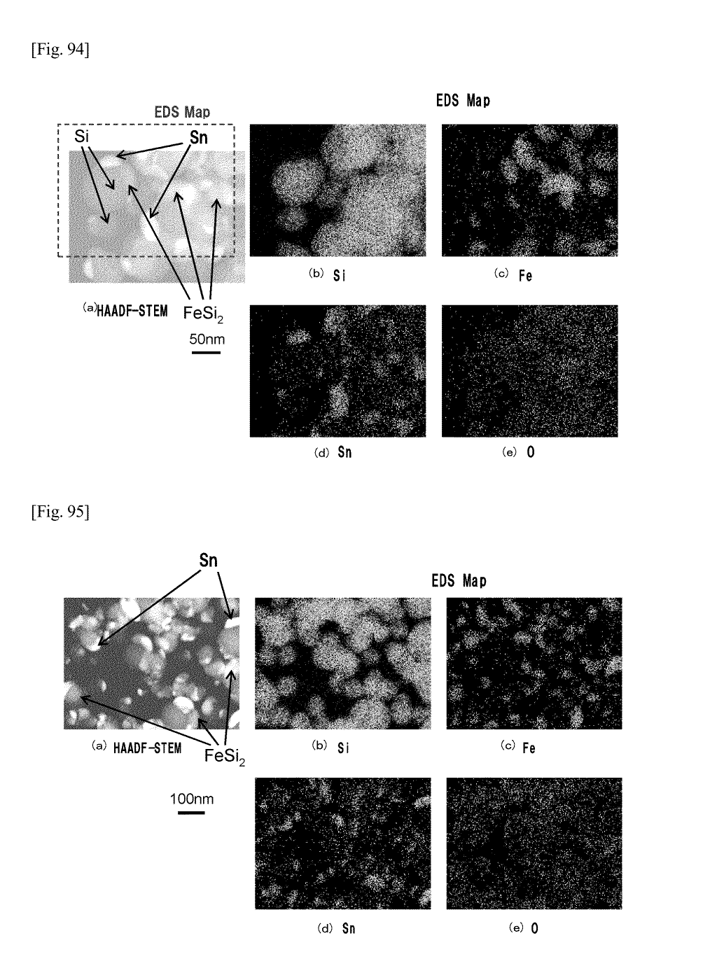

According to FIG. 94 (a), nanosized particles with particle diameters of about 50 to 100 nm were observed, and FIG. 94(b) shows that many silicon atoms were detected in the darkly observed part. FIG. 94(c) shows that many iron atoms were detected in the parts that were observed slightly brighter in FIG. 94(a). FIG. 94(d) shows that many tin atoms were detected in the parts that were brightly observed in FIG. 94(a). FIG. 94(e) shows that oxygen atoms presumably due to oxidation are dispersed throughout the entire nanosized particle. Further, comparing FIG. 94(c) and (d) indicate that the detection points for Sn and Fe do not overlap.

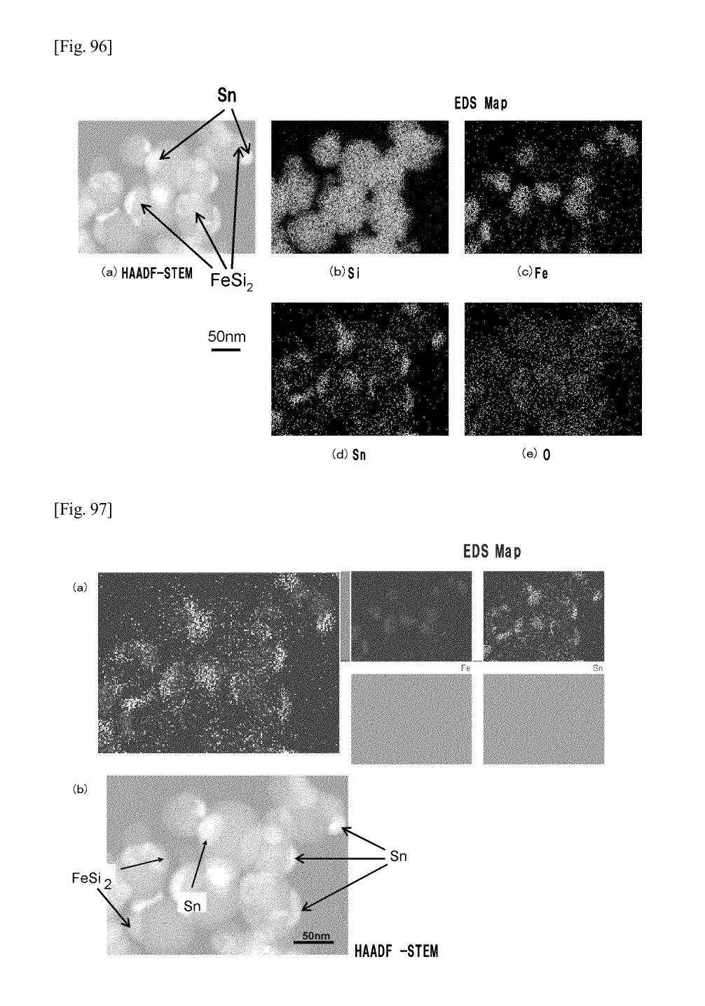

In FIG. 95 and FIG. 96, a similar tendency as that of FIG. 94 was seen, and the detection points for Sn and Fe did not overlap.

FIG. 97 further shows the EDS analysis result. FIG. 97(a) is the EDS map for Fe and Sn and the superposition of these, and FIG. 97(b) is the HAADF-STEM image from the same view point. FIG. 97(a) indicates that there are very little overlap in the detection points of Sn and Fe. Since peaks derived from Sn—Fe alloy could not be seen in the XRD analysis, there are no Sn—Fe alloys formed in this nanosized particle. Further, since Si and Sn do not form an alloy, Sn exists as a simple substance.

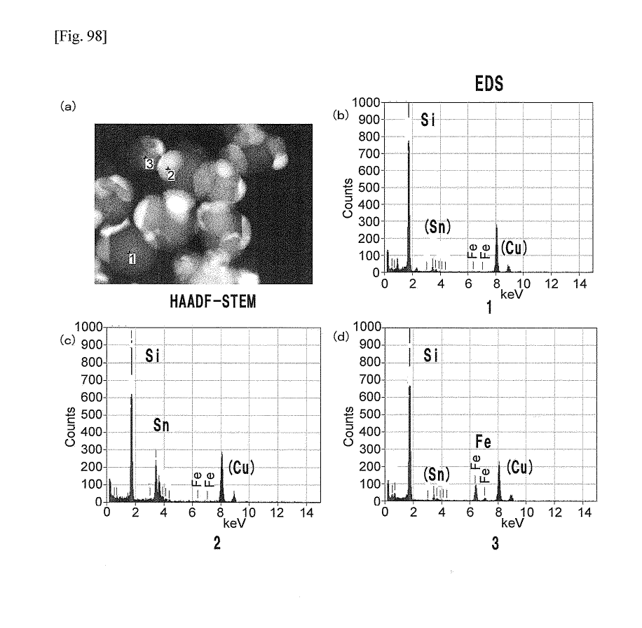

FIG. 98 shows the EDS analysis result for points 1 to 3 within the nanosized particle. In the first part shown in FIG. 98(b), Si was mainly observed, and a very small amount of Sn was observed. In the second part shown in FIG. 98(c), Si and Sn were observed. In the third part shown in FIG. 98(d), Si and Fe were mainly observed and a very small amount of Sn was observed. Note that the Cu background originating from the TEM mesh that holds the sample during observation is widely observed.

From these results, it was determined that the nanosized particle of Example 3-3 comprises a structure wherein a fourteenth phase formed of Sn with an approximately spherical outer surface is bound to an approximately spherical thirteenth phase that is formed of silicon, and an approximately spherical fifteenth phase formed of FeSi₂ is further bound thereto.

### Example 3-4

The nanosized particle of Example 3-1 was used. A precision mixture obtained by subjecting the nanosized particle and carbon nanohorn (average particle diameter of 80 nm, by NEC Corporation) to precision mixing at a ratio of nanosized particle: CNH=7:3 (weight ratio) by a miller (MIRALO, by Nara Machinery Co. Ltd.) was supplied to a mixer at a content of 65 parts by weight, along with 28 parts by weight of acetylene black. Further, a slurry was prepared by the method of Example 3-1, using the same binding agent and thickening agent as that of Example 3-1, at the same ratio as that of Example 3-1. A lithium ion battery was constructed by the same method as that of Example 3-1, and its cycle characteristic was measured.

### Comparative Example 3-1

Using silicon nanoparticles (by Hefei Kai'er NanoTech) with an average particle diameter of 60 nm in place of the nanosized particle, a lithium ion secondary battery was constructed by the same method as that of Example 3-1 and its cycle characteristics were measured.

### Comparative Example 3-2

Using silicon particles (SIE23PB, by Kojundo Chemical Laboratory Co., Ltd.) with an average particle diameter of 5 μm, in place of the nanosized particle, a lithium ion secondary battery was constructed by the same method as that of Example 3-1 and its cycle characteristics were measured.

### (Evaluation of the Nanosized Particle)

For the Si-type nanosized particles prepared in Examples 3-1 to 3-3, and Comparative Examples 3-1 to 3-2, the powder conductivity measured by the method of Example 3-1, under the condition of powder compression at 63.7 MPa, are shown in Table 6.

The powder conductivities of Examples 3-1 to 3-3 were 4×10⁻⁸ [S/cm] or more, while those for Comparative Example 3-1 to 3-2 were 4×10⁻⁸ [S/cm] or less. Note that in Comparative Examples 3-1 to 3-2, the values were below to measurement limit of 1×10⁻⁸ [S/cm]. When the powder conductivity is high, the amount of conductive agent mixed can be decreased, thereby increasing the per-volume capacity of the electrode, and becoming advantageous in the high rate characteristics.

TABLE 6

| | | | | Comparative | Comparative |
|---|---|---|---|---|---|
| | Example | Example | Example | Example | Example |
| | 3-1 | 3-2 | 3-3 | 3-1 | 3-2 |
| Anode | Si:Fe:Sn = 12:1:12 | Si:Fe:Sn = 10:1:1 | Si:Fe:Sn = 21:1:1 | Si (60 nm) | Si (5 μm) |
| Active | | | | | |
| Material | | | | | |
| Powder | 3.08 × 10⁻⁷ | 6.90 × 10⁻⁷ | 8.46 × 10⁻⁷ | <1.00 × 10⁻⁸ | <1.00 × 10⁻⁸ |
| Conductivity | | | | | |
| [S/cm] | | | | | |

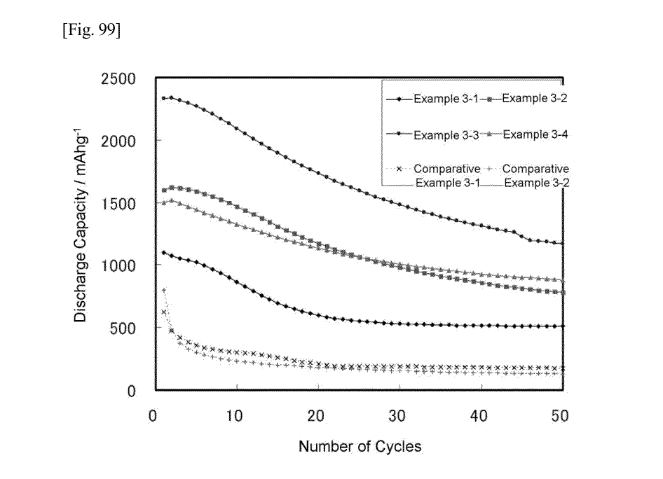

Further, graphs of the number of cycles and the discharge capacity for the batteries of Examples 3-1 to 3-4 and Comparative Examples 3-1 to 3-2 are shown in FIG. 99. Furthermore, the discharge capacity and the capacity maintenance factor of Examples 3-1 to 3-4 and Comparative Examples 3-1 to 3-2 are shown in Table 7.

TABLE 7

| | | | | | Comparative | Comparative |
|---|---|---|---|---|---|---|
| | Example | Example | Example | Example | Example | Example |
| | 3-1 | 3-2 | 3-3 | 3-4 | 3-1 | 3-2 |
| Anode Active | Si:Fe:Sn = 12:1:12 | Si:Fe:Sn = 10:1:1 | Si:Fe:Sn = 21:1:1 | Si:Fe:Sn = 12:1:12 | Si (60 nm) | Si (5 μm) |
| Material | | | | (with CNH) | | |
| Initial | 1110 | 1600 | 2310 | 1500 | 620 | 800 |
| Discharge | | | | | | |
| Capacity | | | | | | |
| (mAhg⁻¹) | | | | | | |
| Discharge | 500 | 780 | 1160 | 890 | 170 | 130 |
| Capacity | | | | | | |
| after 50 cycles | | | | | | |
| (mAhg⁻¹) | | | | | | |
| Capacity | 45 | 49 | 50 | 59 | 27 | 16 |
| Maintenance | | | | | | |
| Factor after | | | | | | |
| 50 cycles (%) | | | | | | |

As shown in Table 7, the initial electric discharge capacities of Examples 3-1 to 3-3 are higher than those of Comparative Examples 3-1 and 3-2. This is because in Comparative Examples 3-1 and 3-2, which consisted only of silicon, most of the silicon could not be used because their conductivities were as low as 1×10⁻⁸ [S/cm], and their discharge capacity became low. On the other hand, in the nanosized particles of Examples 3-1 to 3-3, because Sn and iron silicides were bound to the nanosized particles, the conductivities were high, the silicon utilization rate was high, and the discharge capacity became large.

As shown in Table 7, the capacity maintenance factor after 50 cycles was 45% for Example 3-1, but decreases to 27% in Comparative Example 3-1. It is apparent that the nanosized particle of Example 3-1 suppresses the decrease of capacity and shows superior cycle characteristics, compared to silicon nanoparticles.

Further, by comparing Examples 3-1 to 3-4 and Comparative Example 3-1, the initial discharge capacity and the capacity maintenance factor after 50 cycles in all of Examples 3-1 to 3-4, which utilize the nanosized particle of the present invention, were more superior than those of Comparative Example 3-1.

Further, by comparing Example 3-1 and Example 3-4, it can be seen that by adding carbon nanohorn, the initial capacity becomes high and the capacity maintenance factor after 50 cycles also improves.

### (Discussion on the Nanosized Particle Formation Process)

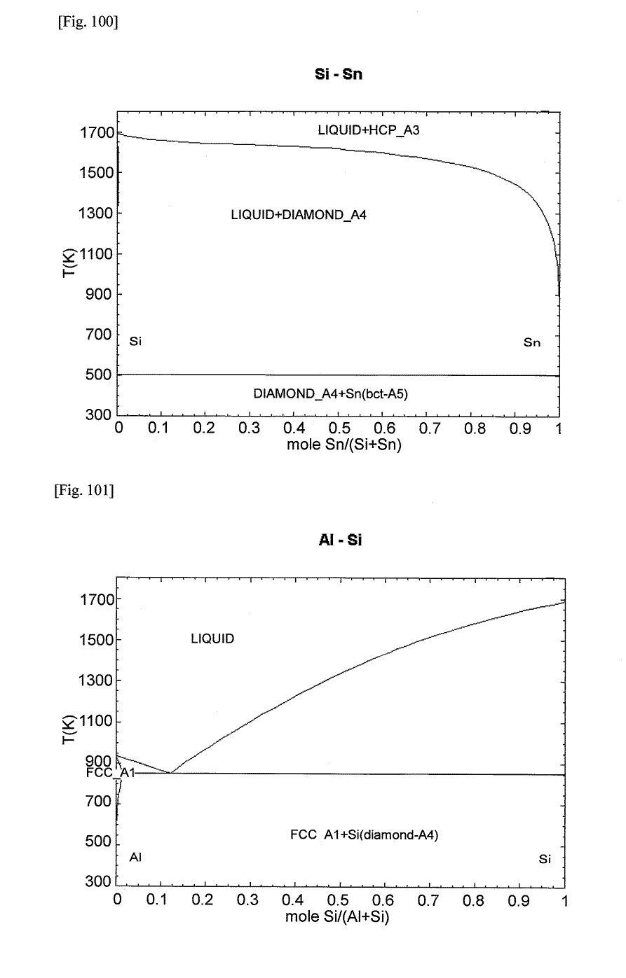

The formation process of the nanosized particle of Example 3-1 is discussed. FIG. 100 is a binary system phase diagram of silicon and tin. Since the plasma generated by the high-frequency coil was equivalent to 10,000 K, it exceeded the temperature range of the phase diagram by far, and plasma in which tin atoms and silicon atoms were uniformly mixed was obtained. When the plasma is cooled, it becomes a mixed gas of Si and Sn, and by further cooling, both are deposited. Therefore, when the plasma of silicon and tin is cooled, a nanosized particle comprising Si and Sn is formed. In such a case, Si and Sn each form a spherical configuration, and depending on their affinity and wettability, form a configuration wherein two particles are bound, so that the surface energy of the droplets of Si and Sn are decreased and the free energy is minimized.

Further, FIG. 69 is binary system phase diagram of iron and silicon. Since the plasma generated by the high-frequency coil was equivalent to 10,000 K, it exceeded the temperature range of the phase diagram by far, and plasma in which iron atoms and silicon atoms were uniformly mixed was obtained. When plasma is cooled, FeSi₂ and Si are deposited via a droplet. Therefore, when the plasma of silicon and iron is cooled, a nanosized particle comprising FeSi₂ and Si is formed. In such a case, it is assumed that FeSi₂ and Si form a configuration where two particles are bound via an interface.

From these results, by cooling a plasma containing silicon, tin, and iron, a nanosized particle comprising Si, Sn, and FeSi₂, wherein Si and Sn are bound and FeSi₂ and Si are bound, is formed.

Note that although in Example 3-1, a ternary system of silicon, tin and iron was used to create a nanosized particle, the nanosized particle of the present invention is not limited to the ternary system of silicon, tin and iron. For example, in the binary system phase diagram of aluminum (Al) and silicon (Si) shown in FIG. 101, when plasma is cooled, Al and Si are deposited, it can be assumed that a nanosized particle with Al particles and Si particles bound, will be obtained.

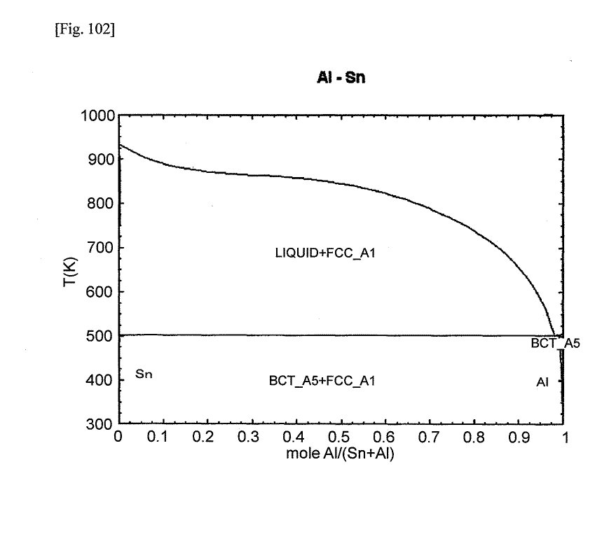

Further, in the binary system phase diagram of aluminum (Al) and tin (Sn) shown in FIG. 102, when plasma is cooled, Al and Sn will be deposited. Since Al and Sn have a low affinity, it can be assumed that a nanosized particle, wherein particles of Al and particles of Sn are bound, so as to reduce the area of contact between Al and Sn, will be obtained.

In all combinations other than using Si as element A-1 and Sn as element A-2, i.e., selecting element A-1 and element A-2 from Si, Sn, Al, Pb, Sb, Bi, Ge, Zn, a similar binary system phase diagram is obtained. Element A-1 and element A-2 do not form a compound, but a thirteenth phase, which is a simple substance or solid solution of A-1, and a fourteenth phase, which is a simple substance or a solid solution of element A-2, are obtained. Therefore, in the above combination of element A-1 and element A-2, it can be assumed that a nanosized particle, wherein both the thirteenth phase and the fourteenth phase are exposed to the outer surface, the surfaces of the thirteenth phase and the fourteenth phase, other than their interface, are approximately spherical, and the thirteenth phase and the fourteenth phase are bound via an interface, is obtained.

Further, for example, in the binary system phase diagram of Co (cobalt) and Si (silicon) shown in FIG. 45, since CoSi₂ and Si are deposited when plasma is cooled, a nanosized particle wherein CoSi₂ is covered by Si is presumably obtained.

In all combinations other than using Si as element A-1 and Fe as element D, i.e., selecting element A-1 from Si, Sn, Al, Pb, Sb, Bi, Ge, In and Zn, and selecting element D from Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, a binary system phase diagram similar to that of Fe—Si is obtained, and compound DA-1ₓ (1<x≦3) is obtained. Therefore, in the above combination of element A-1 and element D, it is assumed that a nanosized particle, comprising a structure wherein a fifteenth phase and a thirteenth phase are bound via an interface, is obtained.

As described above, when a raw material powder obtained by mixing a powder of element A-1, a powder of element A-2, and a powder of element D is supplied to a nanosized particle production apparatus, plasma containing element A-1, element A-2, and element D is generated. When such plasma is cooled, a thirteenth phase consisting of element A-1, a fourteenth phase consisting of element A-2, and a fifteenth phase that is a compound of element A-1 and element D are synthesized, and a nanosized particle, wherein the thirteenth phase and the fourteenth phase are bound, and the fifteenth phase is bound to the thirteenth phase, is obtained.

Also in the binary system phase diagram of iron (Fe) and tin (Sn) shown in FIG. 46, since iron and tin may form a compound, a nanosized particle wherein FeSn₂ and Sn are bound may be obtained. That is, as in the nanosized particle 113 shown in FIG. 11(a), the seventeenth phase 115 may be bound to the fourteenth phase 105.

The formation process of nanosized particle 119 of the present invention will be discussed. When Si is used as element A-1, Sn is used as element A-2, and Al is used as element A-3, by cooling the plasma in which Si, Al, Sn and Fe are mixed, as shown in FIGS. 100, 101, and 102, because Si, Al and Sn do not form a compound, Si as the thirteenth phase 103, Sn as the fourteenth phase 105, and Al as the eighteenth phase 121 are deposited as a simple substance or a solid solution. Further, as shown in FIG. 37, FeSi₂ is deposited. Note that in this case, FeSn₂ may be deposited. When Si is used as the thirteenth phase 103, an anode of high capacity will be obtained.

As described above, when a raw material powder obtained by mixing a powder of element A-1, a powder of element A-2, a powder of element A-3, and a powder of element D is supplied to a nanosized particle production apparatus, plasma containing element A-1, element A-2, element A-3, and element D will be generated. By cooling this plasma, a spherical thirteenth phase 103 consisting of element A-1, a spherical fourteenth phase 105 consisting of element A-2, a spherical eighteenth phase 121 consisting of element A-3, and a fifteenth phase 107 that is a compound of element A-1 and element D, are synthesized. A nanosized particle 119, wherein the fourteenth phase 105 and the thirteen phase 103 are bound, the eighteenth phase 121 and the thirteenth phase 103 are bound, and the fifteenth phase 107 and the thirteenth phase 103 are bound, is obtained. Further, at a certain probability, the fourteenth phase 105, fifteenth phase 107, and eighteenth phase 121 may come in close contact, or be bound via an interface. Further, since the melting point of Sn is low, the time in which it stays as a liquid is relatively long, a situation wherein particles are bound due to the collision of the nanosized particle with the droplets, are obtained. Further, by dissociating at Sn, a polyhedral configuration as in nanosized particle 117 can be observed.

Further, the formation process of nanosized particle 125, which comprises a nineteenth phase 127, will be discussed. From the binary system phase diagram of Co (cobalt) and Si (silicon) shown in FIG. 45, it can be assumed that a nanosized particle, wherein CoSi₂ and Si are bound via an interface, is obtained

FIG. 47 is binary system phase diagram of cobalt and iron. When a mixed powder of cobalt powder and iron powder is cooled from plasma, a simple substance of cobalt and a solid solution of iron cobalt, a simple substance of iron and a solid solution of iron cobalt, or a solid solution of iron cobalt alone, will be deposited. Thus, when plasma containing silicon, tin, iron, and cobalt is cooled, a nanosized particle comprising FeSi₂, CoSi₂, Si, and Sn within the particle, is formed. In such a case, it is assumed that Sn is bound to Si, FeSi₂ is bound to Si, and CoSi₂ is bound to Si. Further, since the affinity of Fe and Si, and the affinity of Co and Si are high, it is believed that FeSi₂, CoSi₂, and the solid solution of iron cobalt are incorporated into Si.

As described above, when a raw material powder obtained by mixing a powder of element A-1, a powder of element A-2, a powder of element D, and a powder of element D′ is supplied to a nanosized particle production apparatus, plasma containing element A-1, element A-2, element D, and element D′ will be generated. By cooling this plasma, a spherical thirteenth phase 103 consisting of element A-1, a spherical fourteenth phase 105 consisting of element A-2, a fifteenth phase 107 that is a compound of element A-1 and element D, and a nineteenth phase 127 that is a compound of element A-1 and element D′, are produced, and a nanosized particle 125 with a structure wherein the fourteenth phase 105 and the thirteenth phase 103 are bound, the fifteenth phase 107 and the thirteenth phase 103 are bound, the nineteenth phase 127 and the thirteenth phase 103 are bound, is obtained.

As described in detail above, suitable embodiments of the present invention were described with reference to the accompanying figures. However, the present invention is not limited to such examples. It should be understood by those in the field that examples of various changes and modifications are included within the realm of the technical idea of the present invention, and that such examples should obviously be included in the technical scope of the present invention.

### Description of Notations

1 Nanosized particle
3 First phase
5 Second phase
7 Nanosized particle
8 Nanosized particle
9 Third phase
11 Nanosized particle
12 Nanosized particle
13 Nanosized particle
15 Fourth phase
17 Nanosized particle
19 Fifth phase
21 Nanosized particle production apparatus
25 Supply port for raw material powder
27 Raw material powder
29 Sheath gas supply port
31 Sheath gas
33 Carrier gas
35 Reaction chamber
37 High frequency coil
39 High frequency power supply
41 Plasma
43 Filter
51 Nanosized particle
53 Sixth phase
55 Seventh phase
57 Nanosized particle
59 Eighth phase
61 Nanosized particle
63 Ninth phase
65 Nanosized particle
66 Nanosized particle
67 Tenth phase
69 Nanosized particle
71 Nanosized particle
73 Nanosized particle
75 Eleventh phase
77 Nanosized particle
79 Twelfth phase
81 Nanosized particle
101 Nanosized particle
103 Thirteenth phase
105 Fourteenth phase
107 Fifteenth phase
109 Nanosized particle
110 Nanosized particle
111 Sixteenth phase
113 Nanosized particle
115 Seventeenth phase
117 Nanosized particle
119 Nanosized particle
121 Eighteenth phase
123 Nanosized particle
125 Nanosized particle
127 Nineteenth phase
129 Nanosized particle
131 Twentieth phase
171 Lithium ion secondary battery
173 Cathode
175 Anode
177 Separator
179 Sealed battery
181 Cathode lead
183 Cathode terminal
185 Anode lead
187 Nonaqueous electrolyte
189 Sealing material

1. A nanosized particle, which comprises element A and element D, wherein
said element A is at least one element selected from the group consisting of Si, Sn, Al, Pb, Sb, Bi, Ge, In and Zn, and
said element D is at least one element selected from the group consisting of Fe, Co, Ni, Ca, Sc, Ti, V, Cr, Mn, Sr, Y, Zr, Nb, Mo, Ru, Rh, Ba, lanthanoid elements (not including Ce and Pm), Hf, Ta, W and Ir; and comprises at least
a first phase that is a simple substance or a solid solution of said element A, and
a second phase that is a compound of said element A and said element D, wherein
said first phase and said second phase are bound via an interface,
said first phase and said second phase are exposed to the outer surface, and
the surface of said first phase other than the interface is approximately spherical.

2. The nanosized particle according to claim 1, wherein said element A is Si and said element D is at least one element selected from the group consisting of Fe, Co, Ni, Ca, Sc, Ti, V, Cr, Mn, Sr, Y, Zr, Nb, Mo, Ru, Rh, Ba, Hf, Ta, W and Ir.

3. The nanosized particle according to claim 1, wherein the average particle diameter is 2 to 500 nm.

4. The nanosized particle according to claim 1, wherein said second phase is a compound expressed as DA_{X} (1<x≦3).

5. The nanosized particle according to claim 1, which further comprises a third phase that is a compound of said element A and said element D, wherein said third phase is dispersed in said first phase.

6. The nanosized particle according to claim 1, wherein oxygen is added to said first phase.

7. The nanosized particle according to claim 1, which further comprises element D′, which is at least one element selected from the group consisting of Fe, Co, Ni, Ca, Sc, Ti, V, Cr, Mn, Sr, Y, Zr, Nb, Mo, Ru, Rh, Ba, lanthanoid elements (other than Ce and Pm), Hf, Ta, W and Ir, wherein
said element D′ is an element that differs from said element D, which composes said second phase; and
which further comprises a fourth phase, which is a compound of said element A and said element D′, wherein
said first phase and said fourth phase are bound via an interface, and
said fourth phase is exposed to the outer surface.

8. The nanosized particle according to claim 1, wherein said first phase consist mainly of crystalline silicon, and the outer surface of said nanosized particle is covered with an amorphous layer.

9. The nanosized particle according to claim 1, wherein the surfaces of said second phase and/or said fourth phase other than their interface are approximately spherical or polyhedral.

10. A nanosized particle, which comprises element A and element M that differ, wherein
said element A is at least one element selected from the group consisting of Si, Sn, Al, Pb, Sb, Bi, Ge, In and Zn, and
said element M is at least one element selected from the group consisting of Cu, Ag and Au; and comprises at least
a sixth phase that is a simple substance or a solid solution of said element A, and
a seventh phase that is a compound of said element A and said element M, or a simple substance or solid solution of said element M, wherein
said sixth phase and said seventh phase are bound via an interface,
said sixth phase and said seventh phase are both exposed to the outer surface, and
the surfaces of said sixth phase and seventh phase other than their interface are approximately spherical.

11. The nanosized particle according to claim 10, wherein the average particle diameter is 2 to 500 nm.

12. The nanosized particle according to claim 10, wherein said seventh phase is a compound expressed as MA_{X} (x≦1, 3<x).

13. The nanosized particle according to claim 10, wherein said sixth phase comprises oxygen, and
the atomic ratio of said oxygen in said sixth phase is AO_{z} (0<z<1).

14. The nanosized particle according to claim 10, which further comprises element D, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os or Ir; and
which further comprises a ninth phase, which is a compound of said element A and said element D, wherein
said sixth phase and said ninth phase are bound via an interface, and
said ninth phase is exposed to the outer surface.

15. The nanosized particle according to claim 14, which further comprises element D′, which is at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir, wherein
said element D′ is an element that differs from said element D, which composes said ninth phase; and
which further comprises an eleventh phase, which is a compound of said element A and said element D′, wherein
said sixth phase and said eleventh phase are bound via an interface, and
said eleventh phase is exposed to the outer surface.

16. The nanosized particle according to claim 15, which further comprises a twelfth phase that is a compound of said element A and said element D′, wherein
part or all of said twelfth phase is covered with said sixth phase.

17. The nanosized particle according to claim 14, wherein the surfaces of said ninth phase and/or said eleventh phase other than their interface are spherical or polyhedral.

18. The nanosized particle according to claim 1, which contains element A-1 and element A-2 as said element A, which are two elements selected from the group consisting of Si, Sn, Al, Pb, Sb, Bi, Ge, In and Zn; and comprises
a thirteenth phase as said first phase, which is a simple substance or a solid solution of said element A-1,
a fourteenth phase, which is a simple substance or a solid solution of said element A-2, and
a fifteenth phase as said second phase, which is a compound of said element A-1 and said element D, wherein
said thirteenth phase and said fourteenth phase are bound via an interface,
said thirteenth phase and said fifteenth phase are bound via an interface,
the surfaces of said thirteenth phase and said fourteenth phase other than their interface are approximately spherical, and
said thirteenth phase, said fourteenth phase, and said fifteenth phase are exposed to the outer surface.

19. The nanosized particle according to claim 1, wherein the powder conductivity under a condition of compressing powdered particles at 63.7 MPa, is 4×10⁻⁸ [S/cm] or more.

20. An anode material for lithium ion secondary batteries, which comprises the nanosized particle according to claim 1 as an anode active material.

21. The anode material for lithium ion secondary batteries according to claim 20, which further comprises a conductive agent, wherein said conductive agent is at least one powder selected from the group consisting of C, Cu, Ni and Ag.

22. An anode for lithium ion secondary batteries, which utilizes the anode material for lithium ion secondary batteries according to claim 20.

23. A lithium ion secondary battery, which comprises
a cathode that is able to occlude and discharge lithium ion,
the anode according to claim 22, and
a separator arranged between said cathode and said anode, wherein
said cathode, said anode, and said separator are provided in an electrolyte that has lithium ion conductivity.

24. A method for producing a nanosized particle, which comprises plasmatizing a raw material containing at least one element selected from the group consisting of Si, Sn, Al, Pb, Sb, Bi, Ge, In and Zn, and at least one element selected from the group consisting of Fe, Co, Ni, Ca, Sc, Ti, V, Cr, Mn, Sr, Y, Zr, Nb, Mo, Ru, Rh, Ba, lanthanoid elements (other than Ce and Pm), Hf, Ta, W and Ir,
to obtain a nanosized particle via a nanosized droplet.

25. A method for producing a nanosized particle, which comprises:
a process of plasmatizing a raw material containing at least one element selected from the group consisting of Si, Sn, Al, Pb, Sb, Bi, Ge, In and Zn, and at least one element selected from the group consisting of Cu, Ag and Au, to obtain a nanosized particle via a nanosized droplet; and
a process of oxidizing said nanosized particle.

26. The method for producing a nanosized particle according to claim 25, wherein at least one element selected from the group consisting of Fe, Co, Ni, Ca, Sc, Ti, V, Cr, Mn, Sr, Y, Zr, Nb, Mo, Tc, Ru, Rh, Ba, lanthanoid elements (other than Ce and Pm), Hf, Ta, W, Re, Os and Ir is added to said raw material.

27. The method for producing a nanosized particle according to claim 24, wherein said raw material contains at least two elements selected from the group consisting of Si, Sn, Al, Pb, Sb, Bi, Ge, In and Zn.
